(19) United States
(12) Patent Application Publication
(10) Pub. No.: US 2002/0067940 A1
(43) Pub. Date: Jun. 6, 2002

(54) Tray for transferring recording media, and recording apparatus

(76) Inventors: Yoji Sasai, Nagano-ken (JP); Masaki Shimomura, Nagano-ken (JP); Masahiro Isono, Nagano-ken (JP); Mamoru Ukita, Nagano-ken (JP); Hiroshi Asawa, Nagano-ken (JP); Kenjiro Ishihara, Nagano-ken (JP); Koji Hashiuchi, Nagano-ken (JP); Kazuo Otsuka, Nagano-ken (JP); Hiroyuki Tajima, Nagano-ken (JP)

Correspondence Address: Stroock & Stroock & Lavan LLP, 180 Maiden Lane, New York, NY, 10018, US

(21) Appl. No.: 09/962,544

(22) Filed: Sep. 24, 2001

(30) Foreign Application Priority Data
Sep. 25, 2000 (JP) 2000-289928
Oct. 20, 2000 (JP) 2000-327018
May 30, 2001 (JP) 2001-161816
Oct. 20, 2000 (JP) 2000-327014
Oct. 20, 2000 (JP) 2000-327015
Oct. 20, 2000 (JP) 2000-321639
May 31, 2001 (JP) 2001-165245

(51) Int. Cl. B41J 5/40

(52) U.S. Cl. 400/61; 101/35

(57) ABSTRACT

A transferring tray for a printing apparatus for printing on one major surface of a recording media having disc shape, wherein the printing apparatus includes, a carriage having a printing head, reciprocating in a main scanning direction, a transferring unit transferring the recording media in a sub scanning direction, a detecting unit detecting the recording media being transferred by the transferring unit, and a recording unit printing on the one major surface of the recording media, the transferring tray including: a tray body having a rectangular plate shape made of a material which is not detected by the detecting unit; a detected portion formed on either one of two major surfaces of the tray body, being detectable by the detecting unit; and a mounting portion having a mounting recess such that the one major surface of the recording media comes up to substantially same level as one of the major surfaces of the tray body when the recording media is mounted on the transferring tray.

### FIELD OF THE INVENTION

The present invention relates to a tray for transferring a recording media to transfer the recording media with transfer means in a recording apparatus and to print the recording media when a printing task is performed on a label face of the circular shaped recording media such as a CD-R with the recording apparatus such as an ink jet printer.

### BACKGROUND OF THE INVENTION

Information recorded on a recording media can be written into a predetermined area on a face opposed to a recording face of the circular shaped recording media such as a CD-R. With respect to the recording apparatus for printing on the area, international filing number PCT/JP96/02833 discloses the recording apparatus in which the recording media is set to the tray for transfer, the tray for transfer is transferred, and the printing task is performed. The recording media is set to a fitting part shaped shallower circular groove formed at a center part on a surface of the tray for transfer formed by a thin rectangular board of the tray for transfer, the tray for transfer setting the recording media is transferred by a transfer roller, and the printing task is transfer is performed on the recording media surface with a recording head.

However, in the recording apparatus of conventional art, there is no means of identifying the surface of the tray for transfer and a back face, therefore, the printing task is tray for transfer and a back face, therefore, the printing task is performed on the back face of the tray for transfer even when the surface and the back face of the tray for transfer are reversed and the tray for transfer is erroneously transferred in a state of reversing the faces.

As a result, extra use of ink occurs due to a waste-printing task and extra use causes dirty on the back face of the tray for transfer with ink. A level of a material of the tray for transfer by the rectangular board is various and some warp or deflection easily occurs in the tray. Recording precision lowers due to warp or deflection.

When an end where is a terminal point at which the ray for transfer is transferred is passed over the transfer roller, a drilling roller abuts against the following roller forced to the drilling roller, since the tray for transfer is the rectangular board with some thickness. The incident causes noise. Therefore, according to the first aspect of the present invention, a printing task on a tray for transfer is prevented, inferior in printing quality due to warp or deflection is reduced, and noise occurs when the tray is transferred with the transfer means. Thereby, the printing task on a label face on media is efficiently carried out with high printing quality and lower noise.

An ink jet type recording apparatus is known in which a tray for transfer setting a recording media such as a CD-R is inserted into a hand-feeder passage similar to a record sheet with little flexible like cardboard and the tray can be recorded on a label face of the recording media.

The ink jet recording apparatus includes a carriage mounting thereon a recording head and reciprocatively moves in the main scanning direction and a recording medium transferring means for transferring the recording medium in the sub-scanning direction. The ink jet type recording apparatus records on recording paper fed from an auto feeder apparatus and provides with a hand-feed passage capable of feeding cardboard etc. by hand other than a feed passage of prior art an auto feeder apparatus. The ink jet typed recording apparatus has a constitution capable of recording on he tray for transfer to which the recording media is set similar to cardboard. When the tray for transfer of such ink jet type recording apparatus is inserted into transfer passage by hand, it is difficult to determine the position of the tray accurately. Therefore, printing a task on the recording media is performed at a slightly off position. This is because a mark to be set when the tray for transfer is set to an accurate position of the ink jet type recording apparatus or the tray for transfer is not indicated on the ink jet type recording apparatus or the tray for transfer. Thus, the task is not accurately performed as expected.

To set the tray for transfer at the accurate position by the user, it is necessary that the accurate position to be set by repeating frequently repeating set of the tray, recording the accurate position onto memories or indicating any marks.

According to the second object of the present invention is to provide a tray for transfer capable of easily setting the tray to an accurate position when a tray transferring a sheet to be recorded is set to an ink jet type recording apparatus.

In an ink jet type printer, paper etc., which is a recording medium, is fed from an auto sheet feeder or an inlet by hand and is sandwiched between a main drilling paper feed roller and a following roller. While the paper feed roller is rotated to be fed, pressure is applied to ink in a pressure generation room of the recording head and ink drips are released from an nozzle opening. Thereby, image information is printed on paper.

In a paper feed mechanism of the printer, once working to lead paper to a printing start position is performed. A printing operation is performed as reference of the position. Therefore, it is necessary to achieve a task to transfer a leading edge of paper with high precision. In a conventional example, paper feed is stopped when a light-emitted element to change an output voltage according to existence or no existence to be detected is used and value. By exceeding the value, transfer of paper is stopped and a leading edge of paper forwards.

FIG. 35 shows a constitution of an optically sensing element used often when the leading edge of paper precisely forwards. Reverse V type slit is on a lower face of the optical sensor 722. A light emitted diode 723 and a photo diode 724 are respectively provided on slit faces each other. Light generated from the light emitted diode 723 is irradiated on a recording paper 745 to be reflected and sensed by the photo diode 724.

FIG. 36 shows a graph indicating change of an output voltage of the photo diode 724 when paper is fed from the left-handed to the right-hand side in FIG. 35. The graph shows a voltage value on a vertical axis and amount transferring paper counted by an optical encoder on a horizontal axis.

FIG. 37A is a view for explaining a state where there is paper and a state where there is no proper in the graph of FIG. 36. FIG. 37A shows a state of prior to transfer of recording paper 745 to change of the optical sensor 722, that is, a state where the optical sensor 722 measures reflect light from only a constitution member of the paper feed passage (e.g., paper guide board or paper feed roller). In contrast, FIG. 37B shows a state where paper forwards, paper is completely transferred under the optical sensor 722, and the photo diode 724 receives reflecting light from only paper.

Once an end of recording paper 745 is in a range detecting the optical reason 72, the output voltage of the photo diode 724 goes up and exceeds a predetermined voltage value abruptly with a hidden line in FIG. 36 at a position shown in FIG. 35. A count value in this case is indicated as CO.

However, it is difficult to detect position accurately. This is because it is unknown when output of the photo diode 724 exceeds the predetermined value depending on a type of paper set to the printer. In this manner, printed output in a particular printing medium varies depending on the surface condition. Such examples of the printing media include high quality, coated, inkjet printer, rough surface papers etc.

Recording paper used for the conventional inkjet printer includes thin paper such as a standard paper or specific-used paper for high quality in color printing and cardboard, slightly think paper such as label paper which has adhesive material in one side to help itself onto a particular surface of an embodiment. Therefore, range of brightness by paper classification is not very large.

Recently, recording paper with thicker than conventional cardboard to perform on board paper in full color print is also used.

On the other hand, an optical disk recording media capable of writing such as CD-R (Compact Disk Recordable) or CD-RW (Compact Disk Rewritable) is widely used by individuals. Commercially, labeling is performed in a method in which a thin printing paper is adhesive.

If a printing task can be directly performed on an optical disk surface, a problem of which the label is taken off can be solved and direct printing is convenient.

To be capable of directly printing on an optical disk, a transfer tray made of polypropylene is designed so as to hold the disk in. The thickness of the transfer tray is about 2.5 mm.

Needs, to put a transfer tray to which board paper or optical disk is set in a paper feed mechanism of the printer and to perform the print task, are generated. When the printing task is performed on such recording medium, it is appropriate to provide with not the auto sheet feeder as described but hand feeder from an inlet.

When these recording mediums is set to the feeder mechanism of the printer from the inlet, due to the use of different thickness, a printer system in accordance with an embodiment of the present invention may have a different problem from a problem, which is expected in prior art a printer system.

When the transfer tray to which the optical disk is set is transferred to a detection mechanism similar to the detection mechanism described in FIGS. 35, 36, 37, the conditions may vary. FIG. 38 shows relation of the optical sensor 722 and the transfer tray 746. The thickness of the transfer tray 746 is thicker than that of general recording paper. Since thickness of recording paper 745, light generated from the light emitted diode 723 is illuminated on the side face of the transfer tray 746. Due to influence from beveled edge on the upper part of the transfer tray, light emitted from the light emitted diode 724 is reflected on various embodiments along paper feeding passage. This repeatedly reflected light results in diffusion of light, which cause a different behavior in output of photo diode 724. Thus, the result in this example is different from that in FIG. 36.

FIG. 39 shows a graph indicating output voltages of photo diode 724 when the transfer tray 746 is fed. Due to diffusion, output voltages increase slowly. But with the inputs increased, accordingly the output increase in concave manner. For example, When transfer tray to which a optical disk is set is fed to paper feed mechanism of printer system, it is desired that development of control technical so that the aforementioned end of the recording mechanism stably forwards with precision not depending on a field of recording medium, when the end of the recording medium is detected by using a reflection typed optical sensor.

According to the third aspect of the present invention, an initial set apparatus of the recording medium is capable of forwarding in stable the end the recording medium with high precision not depending on a kind of the recording medium when the end of the recording medium is detected by using the reflection typed optical sensor.

FIG. 40 is a perspective view showing arrangement of an optical sensor 722 in a conventional ink jet printer. A constitution part of paper feed insight the printer is perspective. In this example, auto sheet feeder is attached to printer system for sending paper into a paper feed path. Storage of recording paper 745 is no shown in this example. The optical sensor 722 provides with the aforementioned element on a bottom face. The sensor 722 is mounted between an ASF roller 750 driven with an ASF motor 711 and a feeder side roller 751 driven with a paper feed motor 712.

In this example, ASF roller 750 does not start feeding recording paper 745. Thus, the recording paper is out of range for scanning with an optical sensor 722. Therefore, the optical sensor 722 detects reflected light only from a constitution member if the paper feed path (not shown paper guide board or feed side roller 751). Therefore, output voltages in FIG. 36 represent voltages, Vn, taken when there is no paper.

The example shown in this Fig. includes a photo sensor having light emitted diode and photo diode, and feeding paper along print feeding passage. In this configuration, output voltages of photo diode are observed. FIG. 36 shows a diagram of output voltages of photo diode 724 with respect to count number, C0, values determining a location of paper at a particular configuration as shown in FIG. 35. In this configuration, as show in FIG. 36, the output voltage of photo diode stays at Vn, which represent that loaded paper is out of range for photo sensor. Once the end of recording paper 745 is in a range of detection of the optical sensor 722, the outputs of sensor start increasing voltages of the photo diode 724. Then, when the loaded paper is in all of the range, the voltage reaches at the heist value, V1. During this voltage change, voltage passes a predetermined value set for determining a location of the loaded paper.

When feeding paper proceeds and configuration changes as shown in FIG. 41. The output voltage of the optical sensor 722 is V1 as shown in FIG. 36. The V1 represents a voltage that fed paper exists in all range.

In this manner, it is difficult to keep precision higher. Thus, to improve the procedure, the applicant developed a technology to more accurately forward the leading edge of paper at the same position even when paper with different brightness is used. (See Japanese Laid-open publication No. 9-136741). A different value of a voltage value is in a state of no paper and a voltage value in a state where paper is the only object for determining the location. In this prior art, the leading edge of paper is calculated by using derivatives of particular voltage values and particular coefficients.

In the prior art to forward the leading edge of paper with precision, after recording paper 745 is in the range of detection of the optical sensor 722, paper forwards. Recording paper 745 is once pulled back from that position and operation goes on to remove to the outside the detection area of the sensor.

To operate these, it is inconvenient to mount the optical sensor 722 at the aforementioned position. For example, to feed back recording paper 745 from a position shown in FIG. 41 to a position shown in FIG. 40, the paper feed motor 712 is rotated in a reverse direction and the ASF motor is synchronized to be rotated in a reverse direction, or the driving mechanism is released.

Thereby, the ASF roller 750 becomes a free wheel state. After recording paper 745 separates from the feeder side roller 751, it is also necessary to pull back paper by reverse operation of the ASF motor.

In a case where paper is supplied from the hand feeder inlet 751 difficult problem further occurs. This is because a means to pullback running out paper after recording paper 745 separates from the feed side roller 751, separate during mechanism have to be prepared.

As described above, it is not desirable to drive two or more motors for feeding the paper back because the operational control for the motor becomes complicated

Further, the arrangement of the optical sensor 722 may raise a problem with respect to the accuracy of the paper heading operation. An actual position of the leading edge of the paper when the printing is actually performed is a position ahead of a position of the recording paper 745 shown in FIG. 41. That is, at least a leading edge of the recording sheet 745 must position ahead of the carriage 713 on which the recording head is mounted. If the position of the leading edge of the paper detected by the sensor is distanced from the position of the leading edge of the paper when the printing operation is actually performed, it is more likely that an undesirable deviation of the paper feed or, in the worst case, a paper jam may occur.

Accordingly a fourth object of the present invention is to perform accurately the operation of the paper feeding and paper feeding back as mentioned above by reviewing the arrangement of the optical sensor within the paper feeding path. Further, another object of the invention is to provide a technique which can realize these operation by a more simple motor control than the conventional motor control.

Recently, in addition, with the printer for use in a computer system or paper handling for various kinds of recording papers, finer or more accurate control has been required.

For example, in an ink jet type printer in which fine ink droplets are ejected from nozzles arranged on a recording head for recording dots on a recording paper, the recording head does not contact the recording paper and a gap of approximately 0.6 mm must be required. Accordingly, in order to realize the accurate dot diameter by the ink jet printer, the gap must be adjusted to be constant even when different thickness of recording paper is used. For that reason, recent ink jet printer installs therein a mechanism for adjusting the gap.

In the ink jet printer or the like a recording paper is put on a flat plate called platen for guiding the paper while being kept in horizontal, and a printing operation is performed in a space above the platen by scanning the carriage on which the recording head is mounted. Accordingly, the gap adjustment mechanism sets an amount of gap defined between the nozzle opening and the platen, i.e., a paper gap, by moving the carriage up and down.

The recording sheet which the conventional ink jet printer can handle includes a thin paper having a thickness equal to or less then Gmm such as a normal paper, special purpose for high-quality color printing or a thick paper having a thickness between approximately 0.7 mm and 1.5 mm such as a label sheet formed of sticky seal which is peelable from a base sheet.

However, in order to make it possible to print directly on an optical disc, a transferring tray made of polypropylene is employed for holding the optical disc. The transferring tray has a thickness of approximately 2.5 mm and, therefore, a large extent of adjustment for the paper gap arrangement must be required. The printer, which is applicable for printing the optical disc, is provided with a mechanism for manually setting the paper gap applicable for the transferring tray.

According to the conventional apparatus, for example, a thin paper is fed by an automatic sheet feeder whereas a thick paper is fed from a manual paper-feed slot. Thus, different kind of paper comes through different paper feed path. Therefore, an erroneous setting of the paper hardly occurs. However, according to the foregoing circumstance, both the thick paper and the transferring tray serving as a extremely thick paper are fed through the same manual paper-feed slot. Therefore, it may be likely that a user of the printer may make a mistake that the printer is set to a paper gap which is not adapted to the recording paper now the user intends to print.

Therefore, according to a fifth object of the present invention is to provide a printer which is capable of detecting an erroneous gap setting made by a user and taking necessary steps such as suggestion to the user to reset the paper gap.

Generally, an ink-jet type recording apparatus is provided with a paper feed roller 1040 for feeding a recording medium P such as printing paper to a recording region 1051 where a recording head 1100 is disposed and a paper discharge roller 1010 for discharging the paper onto which the printing is made from the printing region 1051. In this operation, the paper discharge roller 1010 includes a plurality of rollers arranged in the main scanning direction in the widthwise direction of the recording medium P at a position downstream in the sub-scanning direction of the recording region 1051 of the pri9nting apparatus, that is, the feeding direction of the recording medium P. The paper discharge roller 1010 is constituted by a paper discharge driving roller 1011 and a paper discharge following roller 1012. The paper discharge following roller 1012 may be a roller with a plurality of teeth arranged on a periphery of the roller, each of the teeth being an acute teeth which come into point-contact to the recording surface of the recording medium P. The roller is stored in a holder for a paper discharge following roller in such a manner that those plurality of teeth are exposed up and down, though not shown in FIG. 47. Further, at a position further downstream of the paper discharge roller 1010 in the sub-scanning direction, there is disposed a discharge roller 1060 which is driven to rotate by the feeding force of the recording medium P. The paper discharge following roller is a term used in the present description which includes the paper discharge following roller 1012 and the discharge roller 1060 shown in FIG. 47. Therefore, the paper discharge following roller represents either the he paper discharge following roller 1012 and/or the discharge roller 1060.

By the way, it may occurs that the ejection follower roller, which followedly rotates by contact with the recording media, is slightly inclined, during the transportation of the recording media, to right or left from a position where the teeth are perpendicularly contact with the sheet of paper. Under the circumstance that a change of angle (inclination) occurs, the ejection follower roller does not smoothly rotate. Therefore, the teeth of the ejection follower roller being contact with the recording media makes fine recesses or scratches on a surface, i.e. a printing surface, and deteriorates the printing quality.

Particularly, in case where a sheet in which a printing surface thereof coated with a chemical, resin and the like, so-called “a coating sheet” is used as a recording media, the printing surface of the coating sheet is so nervous that the contact of the teeth with the sheet might make fine recesses on the surface of the coating sheet even if the rotational direction of the ejection follower roller is parallel to the transporting direction of the recording media (named a “parallel position” hereinafter, when applicable). Accordingly, the abnormal contact of the teeth with the sheet should be prevented as possible.

Namely, if the teeth make contact with the coating sheet while the inclination from the right angle, a coating layer slightly peels or rises around the aforementioned recesses (so called “pickings” are formed). Therefore, if the pickings are formed on the sheet for the high quality printing like a picture, a final quality after printing is deteriorated.

One of the most problematic situations for forming the aforementioned peeling or pickings of the coating layer is in reversely rotating the ejection follower roller. For example, in printing on a continuous recording media such as a roll paper, a cutter for cutting off the recording media after printing is arranged downstream in the transporting direction than the ejection roller. In this case, it is necessary to feed back the much fed sheet with a certain amount upstream in the transporting direction than a recording unit. Accordingly, the rollers mentioned above is rotated in reverse. If any peeling or pickings are formed in the reverse rotation, the surface to be printed of the sheet fed back to the recording unit, which has such peeling or pickings, may make large effects on the printing quality.

Furthermore, other than the problems of the peeling and pickings, it is convenient for a user to adjust such that the ejection follower roller keeps away from the surface of the recording media, depending upon the purpose of printing.

### SUMMARY OF THE INVENTION

The present invention was made in view of the afore-mentioned drawbacks accompanying the conventional printing apparatus.

According to a first object of the present invention, a printing task on a tray for transfer is prevented, inferior in printing quality due to warp or deflection is reduced, and noise occurs when the tray is transferred with the transfer means. Thereby, the printing task on a label face on media is efficiently carried out with high printing quality and lower noise.

A second object of the present invention is to provide a tray for transfer capable of easily setting the tray to an accurate position when a tray transferring a sheet to be recorded is set to an ink jet type recording apparatus.

A third object of the present invention is to provide an initial set apparatus of the recording medium capable of stably forwarding the end the recording medium with high precision not depending on a kind of the recording medium when the end of the recording medium is detected by using the reflection typed optical sensor.

A fourth object of the present invention is to perform accurately the operation of the paper feeding and paper feeding back as mentioned above by reviewing the arrangement of the optical sensor within the paper feeding path.

A fifth object of the present invention is to provide a printer which is capable of detecting an erroneous gap setting made by a user and taking necessary steps such as suggestion to the user to reset the paper gap.

The above and other objects can be achieved by a provision of a transferring tray for a printing apparatus for printing on one major surface of a recording media having disc shape, wherein the printing apparatus includes, a carriage having a printing head, reciprocating in a main scanning direction, a transferring unit transferring the recording media in a sub scanning direction, a detecting unit detecting the recording media being transferred by the transferring unit, and a recording unit printing on the one major surface of the recording media, which, according to the invention, includes:

a tray body having a rectangular plate shape made of a material which is not detected by the detecting unit;

a detected portion formed on either one of two major surfaces of the tray body, being detectable by the detecting unit; and

a mounting portion having a mounting recess such that the one major surface of the recording media comes up to substantially same level as one of the major surfaces of the tray body when the recording media is mounted on the transferring tray.

According to a second aspect of the invention, the tray body of the transferring tray includes plural long grooves having plural convex portions and plural concave portions being parallel to the sub scanning direction, wherein the plural convex portions on the one of the major surfaces forms the respective plural concave portions on the other of the major surfaces, and each of the plural convex portions on the other of the major surfaces forms the respective plural concave portions on the one of the major surfaces.

According to a third aspect of the invention, the transferring unit includes a driving roller and a following roller, and wherein a thickness of a starting portion and an end portion of the tray body gradually decreases toward a tip end of the tray body.

According to a fourth aspect of the invention, the tray body has a hole in the mounting recess, being smaller than the mounting recess, for removing the recording media from the transferring tray.

According to a fifth aspect of the invention, the material of the tray body has a black color.

According to a sixth aspect of the invention, the tray body made from an integral molded plastic.

According to a seventh aspect of the invention, the objects can be achieved by a provision of a printing apparatus for printing on one major surface of a recording media having disc shape, which includes:

a carriage having a printing head, reciprocating in a main scanning direction;

a transferring unit transferring the recording media in a sub scanning direction;

a detecting unit detecting the recording media being transferred by the transferring unit;

a recording unit printing on the one major surface of the recording media; and

a transferring tray mounting the recording media thereon, the transferring tray including,

a tray body having a rectangular plate shape made of a material which is not detected by the detecting unit,

a detected portion formed on either one of two major surfaces of the tray body, being detectable by the detecting unit, and

a mounting portion having a mounting recess such that the one major surface of the recording media comes up to a substantially same level as one of the major surfaces of the tray body when the recording media is mounted on the transferring tray.

According to an eighth aspect of the invention, an ejecting unit including an ejection driving roller and an ejection follower roller are provided, and

wherein the tray body of the transferring tray includes plural long grooves having plural convex portions and plural concave portions being parallel to the sub scanning direction, and

wherein the plural convex portions on the one of the major surfaces forms the respective plural concave portions on the other of the major surfaces, each of the plural convex portions on the other of the major surfaces forms the respective plural concave portions on the one of the major surfaces, the convex portion is formed on a portion of the one of major surfaces of the tray body being contact with the ejection follower roller, and the convex portion formed on the portion comes up to a substantially same level as the one major surface of the recording media.

A ninth aspect of the invention provides a transferring tray for a printing apparatus for printing on one major surface of a recording media, wherein the printing apparatus includes, a carriage having a printing head, reciprocating in a main scanning direction, a transferring unit transferring the recording media in a sub scanning direction, and a recording unit printing on the one major surface of the recording media,

wherein the recording media being a thin plate shape is mounted on the transferring tray, the transferring tray to which the recording media is mounted is transferred, serving as the recording media, and the printing head prints on one major surface of the recording media, and

wherein, when the transferring tray is manually set to a predetermined position of a transferring path of the transferring unit, the transferring tray is positioned, based on an outline picture of an element of the printing apparatus drawn on the transferring tray.

According to a tenth aspect of the invention, the predetermined position is located where the outline picture being a similar size of the element overlaps with the element to hide the outline picture by the element.

According to an eleventh aspect of the invention, the outline picture indicates the ejection follower roller of the transferring unit.

According to a twelfth aspect of the invention, the outline picture is drawn with a substantially same color as the element.

According to a thirteenth aspect of the invention, along with the outline picture, an arrow showing a direction for inserting the transferring tray to the printing apparatus is drawn on the transferring tray.

According to a fourteenth aspect of the invention, the recording apparatus further includes a detecting unit detecting the recording media being transferred by the transferring unit, and wherein the transferring tray made of a material which is not detected by the detecting unit while the transferring tray further comprises a detected portion formed on either one of two major surfaces of the tray body, being detectable by the detecting unit.

According to a fifteenth aspect of the invention, the transferring tray further includes a mounting portion having a mounting recess such that the one major surface of the recording media comes up to a substantially same level as one of the major surfaces of the tray body when the recording media is mounted on the transferring tray, and a detaching hole in the mounting recess, being smaller than the mounting recess.

According to a sixteenth aspect of the invention, the transferring tray further includes a first stopper making contact with the carriage when the printing head is closer to the one of the major surfaces of the transferring tray than a predetermined distance, for preventing the printing head from scanning on the transferring tray.

According to a seventeenth aspect of the invention, the transferring tray further includes a second stopper making contact with the carriage when the transferring tray is inserted to the printing apparatus in a direction other than a predetermined direction, irrespective a distance between the printing head and the transferring tray, for preventing the printing head from scanning on the transferring tray, wherein the second stopper is positioned not to make contact with the carriage when the transferring tray is inserted to the printing apparatus in the predetermined direction and the printing head prints on the one major surface of the recording media.

According to an eighteenth aspect of the invention, the recording apparatus further includes a starting end detecting unit having a lever with self-regression to a standing orientation, being pivoted with protruding into the transferring path to be rotatable in the sub scanning direction, for detecting a starting end of the recording media, and

wherein the transferring tray further comprises a protective portion having a shape such that the transferring tray is drawn out from the transferring path without reversely rotating the lever after the transferring tray is inserted to the transferring path of the transferring unit while the one major surface faces to the printing head.

According to a nineteenth aspect of the invention, the transferring tray is transferred as the recording media, and the printing head prints on the one major surface of the recording media having the plate shape.

According to a twentieth aspect of the invention, the printing apparatus further includes a detecting unit detecting the recording media being transferred by the transferring unit, and

wherein the transferring tray further comprises:

a tray body having a rectangular plate shape made of a material which is not detected by the detecting unit;

a detected portion formed on either one of two major surfaces of the tray body, being detectable by the detecting unit; and

a mounting portion having a mounting recess such that the one major surface of the recording media comes up to a substantially same level as one of the major surfaces of the tray body when the recording media is mounted on the transferring tray.

According to a twenty-first aspect of the invention, the tray body of the transferring tray includes plural long grooves having plural convex portions and plural concave portions being parallel to the sub scanning direction, and

wherein the plural convex portions on the one of the major surfaces forms the respective plural concave portions on the other of the major surfaces, each of the plural convex portions on the other of the major surfaces forms the respective plural concave portions on the one of the major surfaces.

According to a twenty-second aspect of the invention, the transferring unit includes a driving roller and a following roller, and wherein a thickness of a starting portion and an end portion of the tray body gradually decreases toward a tip end of the tray body.

According to a twenty-third aspect of the invention, the tray body has a hole in the mounting recess, being smaller than the mounting recess, for removing the recording media from the transferring tray.

According to a twenty-fourth aspect of the invention, the tray body is made of material having a black color.

According to a twenty-fifth aspect of the invention, the tray body is made of plastic material formed in one-body.

According to a twenty-sixth aspect of the invention, the printing apparatus further comprising a detecting unit that detects recording media which is transferred by the transferring unit, wherein

the transferring tray further includes:

a tray body having a rectangular plate shape made of a material which is not detected by the detecting unit;

a detected portion that is detectable by the detecting unit; and

the tray body has a mounting groove, on which the recording media can be mounted so that a printing face of the recording media is arranged at substantially same plane with the plane of the recording media mounting side when the recording media is mounted.

According to a twenty-seventh aspect of the invention, the printing apparatus further includes:

an ejection unit having an ejection driving roller and an ejection follower roller having a teeth; wherein:

the tray body having a plurality of grooves on both sides of the tray body in the direction parallel to the sub scanning direction along which the transferring tray is transferred so that the tray body has a plurality of convex face regions and a plurality of concave face regions; and

the plurality of grooves are formed such that one side of back face of the convex face region becomes the concave face region, and one side of back face of the concave region becomes the convex face region; and a region that contacts with the ejection following roller becomes the convex face region, and the convex face and a printing face of the recording media mounted on the convex face becomes substantially same plane.

According to a twenty-eighth aspect of the invention, the printing apparatus records an image for one scanning on a recording medium by main scanning a printing head at a predetermined printing position in sub scanning direction and records an image on one piece of recording medium by performing a sub scanning with transferring the recording medium in the sub scanning direction after the end of the main scanning and repeating the main scanning and the sub scanning one after another; and

the transferring unit is provided in each of upstream side of the printing position and down stream side of the printing position along the sub scanning direction, and the transferring unit has a first and second paper sending roller that holds and transfers the recording media, and the transferring unit can transfers the recording media in any one of the upstream side and the downstream side of the sub scanning direction; and

the printing apparatus further comprises:

a paper feeding unit provided on most upstream side of the sub scanning direction in the printing apparatus;

a detecting part provided at a position where the optical axis to be detected is positioned at more downstream side than the holding position of the second paper sending roller and second follower roller provided at downstream side of the printing position; the detecting part outputting a voltage according to a reflected light amount of the object at the position and detecting the object by judging whether the detected voltage surpass a predetermined threshold value (T0) at default condition;

a recording unit for recording a value of the detected voltage detected by the detecting part; and

a transferring control unit for transferring the recording media for a predetermined amount downstream side in the sub scanning direction by the transferring unit so that the detection part can detects a tip portion of the recording media; recording a detected voltage (T1) detected by the detecting part at the transferring position and at the same time transferring the recording media to the upstream side in the sub scanning direction by the transferring unit; recording a detected voltage (T2) detected by the detecting part when there is no recording media on the recording unit; calculating a average value (T0Vp) of the detected voltage (T1) and the detected voltage (T2); transferring the recording media to the downstream side in the sub scanning direction by the transferring unit after modifying a predetermined threshold value for detecting the existence of the object to the average value (T0Vp) calculated from the default threshold value (T0); and setting the recording media to an initial position referring to a point where the detected voltage detected by the detecting part reaches to the average value (T0Vp).

According to a twenty-ninth aspect of the invention, the printing apparatus further comprises:

a second detection part provided at a position more upstream side than holding position of the first paper sending roller and first follower roller provided at upstream side of the printing position for detecting an existence of the recording media at the position; and

a third detection part provided at a position between the second detecting part and the paper feeding unit in the sub scanning direction for detecting an existence of the recording media at the position.

According to a thirtieth aspect of the invention, the printing apparatus further comprises:

an initial setting unit for the recording media, the initial setting unit including the transferring unit, which can transfer the recording media in any one of direction of upstream side and downstream side of transferring passage, an optical sensor, a recording unit, and a calculating unit; wherein:

the optical sensor changes an output voltage according to the object;

the recording unit stores predetermined voltage value, which is previously determined;

the transferring unit transfers the recording media for a predetermined distance from the time when the output voltage value of the optical sensor exceeds the predetermined voltage value during transferring the recording media so that the object of the optical sensor becomes the recording media only;

the recording unit records an output voltage value of the optical sensor in the condition as a first measurement value;

the transferring unit further transfers the recording media in the reverse direction toward downstream side of the transferring passage to remove the recording media from a detection range of the optical sensor;

the recording unit records an output voltage value of the optical sensor in the condition as a second measurement value;

the calculation unit calculates an average value of the first measurement value and the second measurement value; and

the transferring unit transferring the recording media upstream side of the transferring passage and transferring the recording media for a predetermined amount referring to a position which is to be an average value calculated by the calculation to perform initial setting of the recording media.

According to a thirty-first aspect of the invention, the optical sensor has a light-emitting element and a light-receiving element, and the optical sensor detects an existence of the object by catching a reflected light that is emitted from the light-emitting element and is reflected from an object with the light-receiving element.

According to a thirty-second aspect of the invention, the transferring tray, on which the optical disc is mounted, can be moved inside the paper passage of the printing apparatus by the transferring unit.

According to a thirty-third aspect of the invention, the transferring unit comprises a structure for sending the recording media by driving a motor with motor driving control unit; and

the printing apparatus further comprising an optical sensor; and

the printing apparatus performing a forward sending and a backward sending of the recording media, which is entered to the detection range of the optical sensor, using a structure for sending the recording media; and detecting a light amount at the forward sending position and the backward sending position of the recording media; and controlling a sending of the recording media with the motor driving control unit based on the detection results; and

a structure for sending the recording media including a roller driven by the motor; and

the optical sensor is arranged at more recording media ejection side than a position of a structure that performs the sending of the recording media in the recording media passage of the printer apparatus.

According to a thirty-fourth aspect of the invention, the transferring unit comprises a structure for sending the recording media by driving a motor with motor driving control unit; and

the printing apparatus further comprising an optical sensor; and

the printing apparatus performing a forward sending and a backward sending of the recording media, which is entered to the detection range of the optical sensor, using a structure for sending the recording media and detecting a light amount at the forward sending position and the backward sending position of the recording media and controlling a sending of the recording media with the motor driving control unit based on the detection results; and

a structure for sending the recording media including a roller driven by the motor and a notched roller which is pushed against the roller, the notched roller holding the recording media together with the roller and sending the recording media; and

an optical axis of the optical sensor is arranged at more recording media ejection side than a center position of the notched roller in the recording media passage.

According to a thirty-fifth aspect of the invention, the transferring unit comprises a structure for sending the recording media by driving a motor with motor driving control unit; and

the printing apparatus further comprising an optical sensor; and

the printing apparatus performing a forward sending and a backward sending of the recording media, which is entered to the detection range of the optical sensor, using a structure for sending the recording media; and detecting a light amount at the forward sending position and the backward sending position of the recording media; and controlling a sending of the recording media with the motor driving control unit based on the detection results; and

a structure for sending the recording media including a roller driven by the motor and a plurality of notched rollers which are pushed against the roller, the notched roller holding the recording media together with the roller and sending the recording media; and

the optical sensor is arranged between the plurality of notched rollers in the paper width direction of the recording media.

According to a thirty-sixth aspect of the invention, the printing apparatus is a printer for performing a printing by scanning a printing head; and

a structure for sending the recording media includes two rollers, which are driven synchronously by same motor through a power transmission mechanism; and

the scanning operation of the printing head is performed at the position between the two rollers in the recording media passage.

According to a thirty-seventh aspect of the invention, the printing apparatus performs a printing operation by driving a sending motor of the recording media with a motor driving control unit to send the recording media in a sub scanning direction and driving a carriage motor to move a carriage, on which the printing head is mounted, in a main scanning direction; and

the motor driving control unit has:

an current detecting unit for detecting a consumption current value of the carriage motor;

a judging unit for judging a type of the recording media installed in the printing apparatus by obtaining information of a detected current value; and

the judging unit judges the recording media has a failure when the consumption current value detected by the current detecting unit exceeds a predetermined value during the process when the consumption current value of the carriage motor is detected while the recording media is sent under a main scanning lines, along which the carriage moves, by a sending motor of the recording media and moves the carriage to a predetermined position on the recording media.

According to a thirty-eighth aspect of the invention, the printing apparatus moves the transferring tray, on which the recording media having a shape of a thin-plate is mounted, in a recording media passage of the printing apparatus with a sending motor of the recording media; and

the printing apparatus has a gap adjusting unit for setting a size of the gap between the printing head and a platen by moving the carriage up and down according to a type of the recording media; and

a convex part, which has a predetermined height against a height of the printing head, is provided on the carriage; and

the convex part contacts with a side face of edge of the recording media when the carriage scans in the condition where the recording media, which has a thickness larger than the thickness of the type of the recording media set by the gap adjusting unit, is positioned under the main scanning line.

According to a thirty-ninth aspect of the invention, the motor driving control unit stops the operation of driving the motor when the judging unit judges the recording media has a failure.

According to a fortieth aspect of the invention, the printing apparatus further comprises:

a screen display unit that can rewrite information, which is to be displayed in a screen, desirably by display control unit; and

the display control unit controls the screen display unit such that the screen display unit displays information for urging resetting the gap adjusting unit to the size of the gap that is adjusted to the recording media mounted in the printer when the judging unit judges the recording media has a failure.

### BRIEF DESCRIPTION OF THE DRAWINGS

FIG. 1A is a flat view of a tray for transmitting according to the present invention. FIG. 1B is a cross sectional view cut along a line F-E shown in FIG. 1A. FIG. 1C is a cross sectional view showing the transferring tray according to the invention cut along a line C-D. FIG. 1D is a cress sectional view cut along a line F-E.

FIG. 2 is a flat view showing relation the try to the recording apparatus according to the present invention.

FIG. 3A is a cross sectional view cut along a line K-G in FIG. 2 showing relation of the tray 1 to the recording apparatus. FIG. 3B is a cross sectional view cut along a line J-I shown in FIG. 2, which shows a relation of the tray to the recording apparatus. FIG. 3C is a cross sectional view cut along a line L-K of FIG. 2 showing relation of the tray to the recording apparatus.

FIG. 4 is a side view showing a main part of an ink jet typed recording apparatus having a constitution capable of transferring a tray for transfer as a material to be recorded.

FIGS. 5A and 5B show a tray for transfer according to the present invention. FIG. 5A is a flat view of surface, FIG. 5B is a side view, and FIG. 5C is a front view.

FIGS. 6A to 6C show the tray for transfer according to the present invention. FIG. 6A is a flat view of back face. FIG. 6B is a cross sectional view of C-C line. FIG. 6C is a cross sectional view of D-D line.

FIG. 7 is a perspective view showing a state where the tray for transfer of the present invention is inserted from a sheet feeder passage provided at the back side of the ink jet typed recording apparatus.

FIG. 8 is a perspective view showing a main part of a state where the tray for transfer of the present invention is inserted from a sheet feeder passage provided at the back side of the ink jet typed recording apparatus.

FIG. 9 is a flat view showing a state before the tray for transfer is set to a predetermined position to be set after the tray for transfer according to the present invention is inserted into the sheet feeder passage of the ink jet type recording apparatus.

FIG. 10 is a flat view showing a state after the tray for transfer is set to a predetermined position to be set after the tray for transfer according to the present invention is inserted into the sheet feeder passage of the ink jet typed recording apparatus.

FIG. 11 is a side view of a main part showing a start where the recording head contacts with a first stopper of the tray for transfer according to the present invention.

FIG. 12 is a side view of a main part showing a state where the lever is contacted with the protection part of means detecting sheet start end of the tray for transfer according to the present invention.

FIG. 13 is a perspective view showing an ink jet type printer to which the present invention is applied looking from a front.

FIG. 14 is a perspective view showing an ink jet type printer to which the present invention is applied looking from a back.

FIG. 15 shows a whole image of a sheet transfer mechanism including a sheet feeder mechanism by hand in the body in the ink jet typed printer shown in FIGS. 13 and 14.

FIG. 16 is a diagram showing a relation of an ink jet printer controller having the sheet transfer mechanism to be applied for the present invention to transfer passage.

FIG. 17A shows a status of the recording medium detected by an optical sensor of a reflection type. FIG. 17B shows a status of the recording medium not detected by an optical sensor of a reflection type.

FIG. 18A is a diagram for explaining a process of changing a detection value of a detector consisting of optical sensors of a reflection type. FIG. 18B shows a status where a leading edge of a recording medium is detected by employing the changed detection value. FIG. 18C is a diagram for explaining the operation of the heading operation.

FIG. 19 is a flowchart showing a sequence of the paper heading operation of the ink jet printer.

FIG. 20 is a flowchart showing a sequence of the paper heading operation of the ink jet printer.

FIG. 21 is a flowchart showing a sequence of the paper heading operation of the ink jet printer.

FIG. 22 is a diagram showing an entire structure of the printer hardware along with a paper feed path in the printer.

FIG. 23 is a perspective view showing an arrangement of the optical sensors in the printer.

FIG. 24 is a schematic view for explaining an actual arrangement of the optical sensors in the printer.

FIG. 25 is a graph for explaining a relationship of an output voltage and a motor control in case of using the optical sensors.

FIG. 26 is a perspective view for explaining the arrangement of the optical sensors in the printer.

FIG. 27 is a diagram showing the printer hardware according to another embodiment of the invention.

FIG. 28 is a diagram showing the main components surrounding the paper feed path of the printer.

FIG. 29 is a block diagram showing the content of the function of the print controller.

FIG. 30 is a diagram showing a status where the transferring tray is fed up to a position below the main scanning line shown in FIG. 28.

FIG. 31A is a diagram showing a confirmation operation of the thickness of the recording sheet. FIG. 31B shows a status where the adaptability of the sheet is confirmed.

FIGS. 32A and 32B are views for explaining a relation between a size of a set paper gaps and a thickness of paper. Each part shown in FIG. 31 is enlarged.

FIG. 33 is a flow chart to explain a procedure of flow in the motor controlling unit when thickness of paper is confirmed in a state shown in FIG. 31A or a state shown in FIG. 32B.

FIG. 34A is a view to explain a reason why the projection has a predetermined margin for the recording head.

FIG. 35 shows a constitution of an optically sensing element used often when the leading edge of paper precisely forwards.

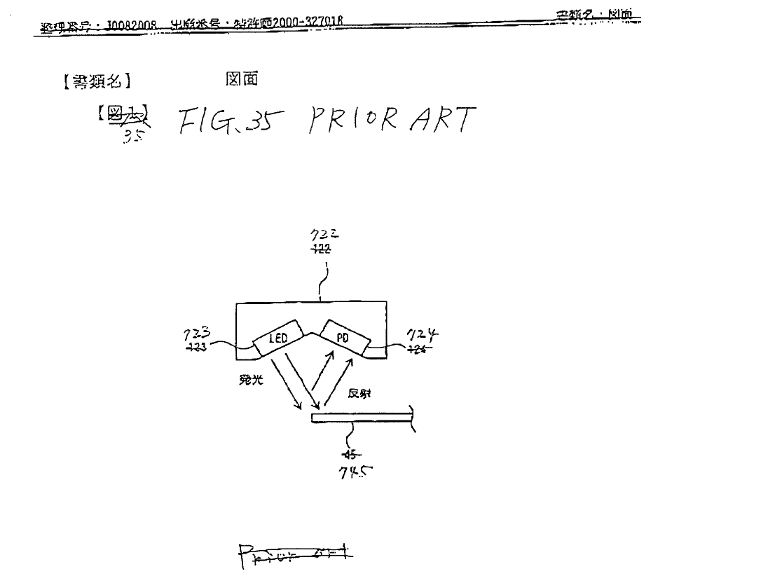

FIG. 36 shows a graph indicating change of an output voltage of the photo diode when paper is fed from the left-handed to the right-hand side in FIG. 35.

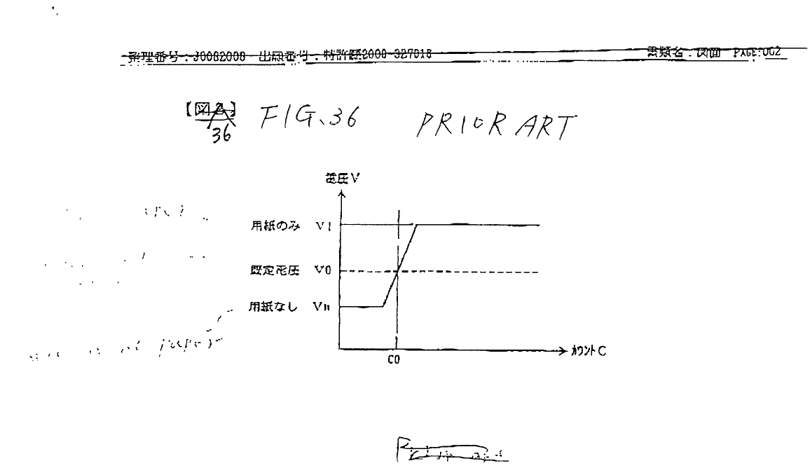

FIG. 37A is a view for explaining a state where there is paper and a state where there is no proper in the graph of FIG. 36.

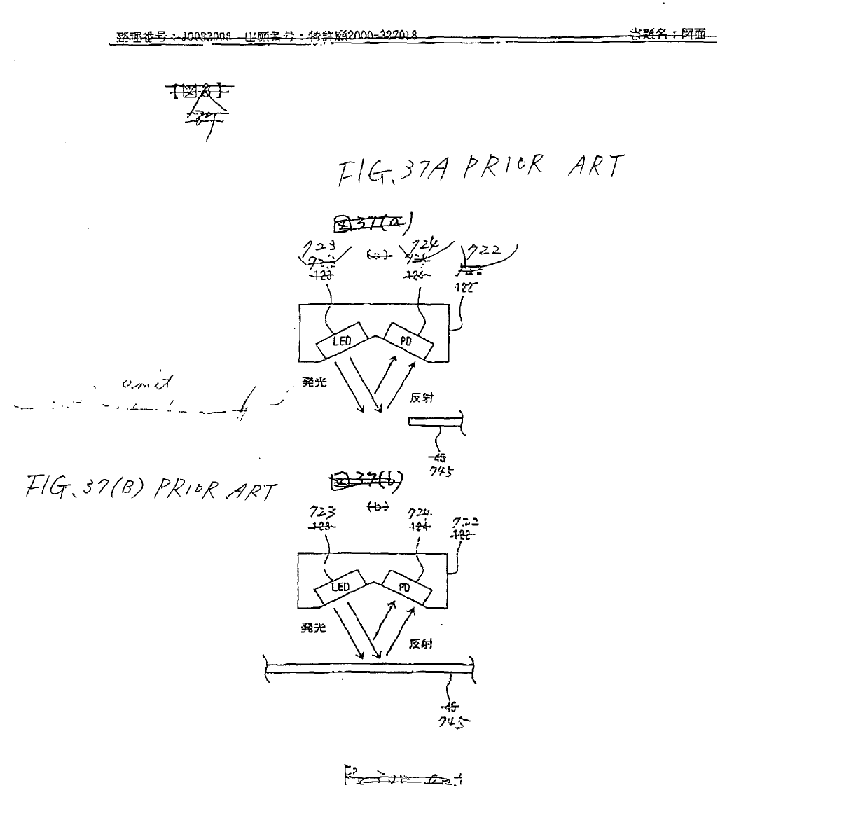

FIG. 38 is a diagram showing the transferring tray an end of which diffuses light beams.

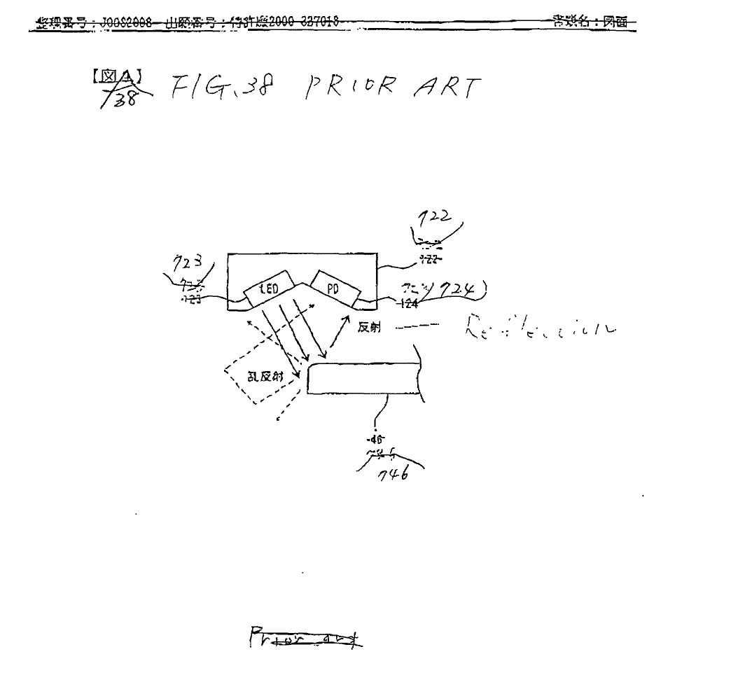

FIG. 39 shows a graph indicating output voltages of photo diode when the transfer tray is fed. Due to diffusion, output voltages increase slowly.

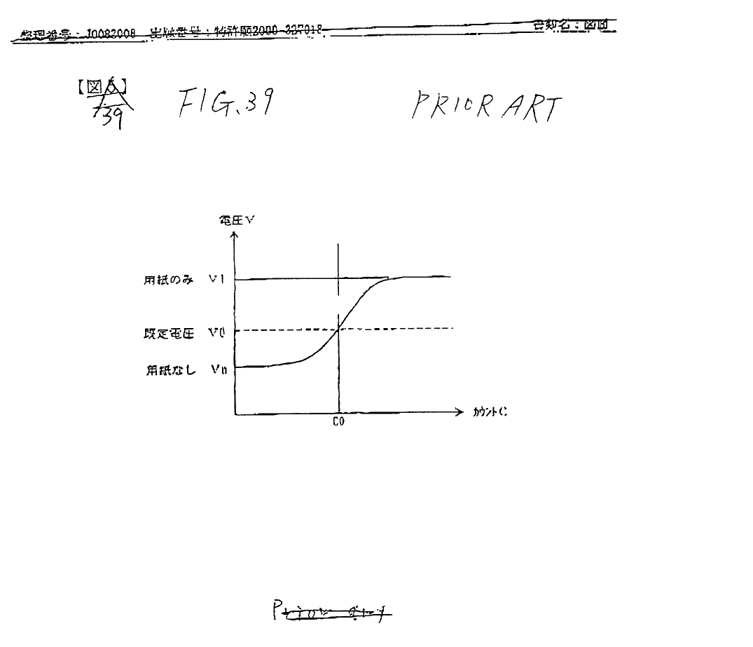

FIG. 40 is a perspective view showing the conventional printer for explaining an arrangement of optical sensors.

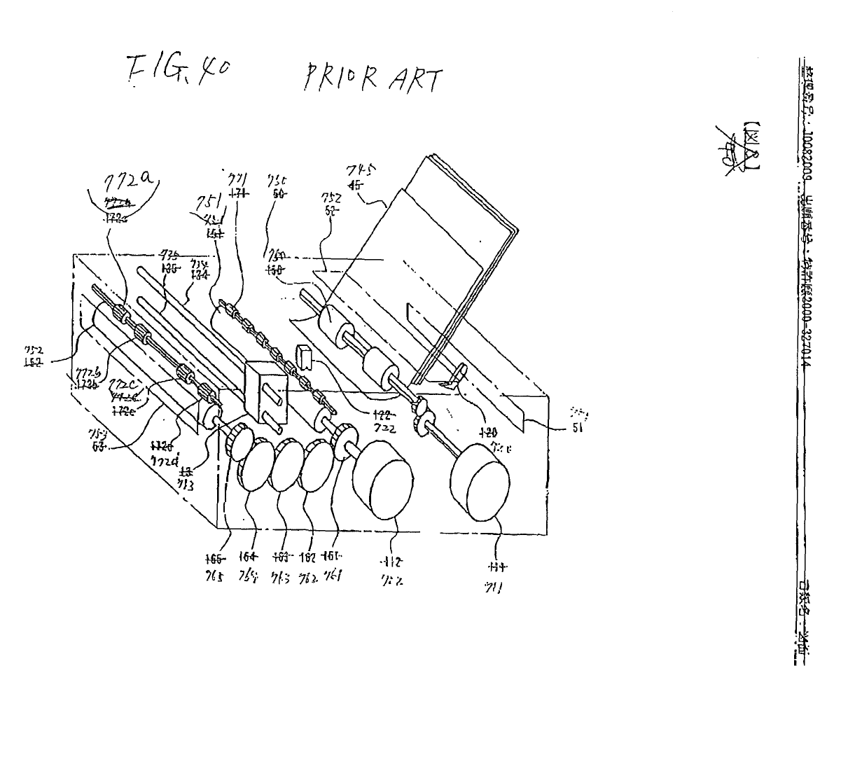

FIG. 41 is a perspective view showing the conventional printer for explaining an arrangement of optical sensors.

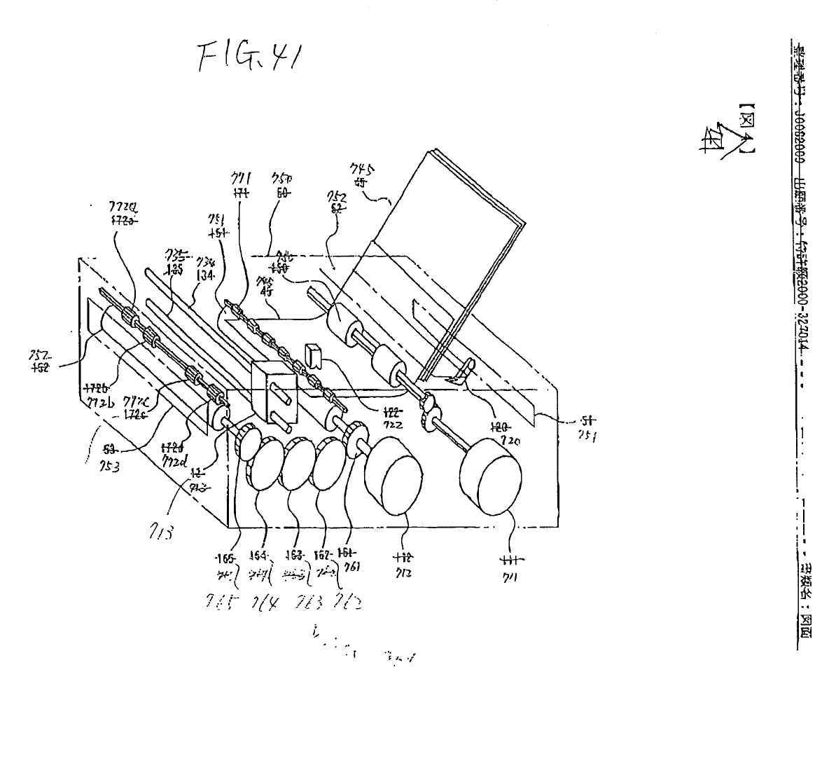

FIG. 42 is a schematic plan view showing a paper discharge following roller.

FIG. 43 is a view in which a main part of FIG. 42 is enlarged and shows a state where a send-out frame is taken off in order to be clear an internal configuration.

FIGS. 44A and 44B are cross-sectional views of a main part of III-III line in FIG. 43.

FIG. 45 is a schematic view showing the status of the paper discharge following roller and the holder when the recording medium is transferred.

FIG. 46 is a sectional view showing an essential part of the paper discharge apparatus in the recording apparatus according to the invention.

FIG. 47 is a sectional view showing an essential part of the ink jet recording apparatus surrounding the recording region.

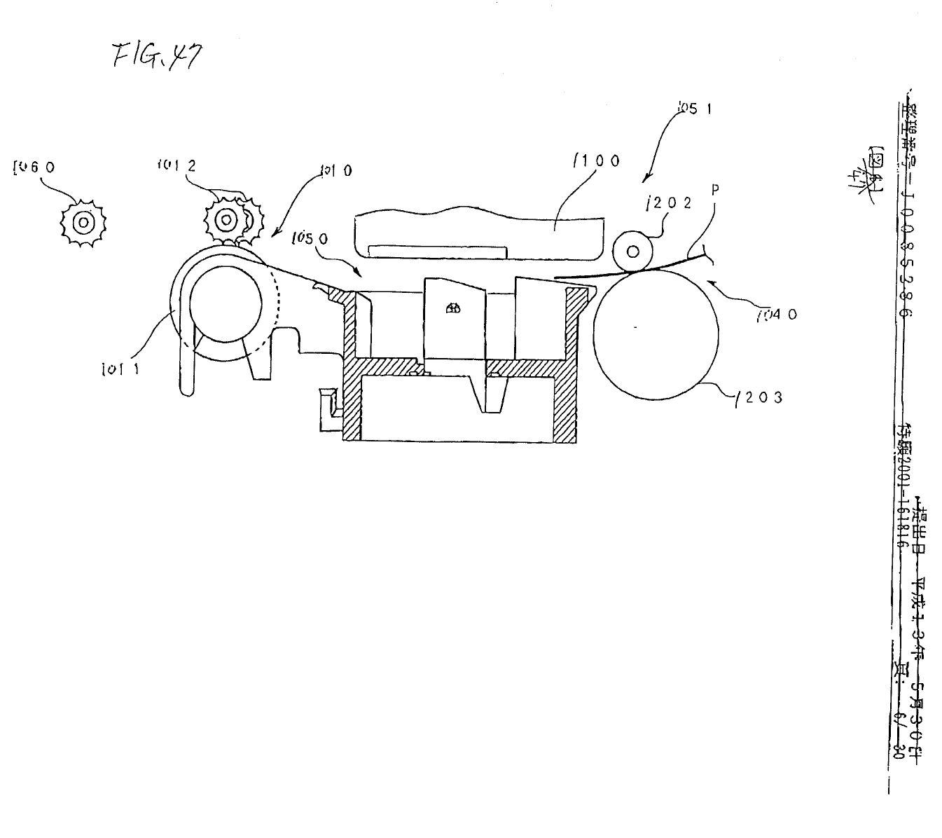

FIG. 48 is a perspective view showing an ink jet printer shown in FIG. 48.

FIG. 49. is a perspective rear side angle view of the ink jet printer in FIG. 48.

FIG. 50 is a block diagram showing the relation of the control means, a paper gap switching means, discharge following roller release means, and a following roller separating means 1200B in paper gap switching means/discharge following roller release means/following roller separating means.

FIG. 51 is a side view showing a detailed example of the control means, the paper gap switching means, the discharge following roller release means, and the following roller release means.

FIG. 52 is a side view showing the first operation of the paper gap switching means/paper discharge following roller release means/following roller spacing means of the ink jet printer shown in FIG. 48.

FIG. 53 is a side view showing the second operation of the paper gap switching means/paper discharge following roller release means/following roller spacing means of the ink jet printer shown in FIG. 48.

FIG. 54 is a side view showing the second operation of the paper gap switching means/paper discharge following roller release means/following roller spacing means of the ink jet printer shown in FIG. 48.

FIG. 55 is a side view showing the third operation of the paper gap switching means/paper discharge following roller release means/following roller spacing means of the ink jet printer shown in FIG. 48.

FIG. 56 is a side view showing the third operation of the paper gap switching means/paper discharge following roller release means/following roller spacing means of the ink jet printer shown in FIG. 48.

FIG. 57 is a side view showing the fourth operation of the paper gap switching means/paper discharge following roller release means/following roller spacing means of the ink jet printer shown in FIG. 48.

FIG. 58 is a side view showing the fourth operation of the paper gap switching means/paper discharge following roller release means/following roller spacing means of the ink jet printer shown in FIG. 48.

FIG. 59 is a perspective view showing an essential part of the paper discharge following roller release means in a status shown in FIG. 51.

FIG. 60 s a perspective view showing an essential part of the paper discharge following roller release means in a status shown in FIGS. 53 and 57.

FIG. 61 is a perspective view showing an essential part of the paper discharge following roller release means in a status shown in FIG. 55.

FIG. 62A is a diagram for explaining the operation of the paper discharge following roller release means. FIG. 62B is a diagram showing its escaped position.

FIG. 63 is a plan view for explaining the plates for use in the slide mechanism of the second release means.

FIG. 64 is a diagram for explaining s status where the plate shown in FIG. 63.

FIGS. 65A and 65B are side views explaining operation to release the discharge following roller with the second release means.

FIG. 66 is a main part front view of the ink jet printer explaining the control part in the second release means.

FIG. 67 is a perspective view of the ink jet printer according to the present embodiment viewed from the front upper side and shows a state where the outside tray is opened.

FIG. 68 is a main perspective view showing a state where a holder is set to the ink jet printer of the embodiment.

FIG. 69 is a main part cross-sectional view of a circumference in FIG. 68.

FIG. 70 is a perspective view showing an essential part of the status of the holder mounted on the side frame opposite side of the status shown in FIG. 68.

FIG. 71 is a side view showing the status of the outside of the side frame of the ink jet printer shown in FIG. 48.

### DETAILED DESCRIPTION OF THE INVENTION

The present invention will now be described based on the preferred embodiments, which do not intend to limit the scope of the present invention, but exemplify the invention. All of the features and the combinations thereof described in the embodiment are not necessarily essential to the invention.

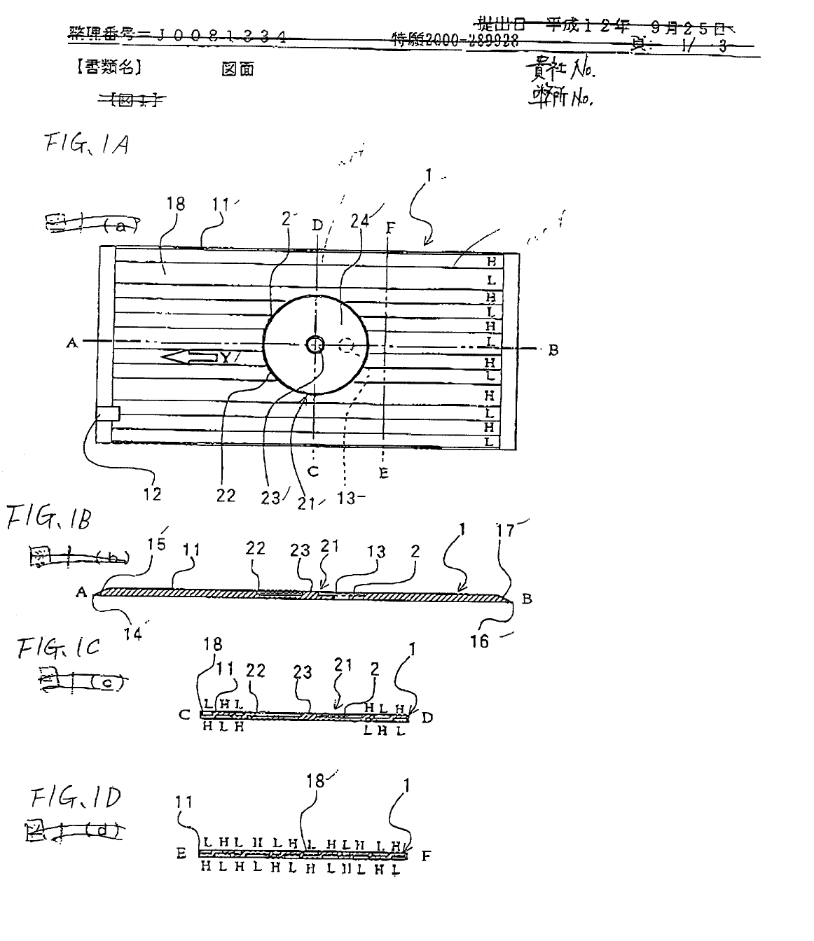

FIG. 1A is a flat view of a tray for transmitting according to the present invention. FIG. 1B is a cross sectional view of code F-code E shown in FIG. 1A. FIG. 1D is a cress sectional view of code F-code E. A constitution of a tray for transmission 1 will be explained referring to FIG. 1B.

The tray for transfer 1 is constituted by a tray body 11 with a rectangular shape and a part to be detected 12. A fitting part 21 in which a circular groove 23 substantially equal to an outer dimension of a recording media 2 and a fixing part 23, which is a circular convex part, fitted to a hole at a center of the recording media 2 is provided at an almost center. The recording media 2 is set to the fitting part 21. The recording media 2 is fitted to the fixing part 23 and is set to the tray body 11. When the recording media 2 is set to the fitting part 21, depth of the circular groove 22 is set to a depth so that height of a printing face for the recording media 2 is almost equal to height of a flat face for the tray body 11. By constituting like this, the tray for transfer 1 to which the recording media 2 is set is transferred as a material to be recorded and a printing task on a label face 24 of the recording media 2 becomes possible. It is possible that the recording media 2 is fitted to the circular groove 22 and fixed without the fixing part 23 of the fitting part 21. However, in consideration of setting the recording media 2 to the tray for transfer 1 with high precisely it is further preferable that the fixing part 23 is provided and the fixing part 23 is fitted to the hole at the center. The circular groove 22 has a hole for taking off the recording media 13. After the recording media 2 is set to the fitting part 21 and the printing task on the label face 24 of the recording media 2 is finished, it becomes possible to easily take off the recording media 2 set to the fixing part 23 by pushing up the recording media 2 from the back side of the fitting part 21 through the hole 13 when the recording media 2 is taken off from the fitting part 21. Therefore, efficiency of the printing task on the label face 24 of the recording media 2 can become improved.

As shown in FIG. 1B, a shape between an end 14 of the tray body 11 where a start point of transfer and a portion around the end 15 is a shape so that thickness of the tray body 11 is continuously reduced gradually with close to the end. A shape between an end 16 of the tray body 11 where a terminal point of transfer and a portion around the end 17 is a shape such as a shape of the end 14 and the portion 15. Thereby, noise, which occurs when the tray 1 is transferred can be reduced and this will be described in relation of the tray 1 to a recording apparatus 50 later.

The tray 11 is formed by a black plastic material by integrally formation and a plurality of long grooves 18 on both faces of the tray 11 so that a plurality of convex shaped areas H and a plurality of recess shaped areas L are arranged parallel to the sub scanning direction. Each of a cross sectional views of FIGS. 1C and 1D show a shape of the grooves 18. The grooves 18 are formed so that a back side area of each of convex shaped areas H at one face side is each of recess shaped areas L and a back side area of recess shaped areas L at one face side is each of convex shaped areas H. Thereby, rigidity of the tray body 11 for warp or deflection becomes high and the tray 1, which hardly occurs can be realized and, further, inferior of printing quality by warp or deflection of the tray 1 can be reduced.

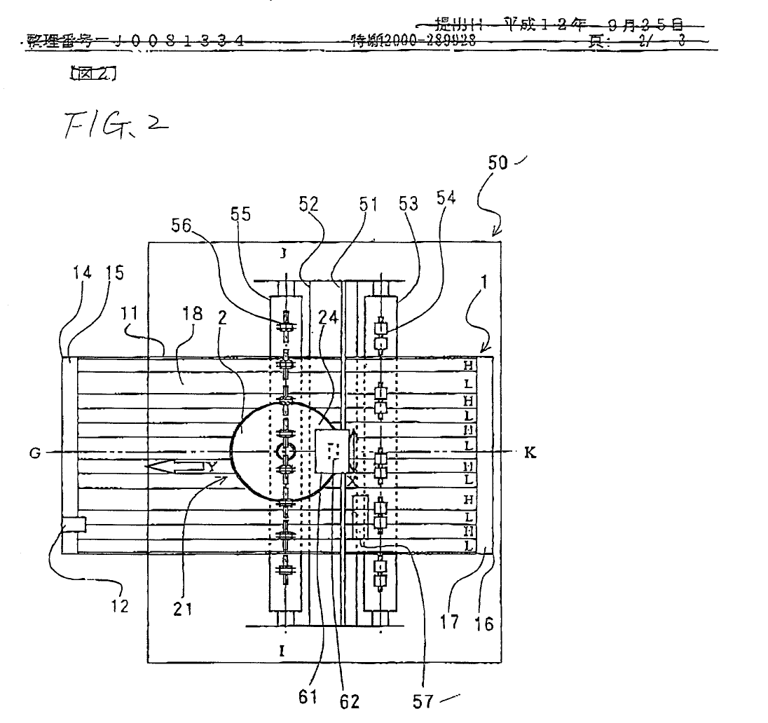

FIG. 2 is a flat view showing relation the try 1 to the recording apparatus 50 according to the present invention. A carriage 61, supported by a carriage guide axis 51, for moving in a main scanning direction X, and a platen 52 are provided in the recording apparatus 50. A recording head 62 ejecting ink on the material to be recorded to print is mounted on the carriage 61. The printing task is carried out by ejecting ink with the recording head 62 while the carriage 61 is transferred in the main scanning direction X and, in the sub scanning direction Y, the material to be recorded is transferred between the carriage 61 and the platen 52. A transfer driving roller 53 and a transfer following roller 54 are provided as a recording sheet transfer means for transferring the material to be recorded in the sub scanning direction Y. The roller 53 is rotationally controlled by rotation driving force such as a stepping motor and the sheet to be recorded is transferred in the sub scanning direction by rotation of the roller 53. The roller 54 is multiple and each of the roller is forced to the roller 53. When the material to be recorded is transferred by rotation of the roller, the roller 54 is contacted with the material to be recorded and rotated accordance with transfer of the material to be recorded.

On the other hand, a discharge driving roller 55 and a discharge sub roller 56 are provided as a means for discharging the printed sheet to be recorded. The roller 55 is rotationally controlled by rotation driving force such as the stepping motor and the sheet to be recorded is sent out in the sub scanning direction Y. The roller 56 is multiple and each has a plurality of teeth on circumference thereof. The roller 56 is a roller with teeth in acute shape so that a tip of each tooth is contacted at a point on the printing screen of the sheet to be recorded. Each of the roller 56 of multiple is forced to the roller 55 with weaker force than force of the roller 54. When the sheet to be recorded is sent out by rotation of the roller 55, the roller 56 is contacted with the sheet to be recorded and rotated accordance with sent out the sheet to be recorded. A detecting means of the material to be recorded 57 for detecting an end of the material to be recorded is provided in the recording apparatus 50. The detecting means 57 detects a transfer position of the material to be recorded in the sub scanning direction Y. The printing task on a predetermined position is performed. In FIG. 2, the material to be recorded is the tray 1, however, a feeding means by a feeding tray and a feeding roller (not shown) are provided in the recording apparatus 50. It is constituted that the printing task on recording paper can be performed. Recording paper such as normal paper or photo paper is used as the material to be recorded.

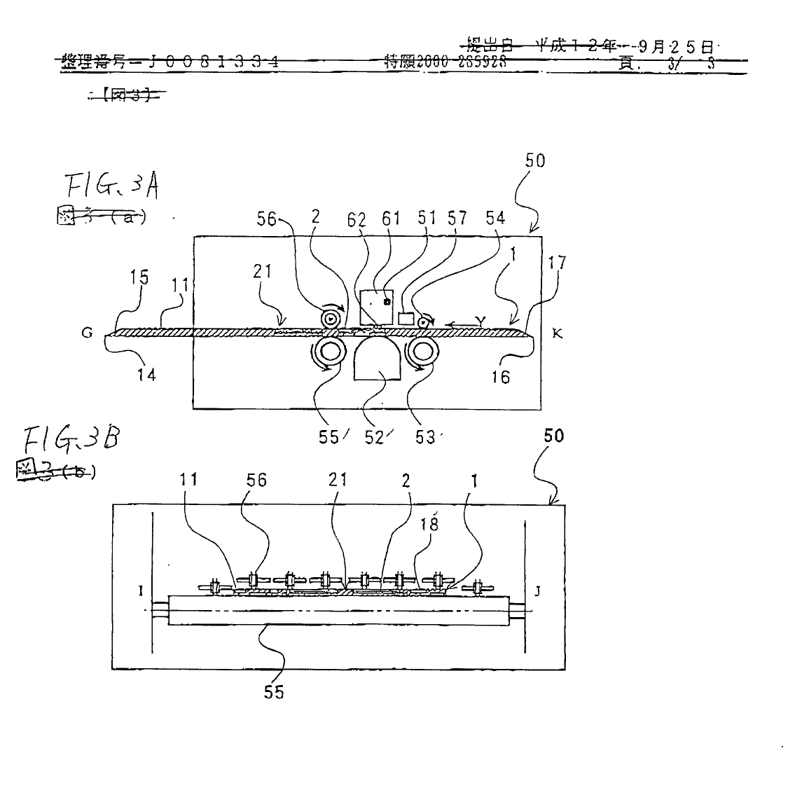

The tray 1 to where the recording media 2 is set is used as the material to be recorded. In the recording apparatus 50 like the above constitution, relation of the tray 1 to the recording apparatus 50 when the printing task on the label face 24 of the recording media 2 is performed will be described referring to FIG. 3.

In the present embodiment, light by light-producing element is reflected to the material to be recorded. The detecting means 57 detects the material to be recorded by detecting the reflected light. The tray 11 is formed by black plastic material by integrally formation. The detecting means 57 does not detect the material to be recorded by using tray 11 of black color and low of a light reflection ratio. In contract, the part to be detected 12 is a member with a high reflection ratio, thereby the part to be detected 12 can be detected by the detecting means 57 and is provided around the end 15 at a face side setting the recording media 2 of the tray 11.

By constituting the tray 1 like this, the only part to be detected 12 of the tray 1 is detected by the detecting means 57 as the material to be recorded. In a case where it is erroneously intended to print on a face at the back side of a face to which the recording media 2 is set, the tray 1 is not detected by the detecting means 57 and the printing task is not performed. Thereby, it becomes possible to prevent from erroneously printing on the tray 1 itself. Printing on the face at the back side of the face to which the recording media 2 is set is prevented and it becomes possible to efficiently print on the label face 24 of the recording media 2.

FIG. 3A is a cross sectional view cut along a line K-G in FIG. 2 showing relation of the tray 1 to the recording apparatus 50.

The end 14 of the tray 11 which is the start point of transfer of the tray 1 is sandwiched between the roller 55 and the roller 56 forced to the roller 55 so that the roller 56 is pushed up.

A shape around the end 15 of the tray 11, as aforementioned, thickness of the tray body 11 is continuously reduced gradually with close to the end. A load to the roller 54 and the roller 56 decreases when the tray 1 is sandwiched so that the tray 1 pushes up the roller 54 and the roller 56. It becomes possible to transfer the tray 1 further smoothly.

After printing on the label face 24 of the recording media 2 is finished, the end 16 of the tray body 11, which is the terminal point of transfer of the tray 1 is passed from between the roller 53 and the roller 54 forced to the roller 53 and further passed from between the roller 55 and the roller 56 forced to the roller 55. The tray 1 is sent out from the recording apparatus 50. As aforementioned above, a shape of a portion around the end 17 of the tray body 11 where a terminal point of transfer is a shape so that thickness of the tray body 11 is continuously reduced gradually with close to the end. When the tray 1 is passed from between the roller 53 and the roller 54 forced to the roller 53 and further passed from between the roller 55 and the roller 56 forced to the roller 55, noise, which occur due to contact of the roller 53 with the roller 54 and contact of the roller 55 with the roller 56 is reduced. Thereby, the printing task with low noise can be performed.

FIG. 3B is a cross sectional view cut along a line J-I shown in FIG. 2, which shows a relation of the tray 1 to the recording apparatus 50. FIG. 3C is a cross sectional view cut along a line L-K of FIG. 2 showing relation of the tray 1 to the recording apparatus 50. In a case where the long groove 18 of the tray body 11 is formed so that each roller passing on the recording media 2 among the roller 54 of multiple and the roller 54 of multiple, and is contacted with the recess shaped area L; the roller is mounted over the recording media 2 when the roller is passed on the recording media 2. The recording media 2 is set to the fitting part 21 of the tray 1. The recess shaped area L is formed by the long groove 18 at the side of the fitting face to which the recording media 2 is set of the tray body 11. The recording media 2 is tilted by mounting over the roller and this leads to inferior of printing quality, or the recording media 2 is hooked over the teeth of the roller with teeth in a case of the roller with teeth such as the roller and there is probability that the roller 56 is broken. To prevent like this, as shown in FIG. 3B, the long groove 18 of the tray body 11 is formed so that each roller passing on the recording media 2 among the roller 56 of multiple and the roller 54 of multiple, and is contacted with the recess shaped area L; the roller is mounted over the recording media 2 when the roller is passed on the recording media 2. Thereby, the printing task with high precisely can be possible.

The tray 1 in the present embodiment can print on the label face 24 of the recording media with efficiency high quality and low noise.

There is the tray 1 without the plurality of long grooves 18 on the tray body 11 as another embodiment. In another embodiment, although manufacturing cost of the tray body 11 can be reduced by no having the grooves 18 on the tray body 11, rigidity for warp or deflection of the tray body 11 becomes low. Therefore, it is preferable to use a material in which warp or deflection for the material of the tray body 11 hardly occurs.

Further, as another embodiment, it is possible to use the recording apparatus 50 mounted on the recording apparatus 50 instead of the tray 1 according to the present invention. Of course, it is possible to implement the present invention even with the roller 56 in the recording apparatus 50 being a following roller besides a roller with teeth. The tray body 11 is formed by a black plastic material by integrally formation and can also be formed by another material such as the bristol board, or by a plurality of members. Further, color of the tray body 11 is not limited to black color.

According to the present invention, erroneous printing on the tray is prevented, reduction of printing quality by warp or deflection of the tray 1 lowers, and the printing task on the label face of the recording media with efficiently high printing quality and low noise becomes possible by the tray for transfer so that noise to occur when the tray 1 is transferred is reduced.

Next, another embodiment of the present invention will be described. In the present embodiment, all constitutions of FIGS. 1 to 3 may be provided or not may be provided.

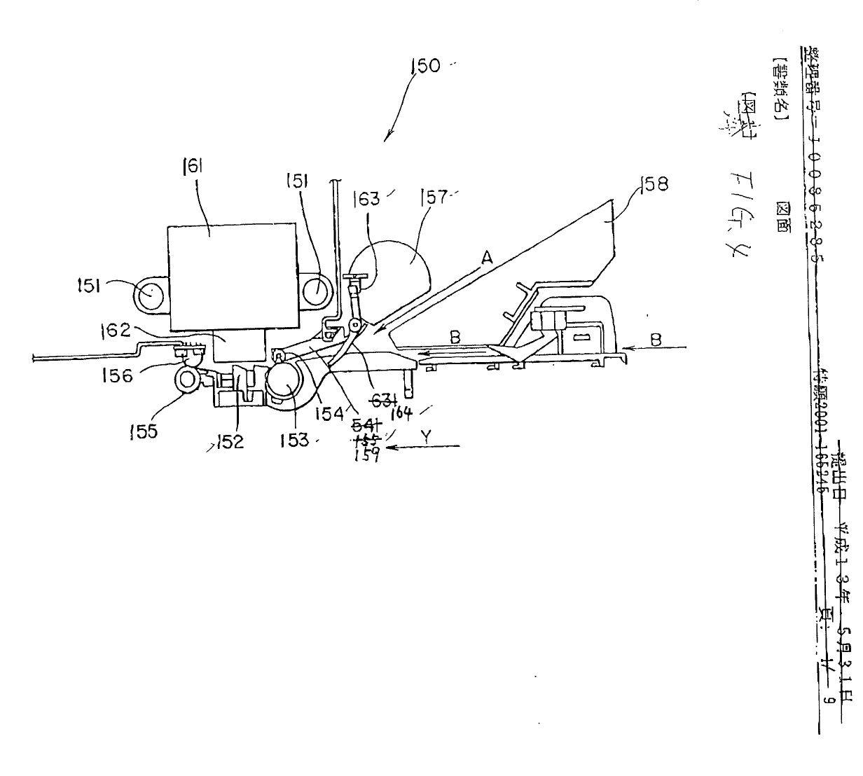

FIG. 4 is a side view showing a main part of an ink jet typed recording apparatus having a constitution capable of transferring a tray for transfer as a material to be recorded.

An ink jet typed recording apparatus 150 provides with a carriage 161, supported by two carriage guide shafts 151, for moving in a main scanning direction as a recording means recording on a material to be recorded. A recording head 162 jets ink on the material to be recorded to record is mounted on a carriage 161.

A platen 152 determining a gap is provided. The platen 152 faces the recording head 162 and the gap is between a head face of the recording head 162 and the material to be recorded. A printing task is carried out by ejecting ink with the recording head 162 while the carriage 161 is transferred in the main scanning direction and, in the sub scanning direction Y, the material to be recorded is intermittently transferred between the carriage 161 and the platen 152.

It is constituted that a sheet feeder tray 158 is capable of feeding a material to be recorded such as normal paper or photo paper and the tray 158 has an auto sheet feeder (ASF) in order to automatically feed the sheet to be recorded. The ASF is an auto sheet mechanism having a sheet feeder roller 157 provided to the sheet feeder tray 158 and a separating bad (not shown). The roller 157 is rotationally controlled by rotation driving force such as a stepping motor and has a shape of a substantial “D” shaped vertical cross sectional face. When multiple sheets to be recorded on the tray 158 is fed by the rotational driving force of the roller 157 and friction resistance of the separating bad, the multiple sheets are not fed once and a piece of sheet is automatically fed accurately.

The sheet to be recorded with a predetermined volume is intermittently transferred toward the downstream of the sub scanning direction Y with a recording sheet transfer means. The sheet is automatically fed in a direction shown with a code A arrow by the ASF. The recording sheet transfer means arranged at the downstream of the sub scanning direction Y from the roller 157. The downstream of the sub scanning direction Y is the side to be recorded.

A transfer driving roller 153 and a transfer following roller 154 are provided as the recording sheet transfer means for intermittently transferring the sheet to be recorded in the sub scanning direction Y. The transfer driving roller 153 is rotationally controlled by rotation driving force such as a stepping motor and a sheet to be recorded is transferred in the sub scanning direction by rotation of the roller 153. A carriage 61, supported by a carriage guide axis 51, for moving in a main scanning direction X, and a platen 52 are provided in the recording apparatus 50. The roller 154 is supported by a transfer following roller holder 159 of multiple and each holder 159 is forced to the roller 153. When the sheet to be recorded is transferred by rotation of the roller 153, the roller 154 is rotated following transfer of the sheet to be recorded while the roller 154 contacts with the sheet to be recorded.

A sheet detector 163 known in the prior art is arranged between the roller 157 and the roller 153. The sheet detector 163 has a lever 164 to which self recovery nature to stand itself is given and is supported in a state where the lever 164 projects in a transfer passage of the sheet to be recorded so that the lever 164 can be rotated in the only recording sheet transfer direction. The sheet detector 163 is constituted so that the lever 164 is rotated by pushing a tip of the lever 164, thereby the sheet to be recorded is detected. The sheet detector 163 detects a start end position and a terminal position of the sheet to be recorded fed by the roller 157, a recording area is determined based on the detected position, and recording is carried out.

On the other hand, a discharge driving roller 155 and a discharge sub roller 156 are provided as a means for discharging the recorded sheet to be recorded. The roller 155 is rotationally controlled by rotation of the driving force such as the stepping motor and, by rotation of the roller 155, the sheet to be recorded is sent out in the sub scanning direction Y. The roller 156 has a plurality of teeth on circumference thereof. The roller 156 is a roller with teeth in acute shape so that a tip of each tooth is contacted at a point on the recording face of the sheet to be recorded. Each of the roller 156 of multiple is forced to the roller 155. When the sheet to be recorded is sent out by rotation of the roller 155, the roller 56 is contacted with the sheet to be recorded and rotated accordance with sent out the sheet to be recorded.

The recording apparatus 150 provides with a sheet feeder passage shown with a code B arrow for feeding the sheet to be recorded or the tray for transfer of the present invention other than the sheet feeder passage by the ASF as described above (Passage shown with the code A arrow). The sheet such as a bristol board has low flexibility.

The recording apparatus 150 is constituted so that recording on the sheet to be recorded fed from the sheet feeder passage can be carried out as similar to that recorded fed from the ASF.

When a tray transfer 101 is set to a predetermined position, the tray for transfer 101 is inserted to the sheet feeder passage to be set to the predetermined position in a state where the roller 154 is separated from the roller 153. The recording apparatus 150 provides with a transfer following roller release mechanism (not shown) for release the separating state and for recovering a state to a state where the roller 154 is forced to the 153d. after the tray 101 is set to the predetermined position to be set.

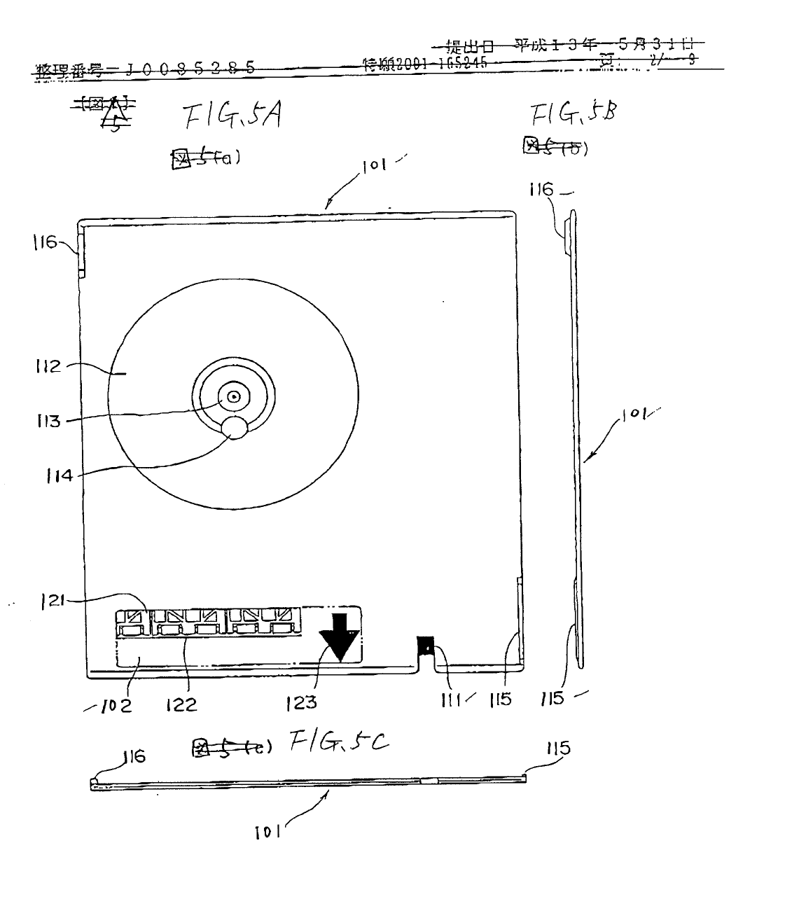

FIGS. 5A and 5B show a tray for transfer according to the present invention. FIG. 5A is a flat view of surface, FIG. 5B is a side view, and FIG. 5C is a front view.

The tray for transfer 101 is a rectangular thin plate and made of a resin member such as plastic by injection formation. In the present embodiment, the tray 101 is made of the resin member of black color not detected with a sensor detecting a tray for transfer (not shown) by an optical sensor mounted on the ink jet typed recording apparatus. A part to be detected 111 is constituted by a member with a high optical reflection ratio and can be detected by the sensor detecting the tray for transfer. It is constituted so that a position of thin typed sheet to be recorded set on the tray for transfer can be recognized by detecting the part to be detected 111 with the sensor detecting a tray for transfer.

A circular groove 112 is formed on a surface of the tray 101 and a convex part 113 around center of the circular groove 112. A thin typed sheet to be recorded such as a CD-R is set to the circular groove 112. A hole 114 to take off the sheet as shown in FIGS. 5A and 5B is formed on the circular groove 112. It becomes possible to easily take off the sheet by pushing up the CD-R from the back side of the tray 101 through the hole 114 when the sheet to be recorded set to the circular groove 112 is taken off.

A first stopper 115 and a second stopper 116 are formed on a surface of the tray 101 as shown in the figure drawing. The stopper 115 and the stopper 116 will be described later.

A label 102 is stuck on a surface of the tray 101. An outline 121, a guide line 122 and an arrow 123 are displayed on the label 102. The outline 121 is to model display outline of the roller 154 and the holder in an actual size. The outline 121 becomes mark when the tray 101 is inserted into the sheet feeder passage and is set to the predetermined position to be set. The tray 101 can accurately and easily be set to the predetermined position by inserting the tray 101 into the sheet feeder passage and matching the outline 121 with the roller 154 and the holder 159. A task to match the outline 121 with the roller 154 and the holder 159 become easier by overlaying a roller face of the roller 154 on the guide line 122.

An arrow 123 shows a direction inserting the tray 101 into the sheer feeder passage. Since a direction inserting the tray into the sheer feeder passage is shown, probability to insert erroneous direction of the tray 101 is reduced.

The outline 121, the guide line 122, and the arrow 123 are not displayed by sticking the label 102 as the present embodiment. The printing task may be perform on the tray 101. The guide line 122 may not be provided. The outline 121 is not limited to the roller 154 and the holder 159. The outline 121 may be any constitution element if element is constitution element of the recording apparatus 150. The outline 121 is easily recognized if the outline 121 is colored as the almost same color as color of constitution element of the recording apparatus 150 shown by the outline 121.

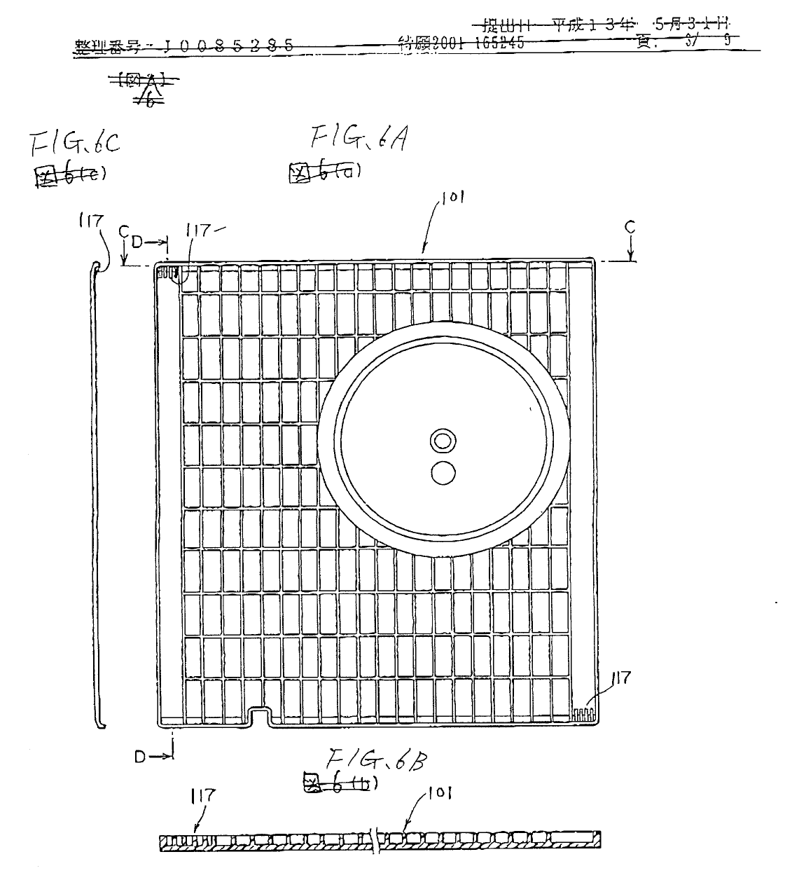

FIGS. 6A to 6C show the tray for transfer 101 according to the present invention. FIG. 6A is a flat view of back face. FIG. 6. is a cross sectional view of C-C line. FIG. 6C is a cross sectional view of D-D line.

A plurality of ribs are respectively formed in a vertical direction and a horizontal direction on a back face of the tray 101. The ribs can reduce warp or deflection of the tray 101, thereby sufficient strength and precision can be obtained.

A protection part of means detecting sheet start end 117 is formed on the tray. The protection part 117 forms a inclined surface with a plurality of ribs shown in the drawing. After the front face and the back face of the tray 101 reverse and the tray 101 is inserted, the inclined surface is formed at a step portion where the lever 164 of the sheet detector 163 slides when the tray 101 is pulled out. In the present embodiment, the inclined surface is formed at the step portion of the rib formed at an end of the tray 101.

Due to the tilted face, after the front face and the back face of the tray 101 reverse and the tray 101 is inserted, the lever 164 of the sheet detector 163 is caught at the step portion of the rib formed at the end of the tray 101 when the tray 101 is pulled out. It is prevent from functioning a force rotating the lever 164 in a direction opposed to a rotatable direction due to the lever's catch. Thereby, probability to break the lever 164 can be reduced. Since the protection part 117 is formed at a centrosymmetry position with respect to a substantially proximal point of the tray 101 as center of symmetry 101, it can prevent from catching the lever 164 at the step portion without relation of direction inserting the tray 101.

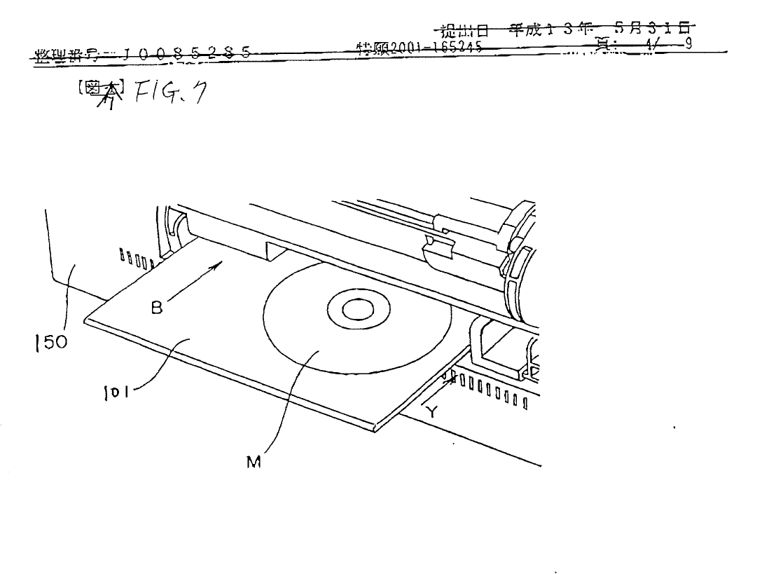

FIG. 7 is a perspective view showing a state where the tray for transfer 101 of the present invention is inserted from a sheet feeder passage provided at the back side of the ink jet typed recording apparatus 150.

In a state where a CD-R (Code M) as a thin typed sheet to be recorded is set to the tray 101, the tray 101 is inserted into the sheet feeder passage and is set to a predetermined position.

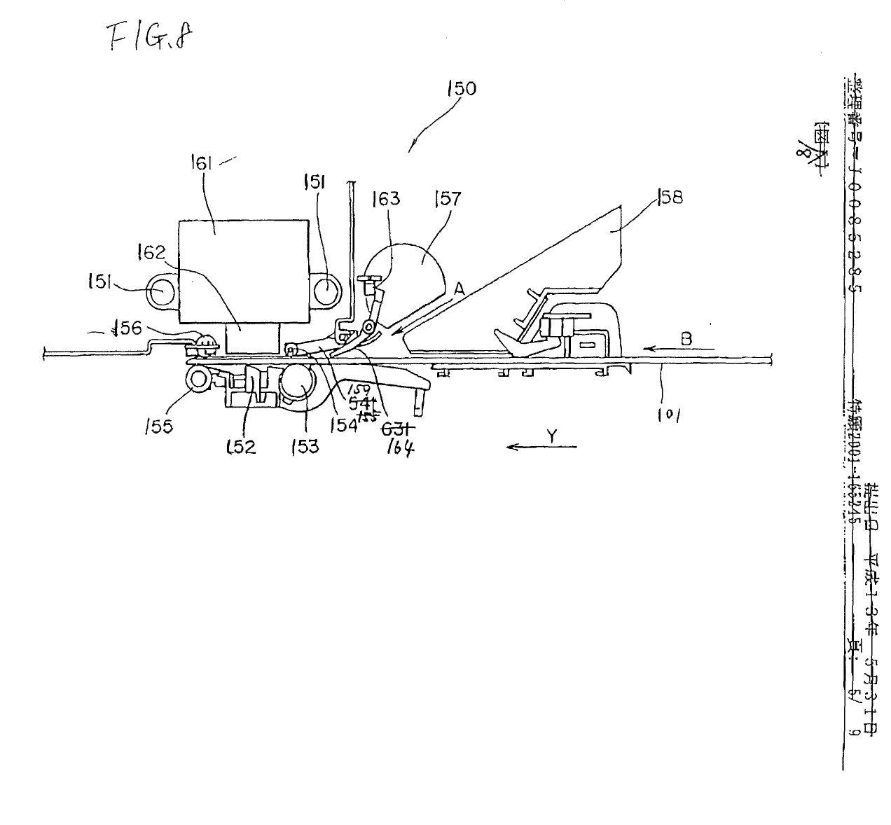

FIG. 8 is a perspective view showing a main part of a state where the tray for transfer 101 of the present invention is inserted from a sheet feeder passage provided at the back side of the ink jet typed recording apparatus 150.

The tray 101 is inserted into the sheet feeder passage of an arrow direction shown with the code B and is set to a predetermined position. A distal portion of the tray 101 rotates the lever 164 of the sheet detector 163 projecting in a transfer passage. The tray 101 is intermittently transferred in the sub scanning direction similar to recording paper such as paper by rotation of the roller 153 in the sub scanning direction Y in a state where the tray 101 is pushed on by a force functioning to the roller 154. Ink is jetted from the recording head 162 mounted on the carriage 161 reciprocating in the main scanning direction while the CD-R set to the tray 101 is intermittently transferred in the sub scanning direction Y. The printing task is performed on the surface.

When the printing task on the CD-R is performed, two carriage guide shafts 151 are moved to upper and lower directions.

The carriage 151 is arranged at an upper position for thickness of the tray 101 so that a gap between a surface of the CD-R and a head face becomes appropriate a PG by a mechanism (not shown) to adjust the PG of the gap between a head face of the recording head 162 and a recording face of the sheet to be recorded. The roller 156 is not contacted with the sheet to be recorded by a discharge following roller release mechanism (not shown) arranging the roller 156 at the upper position to prevent from damaging on the surface of the CD-R by sharpen teeth of the roller 156.

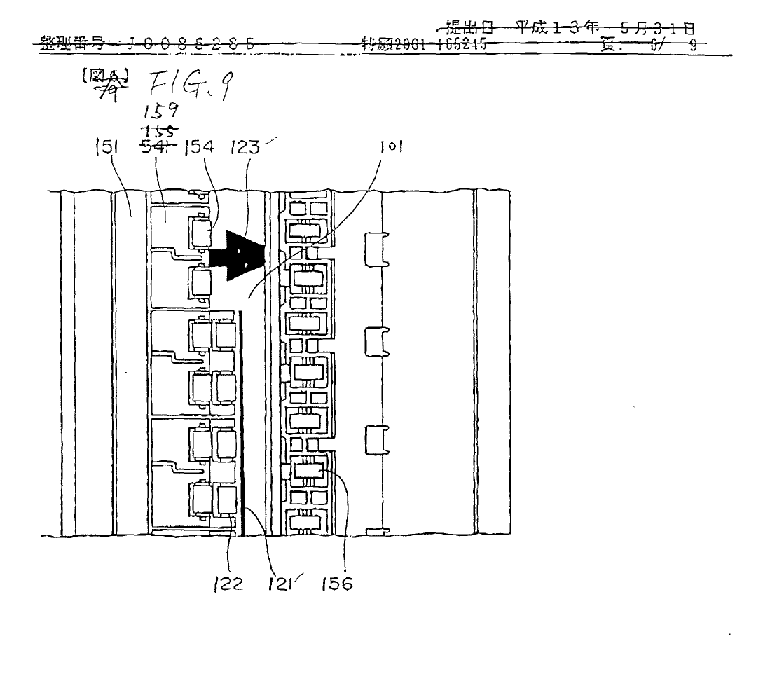

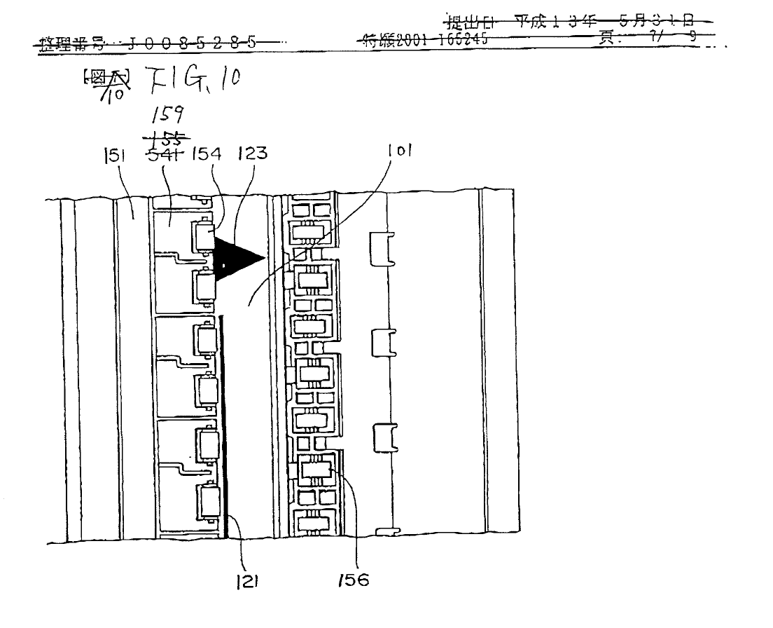

FIG. 9 is a flat view showing a state before the tray for transfer is set to a predetermined position to be set after the tray for transfer according to the present invention is inserted into the sheet feeder passage of the ink jet type recording apparatus. FIG. 10 is a flat view showing a state after the tray for transfer is set to a predetermined position to be set after the tray for transfer according to the present invention is inserted into the sheet feeder passage of the ink jet typed recording apparatus.

The tray 101 is inserted into the sheet feeder passage in a direction shown with the arrow 123 as shown FIG. 9. A position of outline 121, a position of the roller 154 and a position of the holder 159 are respectively confirmed. The outline 121, the roller 154 and the holder 159 are matched as shown in FIG. 10. The tray 101 can easily be set to an accurately position to be set by matching the guide line 122 with a roller face of the roller 154.

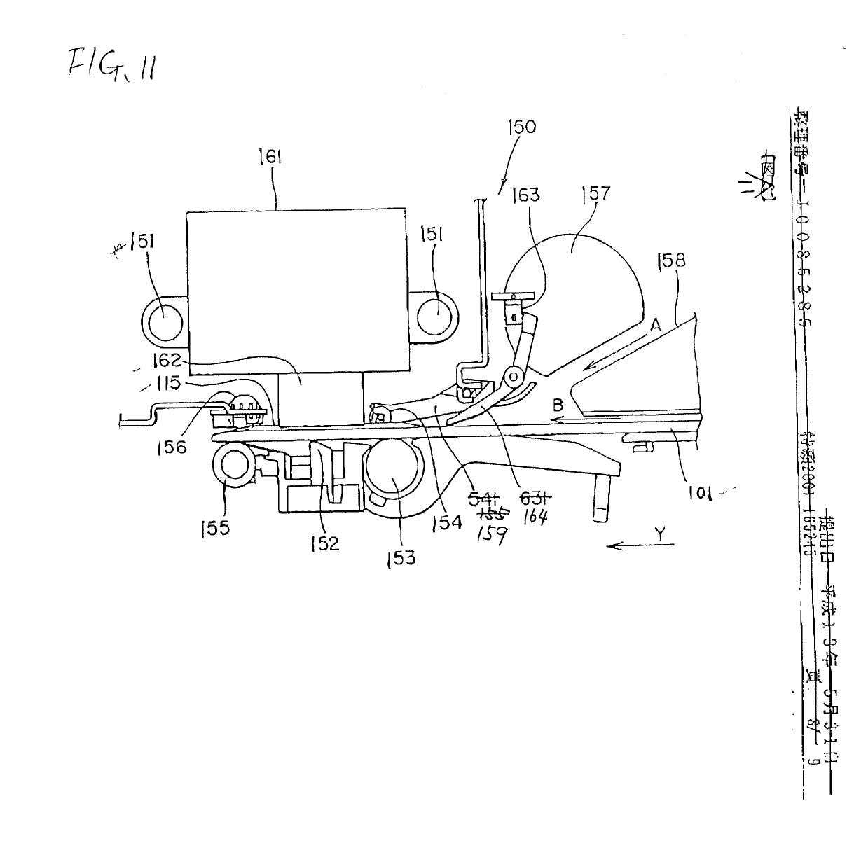

FIG. 11 is a side view of a main part showing a start where the recording head 162 contacts with a first stopper 115 of the tray for transfer 101 according to the present invention.

When the printing task on the CD-R is performed, the carriage 151 is arranged at an upper position for thickness of the tray 101 so that the gap between the surface of the CD-R and the head face becomes appropriate the PG by the mechanism moving two carriage guide shafts 151 to upper and lower directions.

As aforementioned, when the printing task on the CD-R has been performed regardless of below a predetermined PG, there are probability that this causes inferior in recording quality or dirty of the head due to an ink stain on the head face of the recording head 162. In some cases, there are probability that contact the head face with the surface of the tray 101 causes dirty of the tray 101 or damage of the head face.

The stopper 115 is formed on the tray 101 to prevent from performing the printing task not arranging the carriage 151 at the upper position.

when the gap between the surface of the CD-R and the head face is below a predetermined PG, the side face of the recording head is contacted with the stopper 115. It is prevented that the recording head 162 scans on the tray 101. Since there is probability the recording head 162 is damaged in a case where the stopper 115 is directly contacted with the recording head 162, it is preferable that a wall to protect the recording head 162 is formed on the carriage 161 and the wall is contacted with the stopper 115.

The discharge following roller release mechanism arranging the roller 156 at the upper position is constituted so as to operate in liaison with mechanism moving two carriage guide shafts 151 to upper and lower directions, to prevent from damaging on the surface of the CD-R by sharpen teeth of the roller 156. Thereby, it is also possible to prevent that contact of the roller 156 causes damage of the screen face of the CD-R by the stopper 115.

When the tray 101 is inserted from a direction different from a predetermined direction, that is, when erroneous insertion is made, the stopper 116 prevents that the recording head 162 scans on the tray 101 without relation of the PG.

Similar to the stopper 115, it is prevented that the side face of the recording head 162 is contacted with the stopper 116 and the recording head 162 is scanned on the tray 101. Therefore, the stopper 116 is formed so as to have higher height than height of the stopper 115.

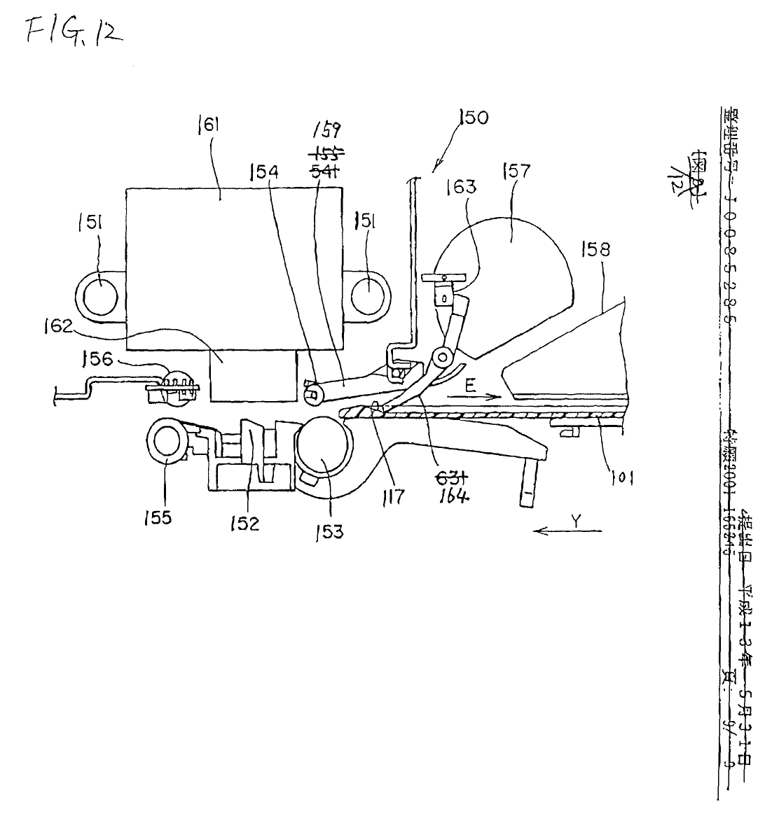

FIG. 12 is a side view of a main part showing a state where the lever 164 is contacted with the protection part of means detecting sheet start end 117 of the tray for transfer 101 according to the present invention.

As aforementioned, the protection 117 forms the inclined surface at the step portion of the rib formed at an end of the tray 101. Due to the inclined surface, after the front face and the back face of the tray 101 reverse and the tray 101 is inserted, it is prevent the lever 164 of the sheet detector 163 is caught at the step portion of the rib formed at the end of the tray 101 when the tray 101 is pulled out in a direction shown with a code E arrow. It is prevent from functioning a force rotating the lever 164 in a direction opposed to a rotatable direction due to the lever's catch. Thereby, probability to break the lever 164 can be reduced.

As another embodiment, a shape of the circular groove 112 is a shape so that, for example, an IC card can be set. Thereby, it is also possible to print on a surface of the IC card. Further, the sheet to be recorded is not limited to the CD-R or IC card.

It becomes possible to print on various sheet to be recorded by changing the shape of the circular groove 112 so that a thin typed sheet to be printed can be set.

According to the present invention, it is possible to provide the tray for transfer easily settable to accurate a position to be set when the tray transferring the sheet to be recorded is set to an ink jet typed recording apparatus.

Next, further another embodiment of the present invention will be described. In the present embodiment, when the tray for transfer, as aforementioned, is manually set to a predetermined position of the passage transferring the sheet to be recorded of the means for transferring the material to be recorded, the tray for transfer is set to the position to be set based on the outer contour design of the constitution element in the recording apparatus displayed on the tray for transfer.

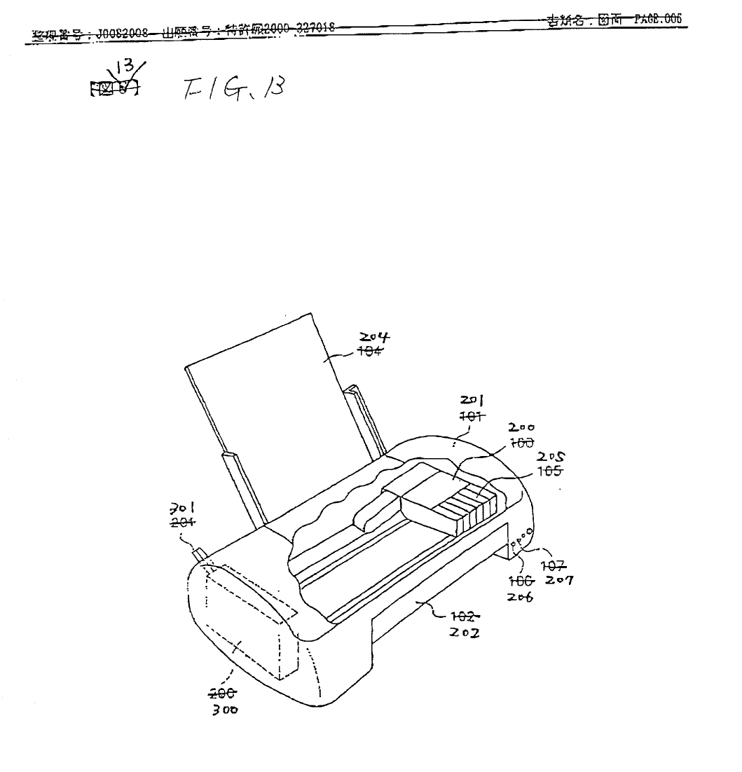

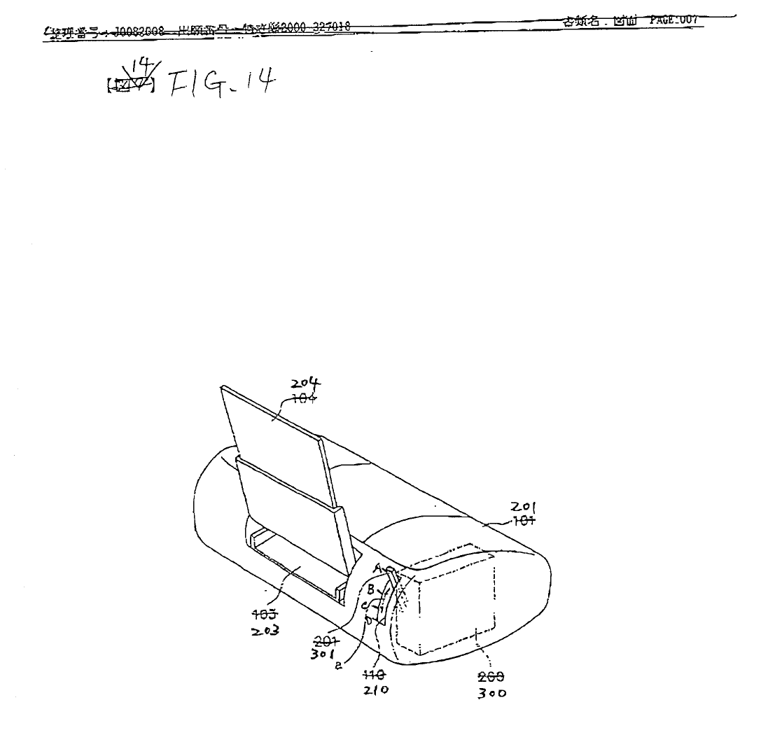

In an ink jet typed printer shown in FIGS. 13 and 14, within a body 201 is provided with an ink jet typed recording head 200, a carriage mechanism (not shown), an auto feeder (not shown), a sheet feeder mechanism by hand, and a sheet transfer mechanism including a mechanism initially setting record sheet etc. as characterization of the present invention. A discharge outlet 202 is provided on a front face of the body 201 and a feeder inlet 203 by hand is provided on a back face of the body 201. A tray for auto feeder 204 is provided at the upper side of the inlet 203 of back face. An adjust lever 301 is placed at the side of the inlet 203 so as to project from the body 201. The adjust lever 301 is used to switch the paper gap according to thickness of the recording medium and separate the center point for the roller transferring paper of the following roller.

Recording paper fed to the tray 204 is automatically transferred by, for example, the auto sheet feeder and recording paper is sandwiched at the center point of a driving roller or transferring paper roller (not shown) or a following roller (not shown), further is transferred and is discharged from the outlet 202. Recording paper fed to the inlet 203 by hand is sandwiched at the center point of the driving roller and the following roller, is transferred and is discharged from the outlet 202 similar to recording paper fed to the tray 204.

Plain paper, special purpose paper, recommended OHP sheet, glossy print paper, coated paper, coated film, label sheet, and a post card can be used as recording paper fed from the tray 204. Cardboard, extremely cardboard (tray for information recording disk is included), that is, difficult-bend sheet besides the above each paper cab be used as recording paper fed by hand.

In a shown arrow a direction along a slit 210, the adjust lever 301 slides in stages. The slit 210 is linearly provided to the body 201. It is possible to switch the paper gap and to separate the center point for the transferring paper roller of the following roller. Switching of the paper gap is to move-adjust the ink jet typed recording head 200 so that a distance between a paper face and a nozzle opening face of an ink jet typed recording head 200, that is, the paper gap is almost constant to keep printing precise with constant high precise without influence by thickness of recording paper.

Separation of the following roller is to apply pressure to the following roller for pushing the following roller to the roller transferring paper or to release the pressure for separating the following roller from the driving roller in order that recording paper is sandwiched between the driving roller and the following roller or the recording paper is pulled out from between the driving roller and the following roller. The adjust lever 301 to adjust these mechanisms in multiple stages is reciprocatively movable in the shown arrow a direction and a position can be determined at positions A, B, C, and D in stages. When the adjust lever 301 is determined at the position A, a position to use recording paper with normal thickness, that is, plain paper. When the adjust lever 301 is determined at the position B, a position to use recording paper with slightly thickness, that is, cardboard of cardboard. When the adjust lever 301 is determined at the position C, a position to use recording paper with extremely thickness, that is, extremely cardboard including the tray for information recording disk. When the adjust lever 301 is determined at the position D, a position where the roller 302 is separated from the roller 303.

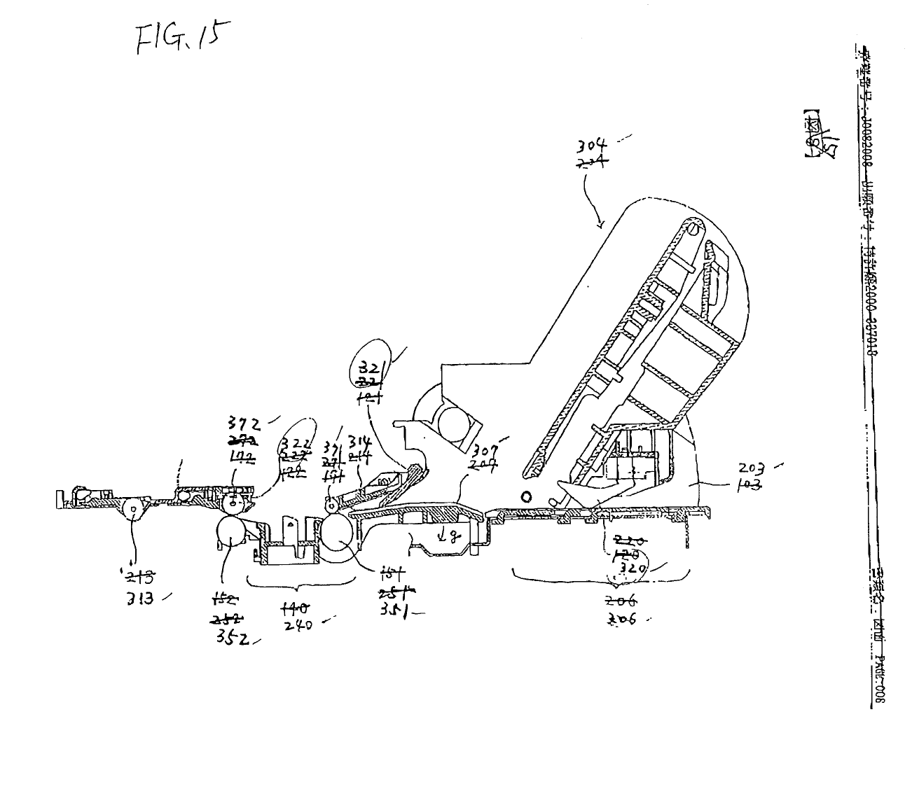

FIG. 15 shows a whole image of a sheet transfer mechanism including a sheet feeder mechanism by hand in the body 201 in the ink jet typed printer shown in FIGS. 13 and 14.

As shown in FIG. 15, a sheet transfer mechanism is provided with the inlet 203 provided at the back face side of the aforementioned body 201, an auto sheet feeder (ASF) unit 304 provided at the upper part of the inlet 203, a paper guide stage by hand 306, a movable stage 307, and a print stage 240 for printing, at an upper part, by being reciprocated with an print head (and carriage, not shown) in an orthogonal to the same drawing. The movable stage 307 is gradually tilted and directed to a paper discharge side as shown in the figure drawing when plain paper is fed from the auto sheet feeder (ASF) unit 304 and the movable stage 307 is sank at the lower side as shown in a shown arrow g and obtains the flat sheet feeder passage when cardboard is guided by hand.

The sheet transfer mechanism has a sheet feed roller (Main) 351 provided at the upper side of the print stage 240 and a following roller 371 thereof; a discharge roller (Sub) 352 provided at the lower side of the print stage 240 and a discharge star-wheel roller 372, which is the following roller thereof; a discharge star-wheel roller 313 provided at the lower side from the roller 352 and the roller 372. An upper guide plate is also provided at the upper part of the movable stage 307. The guide plate is forced to the lower part by a spring.

The sheet transfer mechanism has three detectors composed of a detector by hand 320 provided around lower side of the inlet 203, a paper detector 321 provided at the upper part of the above movable stage 307, and a tip detector (Optical sensor) 322 provided at the slight lower side of the center point of the roller 372 and the roller 352 so that an optical axis is placed on it. Although all of these detectors are sensors of two values detecting whether or not there is paper, the detector 320 and the detector 321 are respectively mechanical contact point typed switches. Tips of switch knobs are respectively placed in the transfer passage so that the tips are projected. The knobs are by passing paper under the tips, the contact point is introduced, and whether or not there is paper is detected. In contract, the detector 322 is a reflection typed optical sensor almost similar to a description of the prior art.

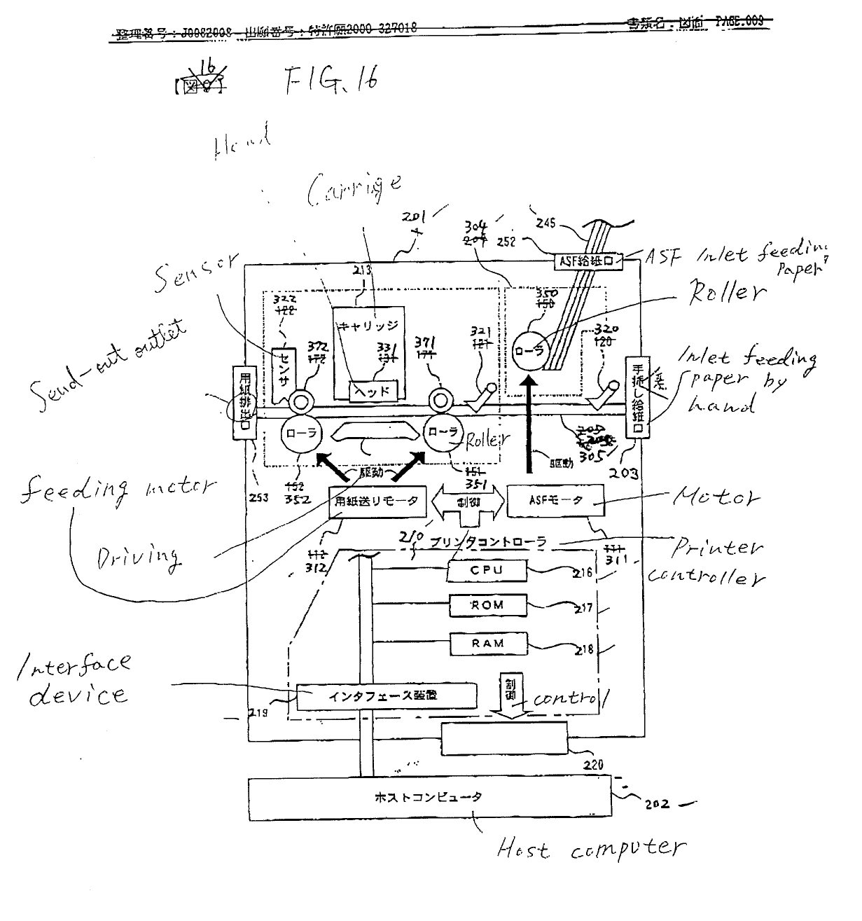

FIG. 16 is a diagram showing a relation of an ink jet printer controller having the sheet transfer mechanism to be applied for the present invention to transfer passage.

In the printer 201, a CPU 216, a ROM 217, a RAM 218 operating as a main storage unit are connected via a bus to totally control each unit. A print controller 210 (Controller 210 is shown with circular projected line), which is a control mechanism of a computer component is comprised like this.

Printer command data sent from a host computer 202 are transmitted from an interface unit 219 to the print controller 210 via a bus. The print controller 210 controls the recording head 200 actually jetting ink to perform a printing operation; and performs driving control of an ASF motor 311 feeding a cut sheet 245 from a feeding motor 312 for feeding at the printing operation or the unit 304 to a transfer passage 305.

Two roller to transfer paper during print operation, that is, the sheet feed roller 351 and the sheet discharge roller 352 are provided to the passage 305. The roller 351 and the roller 352 are driven by the motor 312 and are synchronously rotated via teeth (not shown). The roller 371 and the roller 372 are respectively provided on the upper parts the roller 351 and the roller 352. A spring mechanism (not shown) respectively forces to the roller 351 and the roller 352. Recording paper is sandwiched between the roller 372 and the roller 352. Recording paper is sandwiched between the roller 371 and the roller 351. Recording paper is moved in the passage 305 like this.

In FIG. 16, the roller 372 is simplified and illustrated similar to the following roller. The carriage 213 movable in the main scanning direction in printing is arranged at the upper side of the print stage 240 between the roller 351 and the roller 352 supported by an guide rail (not shown).

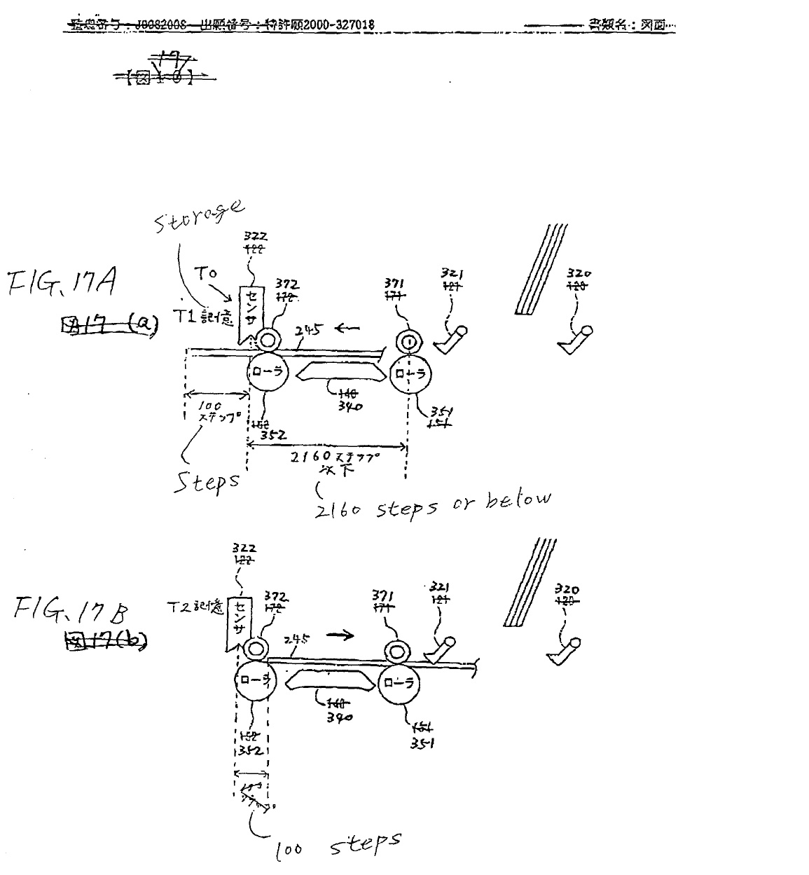

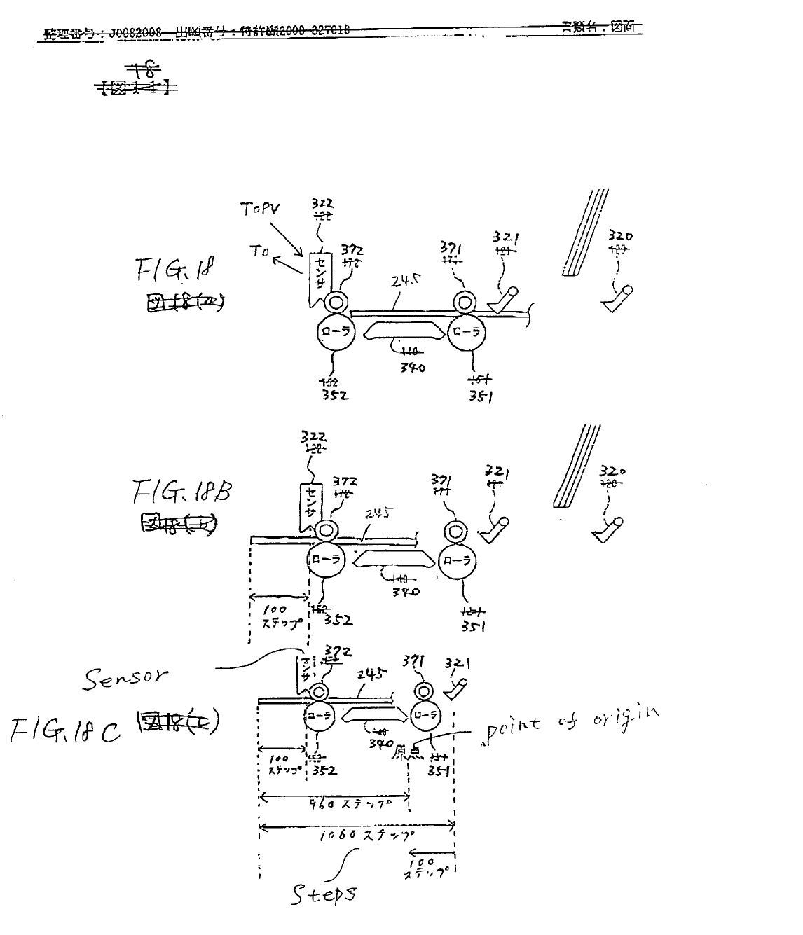

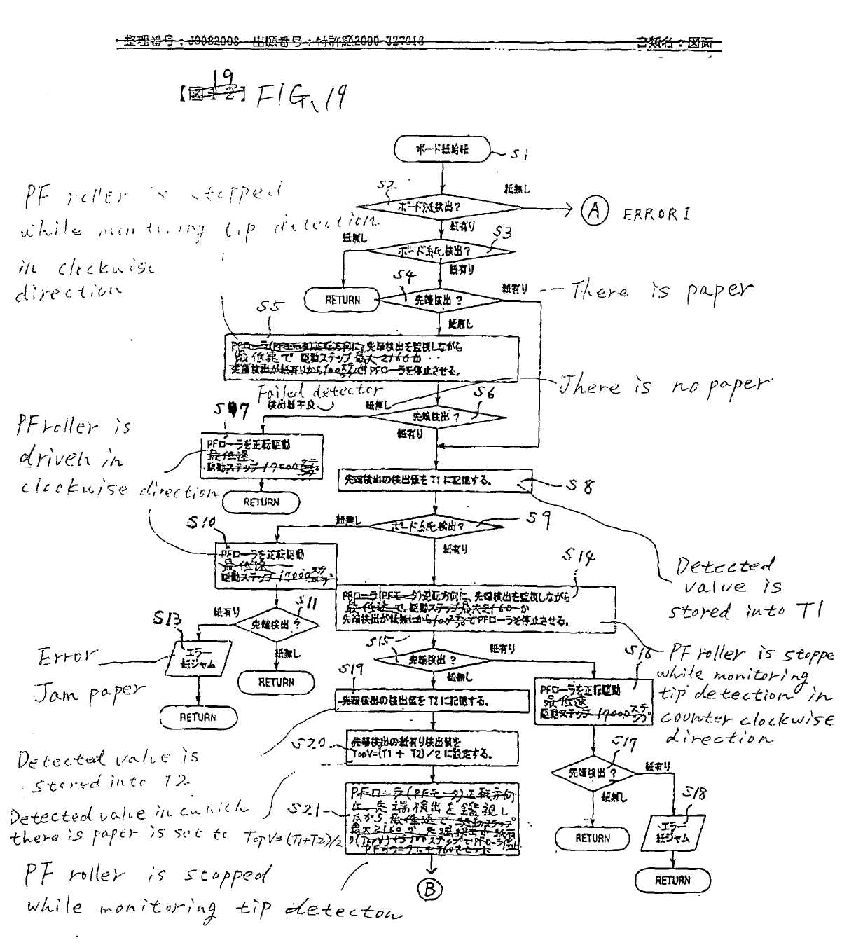

An initial set method of a recording medium of the present embodiment will be described referring to FIGS. 17A to 18C and flowcharts of FIGS. 19 to 21 below.

A user which intends to print card board or a CDR set to a CDR tray makes the roller 371 from the roller 351 by setting the adjust lever 301 to the position D. In a state of this, cardboard or the CDR try is inserted from the inlet 203.

Next, the user moves back the adjust lever 301 to the position B in a case of cardboard and moves back the adjust lever 301 to the position C in a case of the CDR try.

A sheet feed button of a panel switch unit 220 (See FIG. 16) is pushed. A position of the above the adjust lever 301 is kept at the position D (That is, the adjust lever 301 is not moved back to the position B or the position C) and the discharge button is pushed. In this case, error occurs and lamp 206 for an erroneous display 206 is blinked 206 (See FIG. 13).

As aforementioned, the adjust lever 301 is moved back to the position B or the position C. Sequence of a distal portion in the present embodiment is performed by pushing the discharge button of the panel switch unit 220. Here, a description will be explained by describing a case where cardboard is fed by hand as an example.

The present embodiment is characterized that distal detection is performed for a recording medium fed by hand twice and then the distal portion is set. On the other hand, a state where there is paper or a state where there is no paper is respectively detected once and intermediate potentials of both are deemed as detection thresholds of a detector as mentioned later. Sequential explaining will be made below.

In sequence of distal portion in the present embodiment, a detection value (Threshold value) T0, that is, there is paper of default in the detector 322 is kept to reset to a lower value, which can absolutely detect paper etc. substantially.

In this state, as shown in FIG. 17A, board 245 is transferred to the lower side for 100 driving steps from center of the detector 322. A detection value T1 of the detector 322 at this time is stored into the RAM etc.

Next, as shown in FIG. 17B, board 245 is moved back to the upper side for 100 driving steps from center of the detector 322. A detection value T2 of the detector 322 in a state where there is no paper is stored into the RAM etc.

As shown in FIG. 18A an average of each detection value stored into T1 and T2, Top V=(T1+T2)/2, is obtained by calculation. The detection value (threshold) in which there is paper of the detectors is changed from TO of the default to the average Top V. FIGS. 17A and 17B shown respectively an operation in which a value for change in the detector 322 to detecting end.

Next, as shown in FIG. 18B, the detector 322 detects that there is paper from Top V and then the board sheet 245 is fed out up to a position downstream by one hundreds of driving steps from the center of the leading edge detector 322. Here, an initial value [+960] of a PF counter is set to forward the end portion to an original point.

In a printer of the present embodiment for which the initial set method of the recording medium of the present invention is applied, sequence of cardboard seek is performed. In the printer of the present embodiment, the PG (Paper gap) can be adjusted in three stages according to a kind (thickness) of the recording medium as mentioned above. If the user erroneously set the adjust lever to the above position A regardless of feeding the recording medium with extremely thickness of, for example, the CDR tray, the PG is set to a narrow interval taking account of plain paper. If this is disregarded and the carriage is mainly scanned with a normal printing speed, and a problem may occur which an equipment is broken by colliding the carriage with the CDR. When the carriage is moved to almost center in a recording area with a low speed, judgement is performed based on a movement step position or a drinking current value. As a result of this, when cardboard is judged, this is sequence to inform to enlarge the PG. Detail is here omitted.

FIG. 18C shows a diagram representing procedure of determine the origin position in sequence from FIG. 18B. In this diagram, a positive step is set to the left along the direction of feeding a cardboard 245. In this process, while setting a value of +960 in PF counter, the position of the cardboard 245 shifted back in 1060 steps. Then, the cardboard is forwarded in 100 steps. At this point, the left end of the cardboard is defined as the origin. This process prevents a gear from occurring the undesirable backlash.

As shown in FIG. 19, when the user feeds board paper (S1) and pushes the feed button, whether or not board is detected by the detector 321 is judged (S2). When board paper is not detected by the detector 321 (There is no paper) (No in S2), error processing (ERROR1) is performed. Any error is considered for not detecting board paper by the detector 321 regardless of insertion of board paper from the inlet 203 by the user.

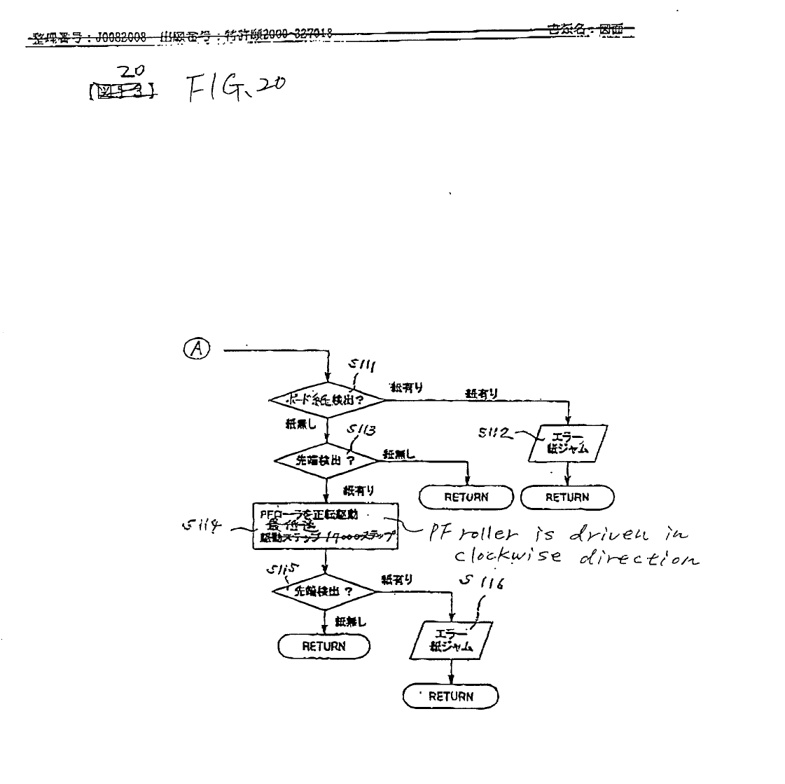

As shown in FIG. 20, whether or not board is detected by the detector 320 is judged (S111). When board paper is detected by the manual feeding detector 320 (There is paper) (Yes in S111), it is considered that paper jam occurs between the detector 320 and the detector 321. Error processing is performed (S112) and RETUN is executed. When board paper is not detected by the detector 320 (There is no paper) (No in S111), board paper is not detected by both the detector 321 and the detector 320 even though the user inserted the board paper from the inlet 203. In this case, very short paper is supposed to be inserted. Further, it is judged whether or not board paper is detected by the detector 322 (S113).

When the board paper is detected (There is paper) by the detector 322 (Yes in S113), a PF roller (Motor 312) is rotated with a minimum speed in a forward direction, the motor 312 is rotated up to driving step 2700 steps (S114), here the PF roller is stopped, and whether or not board paper is detected by the detector 322 is judged (S115). Again, if the board paper is not detected by the detector 322, that is, “No Paper” is judged (No in S115), then the operation turns to RETURN mode and it becomes a state of waiting next command. When the leading edge of the paper is detected (Yes in S115), error processing is performed as occurrence of paper jam (S116) and then the operation goes to RETURN mode. In this case, the user takes off paper, which occurred paper jam and the user may try to print again.

Referring again to FIG. 19, as different from the foregoing error operation (ERROR1), when board paper is detected by the detector 321 (There is paper) (Yes in S2), whether or not board paper is detected by the detector as shown in FIG. 17 (S3). If no board paper is detected by the detector 320 (No in S3), and then the operation turns to RETURN mode, and then the control system waits for the next command. When the board paper is detected by the manual feed detector 320 (There is paper) (Yes in S3), further, it is judged whether or not board paper is detected by the detector (S4). The leading edge detector 322 does not detect the board paper (No in S4), the PF roller (Roller 351 and roller 352 are called as the PF roller, here) is rotated with the minimum speed in the forward direction (paper feed motor 312) while the detector 322 monitors end detection. When end detection is not performed, the motor 312 is rotated up to driving step maximum 2160 steps and the PF roller is stopped here.

When the detector 322 detects that there is paper while end detection is monitored, the PF roller is stopped in 100 steps ahead (S5). Driving steps 2160 shows a value below 2160 steps in a driving step of a distance from a center point NP1 of the roller 351 and the roller 371 to a detection point DT of the detector 322. When paper is transferred from the NP1 to DT and paper does not reach DT, it is preferable that processing is considered as error.

In S4 when the leading edge detector 322 detects the board paper (Yes in S4), it is considered that board paper reaches to a tip of detection point of the detector 322 only insertion by user. Therefore, since a state shown in FIG. 17A is achieved, a routine goes to S8 without transfer of paper (S5 and S6 are jumped). In step 5, when the detector 322 detects that there is paper during monitoring end detection, the PF roller is stopped in 100 steps ahead. This is because a state shown in FIG. 17A is achieved by transferring paper.

On the other hand, when the sheet feed motor 312 is rotated from the detection point DT of the detector 322 to the during step 2160 steps (No in S6), it is judged as failure of the detector 322. Then PF roller (Motor 312) is rotated with a minimum speed in the forward direction. Then the motor 312 is rotated up to driving step 17000 steps and the PF roller is stopped at the step (S7) and RETURN is executed and waits for the next command. Driving step 17000 steps is volume transferring paper capable of sending out paper in A4 size in transfer lower direction. Processing is changed to error processing as failure of the detector 322 and paper is sent out.

On the other hand, when end detection occurs (Yes in S6), a detection value of the detector 322 is stored, for example, in a second storage area (T1) provided on the RAM 218. whether or not board paper is detected by the detector 321 is judged (S9). When board paper is not detected by the detector 321 (There is no paper) (No in S9), paper is fed out as the paper is judged to be extremely short. In this state, to execute sequence of transfer end, when short board paper is moved back to the upper side, these destruction probably occur since the detector 321 or the detector 320 is a mechanical connection point switch and the switch is set in a state where the switch is tilted at the low side.

Then, PF roller (paper feed motor 312) is rotated in forward direction at a minimum speed and the paper feed motor 312 is rotated up to the driving step 17000 steps (S10) and, then the PF roller is stopped. Here again, it is judged whether the leading edge detector 322 detects the board paper (S11). If the leading edge detector 322 does not detect the board paper (no paper) (No in S11), it is considered that the short paper can be discharged out well by driving of 17000 steps. Then the operation goes to RETURN and wait for the next command to return to the original sequence (not the present sequence). If a leading edge of the paper is detected (Yes in S11), error processing is performed (S13) as occurrence of paper jam by the short paper during driving of 17000 steps.

On the other hand, if the paper detector 321 detects the board paper (Yes in S9), the PF roller (paper feed motor 312) is rotated at the minimum speed in a reverse direction while an edge detection is monitored. The motor 312 is rotated from 2160 steps at maximum driving step or no paper of the detector 322 to 100 steps. The PF roller is stopped at the step (S14). After that, further it is judged whether the leading edge detector 322 detects the board paper. If the paper is detected (Yes in S15), the PF roller (paper feed motor 312) is rotated at the minimum speed in the forward direction, the motor 312 is rotated up to driving step 17000 steps (S16), the PF roller is stopped, and whether or not board paper is detected by the detector 322 is judged at the step (S17).

If the detector 322 does not detect the board paper (no paper) (No in S17), RETURN is executed and waits for the next command. If the paper is detected (Yes in S17), error operation is performed as it is considered that a paper jam occurred (S18) and then RETURN is executed.

On the other hand, when no detection is made at S15 (No in S15), the detection value of the leading edge detector 322 is stored in a second storage region (T2) on a RAM 218 (S19).

In the present embodiment, the average value TopV is deemed as detection value (Threshold value) in which there is paper by the detector 322 (S20). The average value of respective detection values respectively stored in T1 and T2 is obtained by calculation. It is characterized the detector 322 is modified to consider the detection value (Threshold value) in which there is paper as the average value.

Then, the PF roller (paper feed motor 312) is rotated in the forward direction at the minimum speed while a leading edge detection is monitored. The paper feed motor 312 is rotated by 100 steps from either the maximum driving step 2160 steps or the detector 322 detects “There is paper (there is paper detected from TopV) and then PF roller is stopped. A value of +960 is set to a PF counter (S21). Thereby, a state transferring board paper becomes the same as a state of FIG. 17A. However, in FIG. 17A, the detection value (threshold value) at which the detector 322 represents the paper exists is the default detection value (threshold value) T0 which is the lowest value which can absolutely detect a paper or the like, whereas in FIG. 18B, the paper detection is performed at TopV. The reason why it is set the rotation by 100 steps from either the maximum driving step 2160 steps or the detector 322 detects “There is paper (there is paper detected from TopV) is that it is sufficient to achieve the status shown in FIG. 18B as described for S5. It is for the first time here when the PF counter is set to a value of +960 to feed paper to a reference position (original point) where the leading edge is transferred.

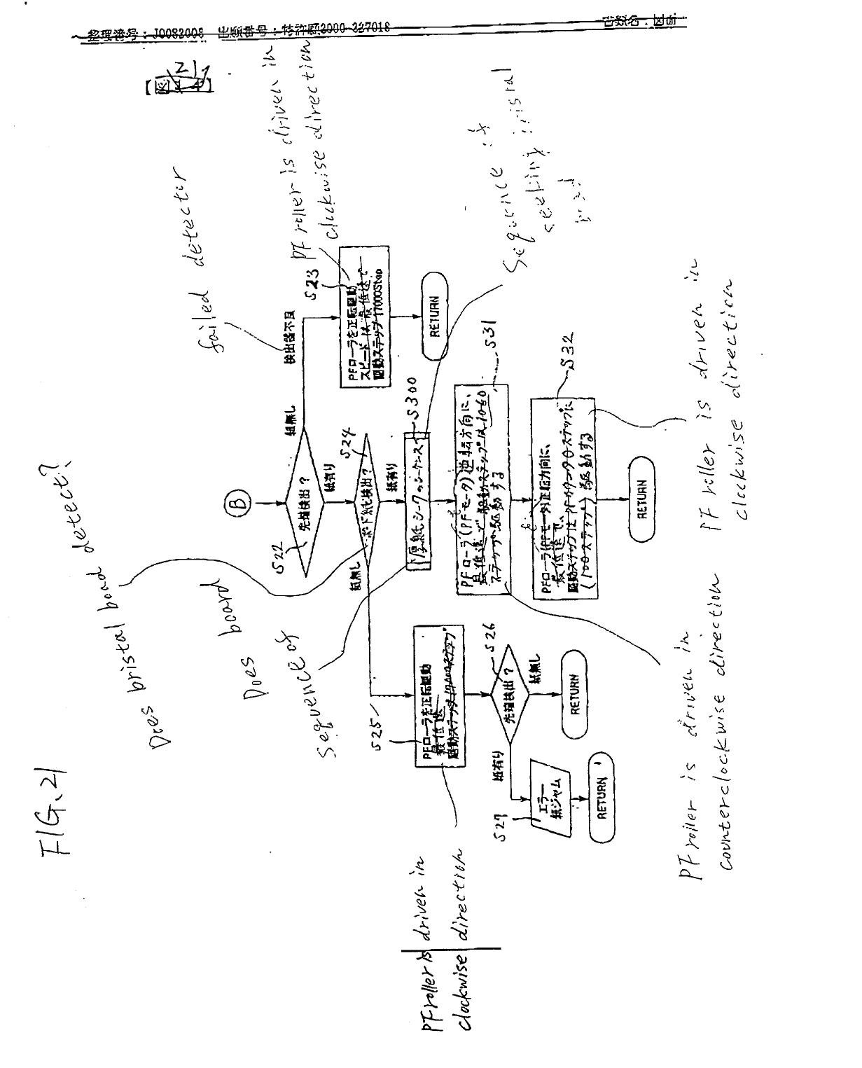

Thereafter, as shown in FIG. 21, it is judged whether the leading edge detector 322 detects the board paper (S22). If there is no detection (No in S22), it is judged as failure of the detector, the PF roller (paper feed motor 312) is rotated in forward direction at the minimum speed and then the motor 312 is continued to rotate up to the driving step 17000 steps. Then the PF roller is stopped (S23) and RETURN is executed and waits for the next command. On the other hand, if a paper is detected in (Yes in S22), then it is judged whether the paper detector 321 detects the board paper (S24). If no board paper is detected by the detector 321 (No in S24), then the PF roller (paper feed motor 312) is rotated at the minimum speed in the forward direction and the paper feed motor 312 is driven up to 17000 driving steps and, then the PF roller is stopped (S25). Again, it is judged if the leading edge detector 322 detects the board paper (S26).

If no paper is detected (No in S26), RETURN is executed and the operation waits for the next command. IF a detection is made, (Yes in S26), an error operation is performed as a paper jam or the like is supposed to occur (S27), then RETURNed. On the other hand, when the board paper is detected at S24 (Yes in S24), the afore-described sequence for the thick paper is performed (S300). After that, PF roller (paper feed motor 312) is rotated in reverse direction at the minimum speed, and the driving step 1060 steps is driven (S31). As mentioned above, the value of +960 is previously set to the PF counter in S21. The reason why driving up to driving step 1060 steps in reverse direction is that a 100 steps back from reference position (original point) is performed and, thereafter, 100 steps forward is accomplished to set the reference position (original point) so that the backlash can be avoided.

Then the PF roller (paper feed motor 312) is rotated at the maximum speed in the forward direction and the PF roller is driven until a driving step becomes a PF counter zero step (S32). Owing to the operation, the leading edge of the board paper is transferred to the original point. Then RETURN is executed and the system waits for the next command.

In the present embodiment, while three detectors monitor a transferring state of the recording medium. In a case where a normal operation is doubt, since a processing proceeds appropriately to discharge the medium or error processing, a leading edge of the recording medium can efficiently be transferred. Both a state that there is the recording medium and there is no the recording medium are detected, and an intermediate potential of the both is considered as a detection value of the detector described below. Thereby, end detection can be stable with high accuracy. Therefore, a leading edge can be transferred in stable with high accuracy regardless a kind of the recording medium or thickness.

In the present invention, detection voltage according to receiving amount s respectively detected in a state where there is the recording medium and there is no recording medium by using a detector composed of a reflection typed optical sensor once. Since a tip position of the recording medium is detected considering both intermediate potential as the detection threshold tip detection can be separated in stable with high accuracy. Since the recording medium is set to the initial position, the tip is set to the initial position with high precision not depending on the kind of the recording medium or thickness, it is possible to transfer in stable the tip to the initial position.

Still another embodiment will be described below. In the present embodiment, when the tray for transfer in FIGS. 4 to 12 is manually set to a predetermined position of a passage transferring a recording material to the recorded of a means transferring the recording medium to be recorded, the tray for transfer is set to the position based on an outer view of constitution elements of the recording apparatus displayed on the tray for transfer.

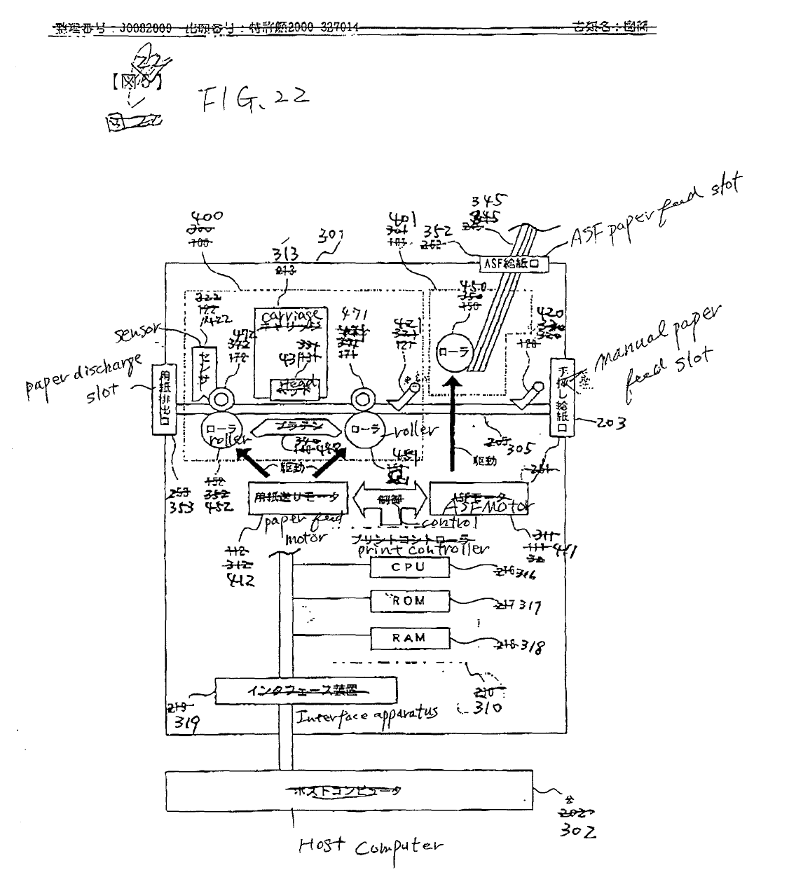

FIG. 22 is a diagram for explaining a relationship of the control mechanism and the paper feed path of the printer 301 according to the invention.

For the purpose of controlling a printer 301, the printer 301 includes Central Processing Unit (CPU) 316, Read Only Memory (ROM) 317, Random Access Memory (RAM) 318 and Printer controller 310. These elements are, through interface device 319, connected to a host computer 302 along a bus. The bus is a path allowing sending or receiving information between particular points. In this figure, the Printer controller 310 is shown as a dashed line.

Printing instructions from the host computer 302 are sent to the controller 310 through the interface device 319 along the bus. The controller 310 controls various embodiments in the printer 301. Such examples include recording head 431 for controlling ink emission in printing process, paper feeding motor 412 for feeding paper with the printer 301 during printing process, ASF (Auto Sheet Feeder) motor 411 for transferring cut sheet 345 into paper feed passage 305, etc.

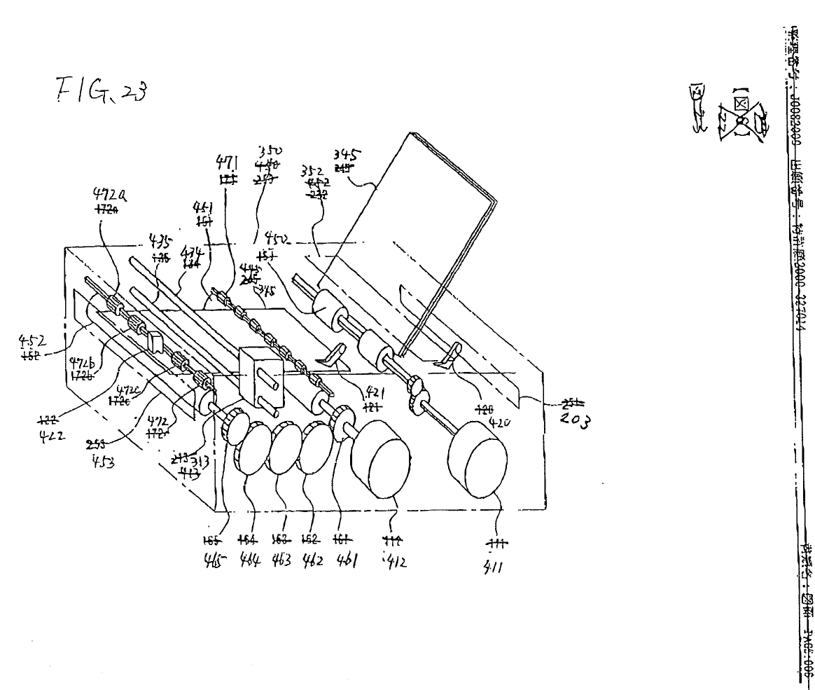

FIG. 22 shows a perspective view showing the configuration of embodiments located in the area near print feed passage 305. FIG. 23 shows a portion of feeding paper in two regions shown by dashed lines.

The inlet 203 to feed thick recording paper is provided on a back face of a printer body 350. An ASF inlet 352 is opened to feed thin recording paper 345 put in a stoker and placed at an upper part of the body 350 in a paper feed path by an ASF roller 450.

In the paper feed path, two rollers, a feeder side roller 451 and s send-out side roller 452 to transfer paper during printing are provided. Two rollers 451 and 452 are driven by a transfer motor 412 and synchronized with each other via gears 461 to 462. From upper parts of the rollers 451 and 452 multiple of a star-wheel roller 451 with a small diameter to a star-wheel roller 472 with a small diameter (a to d)/engaged with respective rollers to be operated are respectively arranged at respective free points. And are respectively forced to respective rollers by the spring mechanism. Recording paper is sandwiched by the plurality of the star-wheel rollers and the rollers and are transferred in the paper feed path.

A carriage 313 movable in the main scanning direction in printing is arranged at the upper side of a platen 440 between the two rollers 451 and 452 by two guide rails 434 and 435. Sensors 420 to 422 are provided in the paper feed path. The sensor by hand 420 and a paper end sensor 421 are respectively mechanism connection point typed switched. Tips of switch knobs projected in the paper feed path thereunder.

Thereby, it is detected that there is paper. Only knobs of the sensors 420 and 421 are illustrated in each figure.

On the other hand, the sensor 422 is an optical sensor comprised of a light emitted diode and a photo diode. The optical sensor 422 is provided at the upper space of the roller 452, and between the roller 472b and the roller 472C.

That is, the optical sensor 422 is arranged between the roller 472b and the roller 472C in a direction of paper width of recording paper 345. The optical sensor 422 is extremely close to the roller 452 or the center point of each of the rollers 472a to 472d and the optical sensor 422 is provided at the front side of the printer.

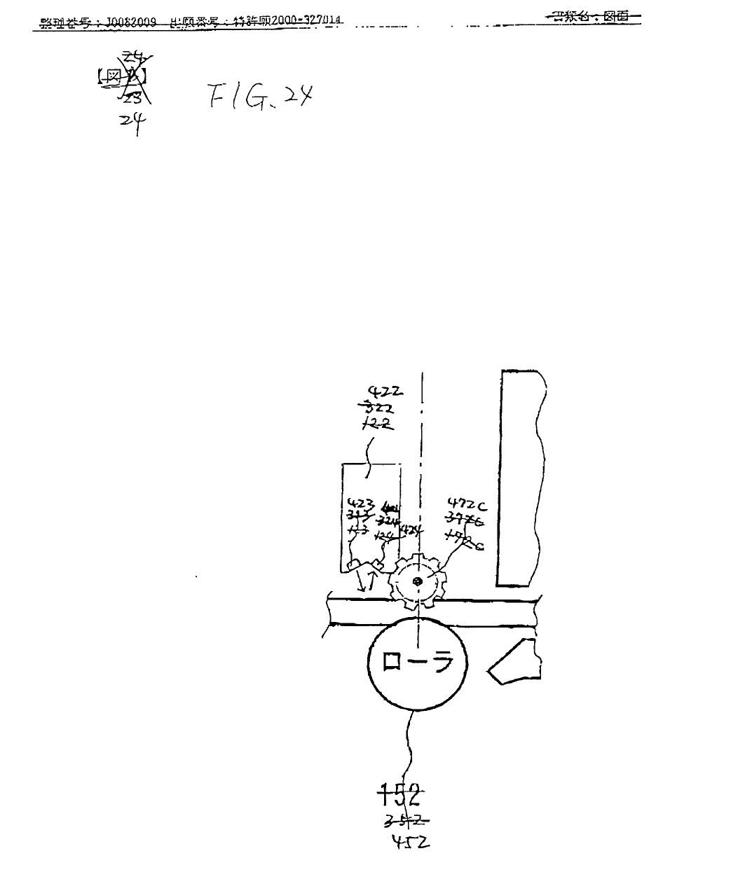

As shown in FIG. 24, it is preferable that the optical sensor 422 is provided so that an optical axis of the diode 423 and the diode 424 is at the paper discharge side of the paper feed path from the center point (nipple point) of the star wheel roller 472 (roller 472C in FIG. 24) . This is because the recording paper 345 is passed through the center point of the roller 472 and the recording paper 345 can sufficiently be stable after it is sandwiched by the rollers 472 (and roller 452).

Next, paper detection by the optical sensor 422 and relation to motor control by the controller 310 will be described.

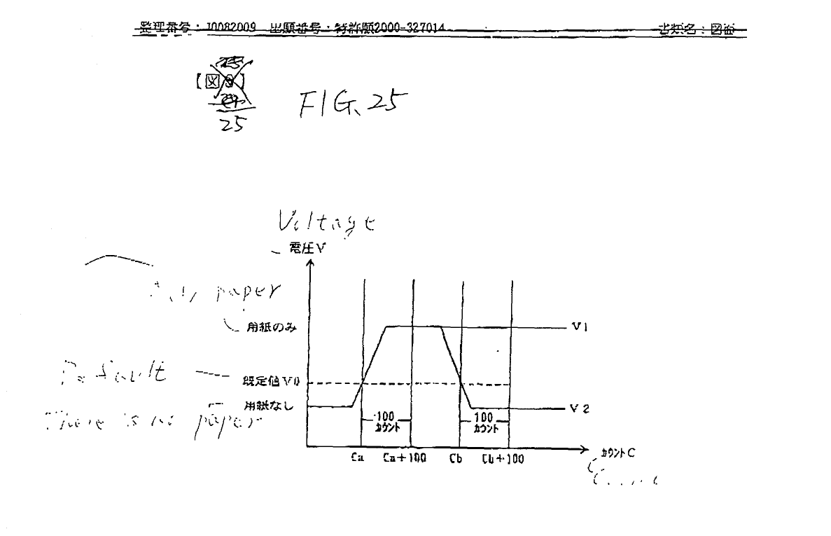

FIG. 25 shows a graph of an output voltage change of the photo diode 424 of the optical sensor 422. A vertical axis in the graph is a voltage value and a horizontal axis is amount paper (counted value counted by an optical encoder or the like) shown at the horizontal axis is shown as a value in which an absolutely value is added regardless of whether a motor is rotated in the forward direction or in the reverse direction.

Upon recording paper 345 is transferred by the ASF rollers 450, the paper end sensor 421 detects this. The controller 310 operates the motor 412 to rotate in the reverse direction and recording paper 345 is transferred to the optical sensor 422. When the end of recording paper 345 is passed under the optical sensor 422, output of the diode 424 is changed from Vn to V1. In this way, the controller 310 exceeds a voltage value V0 stored as a predetermined value. The controller 310 rotates a motor for 100 count from a count value Ca of the encoder in the forward direction and stops the motor (Position of recording paper 345). The controller 310 obtains a voltage value V1 at this time.

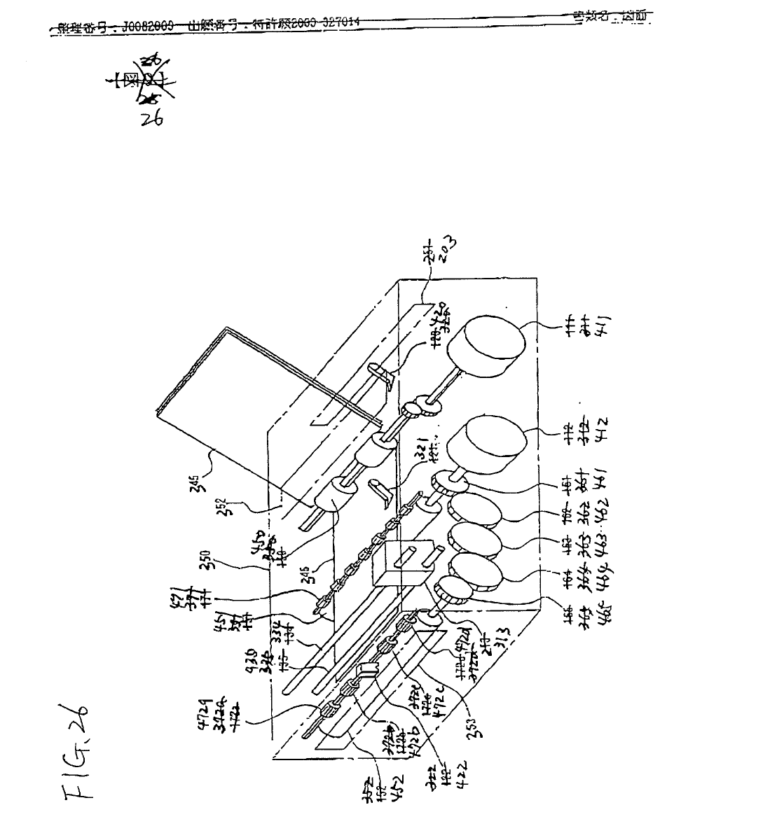

Next, the print controller 310 rotates the motor 412 in reverse direction and pulls back the recording paper 345. During pulling out paper, if a value of output voltage of the diode 424 becomes below the predetermined voltage value V0, the print controller 310 rotates the motor in the reverse direction by 100 counts from the counted value Cb of the encoder and then it is stopped rotating. At this time, recording paper 345 may apart from the roller 345 once, recording paper 345 is sandwiched by the roller 451 rotating in synchronization with the roller 452. Thereby, recording paper 345 is transferred without any problems by only during of one motor 412 (Position of recording paper 345 is transferred without any problems by only driving of one motor 412 (Position of recording paper 345 shown in FIG. 26). The controller 310 obtains a voltage value V2 at that time.

The obtained voltage values V1 and V2 are processed in accordance with a predetermined algorithm and used for head transfer. An average value of V1 and V2 is obtained and, again, the motor 412 is rotated in the forward direction again. It can be considered that the end of recording paper 345 reaches directly below the optical sensor 422 The end is transferred ahead of a predetermined (paper is fed forward or moved back) and set to the predetermined position. Such this, it is considered that the values are used.

In the present invention, the optical sensor is arranged directly below the roller at the front side of the printer from the discharge roller and, the roller and a sensor to detect paper of driving are closely arranged extremely. Therefore, it becomes possible to transfer end of paper with high precision without influence of warp of paper.

The sheet feed roller and discharge roller move in synchronized with each other by gears. By constitution like this, it becomes possible to transfer the end of paper and pull back paper.

Since the optical sensor is provided so that the optical axis is at the send-out side of the paper (sheet) transfer-passage from the center point, end detection of recording paper can be in stable.

Still another embodiment will be described below. When the tray for transfer is manually set to a predetermined position of a recording transfer passage in a means for transferring the recording a position of the tray for transfer is set to the predetermined position based on an outline view of a constitution element in the recording apparatus displayed on the tray for transfer.

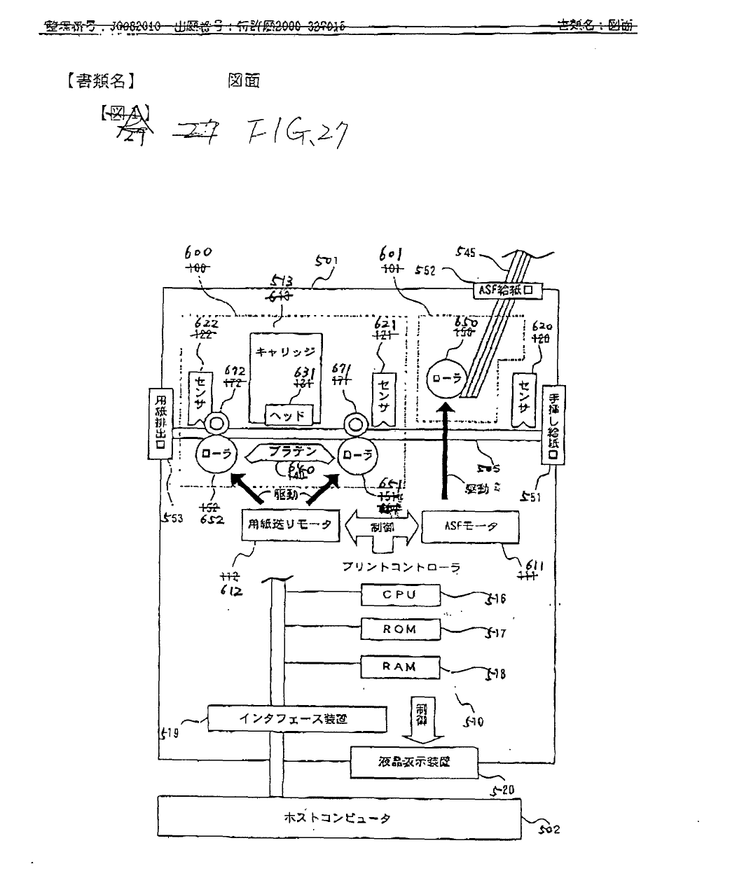

FIG. 27 is a diagram showing a constitution of a control mechanism and a paper feed path of the ink jet printer 501 for which the present invention is applied.

For the purpose of controlling all functions in a printer 501, the printer 501 includes Central Processing Unit (CPU) 516, Read Only Memory (ROM) 517, Random Access Memory (RAM) 518, and Printer controller 310. These elements are, through interface device 319, connected to a host computer 302 along a bus. In FIG. 27, the Printer controller 510 is shown as a dashed line.

Printing instructions from the host computer 502 are sent to the controller 510 through the interface device 519 along the bus. The controller 510 controls various embodiments in the printer 501. Such examples include recording head 631 for controlling ink emission in printing process, paper feeding motor 612 for feeding paper with the printer 501 during printing process, ASF (Auto Sheet Feeder) motor 611 for transferring cut sheet 545 into paper feed passage 505, etc.

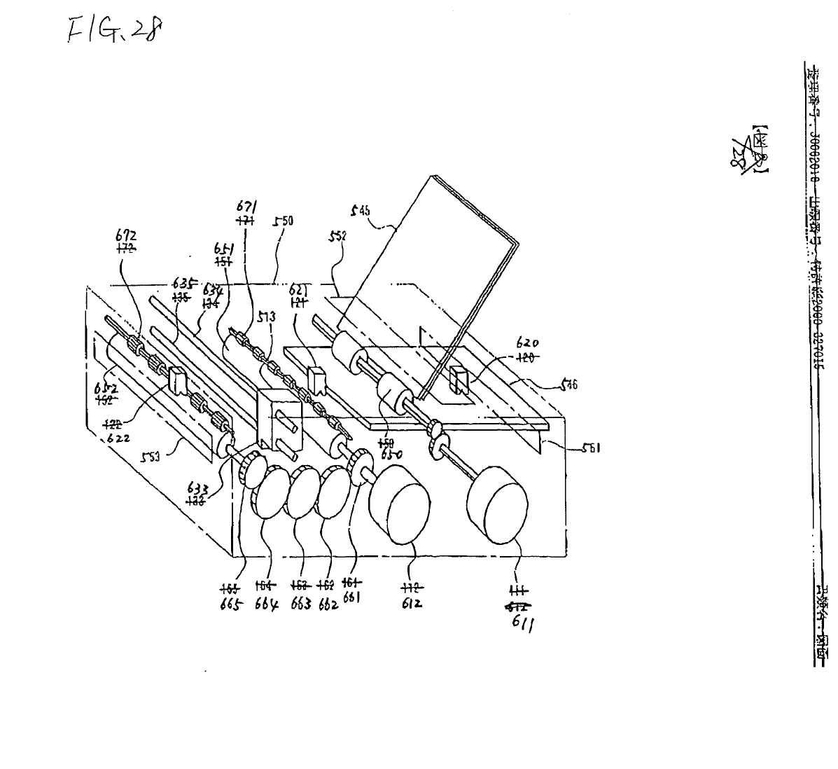

FIG. 28 is a perspective view explaining positional relationship of each constitution part arranged around the sheet transfer passage 505. In FIG. 28, an only part relating to paper transfer in the printer body 50 drawn with a phantom line is shown.

The inlet 551 to feed thick recording paper or the transfer tray 546 is provided on a back face of the printer body 550 since the thin recording paper 546 stored in the stoker and placed at the upper part of the body 550 is transferred in the paper feed path by the ASF roller 650, the ASF inlet 552 is opened.

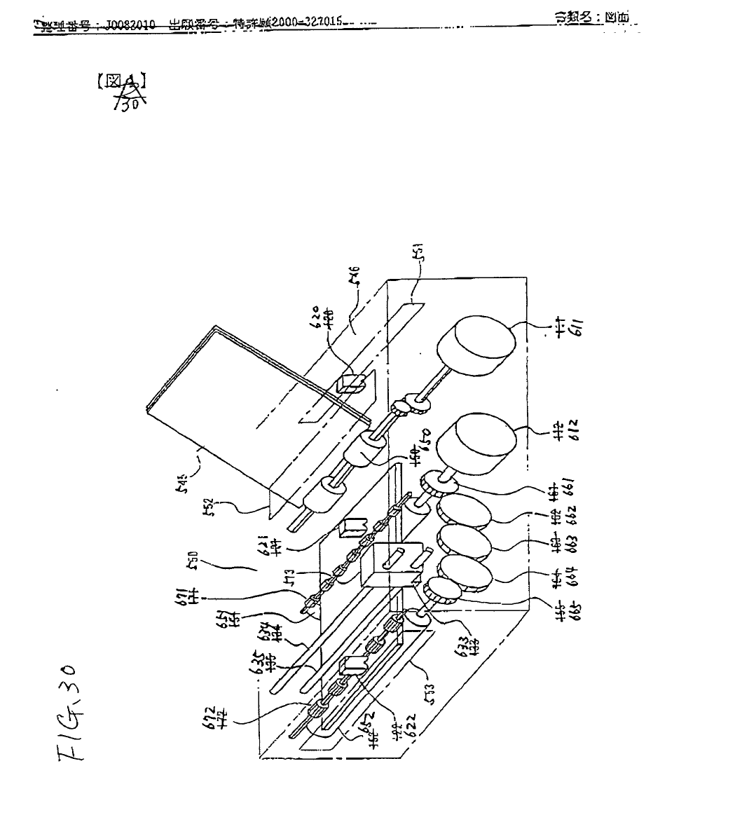

A couple of rollers for performing the paper feed operation during the printing, i.e., a paper feed roller 651 and a paper discharge roller 652 are disposed in the paper feed path. These two rollers 651 and 652 are driven by a paper feed motor 612 to rotate via gears 661 through 665 in synchronized with each other. From a top of the rollers 651 and 652, a plurality of pinions 671 and 672 are mounted on a free-rotating axis and urged toward the respective roller by a spring mechanism not shown. A recording sheet is sandwiched by the plurality of pinions and rollers and conveyed in the paper feed path as shown in FIG. 30.

A carriage 513 is supported by a couple of guide rails 634 and 635 in an upper area of the platen 640 arranged between the two rollers 651 and 652 shown in FIG. 27 and moves therealong in the main scanning direction during the printing operation.

Sensors 620 through 622 each having a light emitting element and a light receiving element are disposed on a bottom of a reverse-V shaped notches formed in the paper feed path. With these sensors 620 through 622, the light emitting element emits light beam toward an object and the light receiving element receives the reflected light, so that the existence of the object can be detected by detecting a change in output voltage of the light receiving element caused by a change in the reflective index of the object under the sensor.

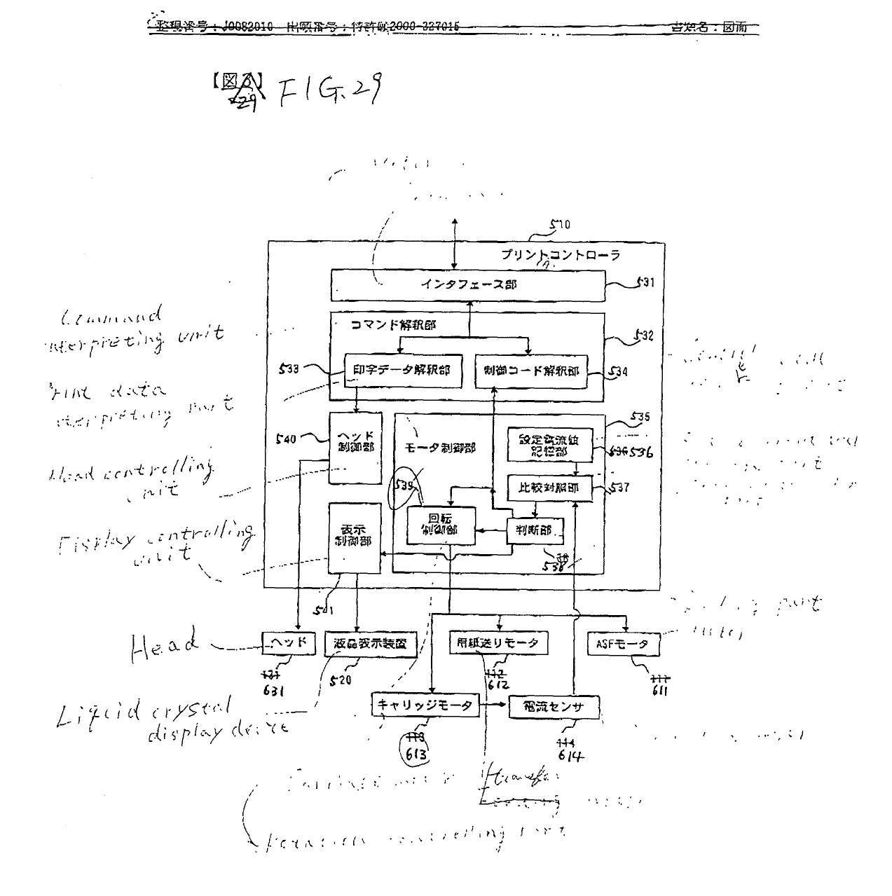

FIG. 29 is a block diagram for showing a content of a function in which a printer controller is included. Print command sent from a host computer is transmitted to a command interpreting unit 532. Print data and control code are respectively interpreted. in a normal print operation, an ASF motor 611, which is a hardware, a transfer motor 612 and a carriage motor 613 are driven by a rotation controlling part 539 of a motor controlling unit 535 in accordance with a control content interpreted with a control code interpreting part.

On the other hand, image data in which a bit map is imaged are transmitted to a head controlling unit 540 and a recording head 631 is driven based on the data.

A function in which the motor controlling unit 535 has is a characterized feature in the present embodiment. In the motor controlling unit 535, data of a slight higher current value (e.g. 400 mA) is stored compared with a consumption current value when the carriage motor 613 is operated without a special load. An actual consumption current value during driving the carriage motor 613 is continually detected by the current sensor 614 and the value is supplied to a contradistinction part 537 as digital information.

The contradistinction part 537 compares a set current value (400 mA) with the actual detected current value. When the actual measured value is higher than the set value, this is informed a judging part 538. The judging part 538 judges whether recording paper put into a printer is suited to a set paper gap by the following procedure and a processing is performed according to a judgement content.

FIG. 30 is a perspective showing a state where recording paper (Transfer tray 546 in an example) is et at a print start position. Since printing at an accurate position on the optical disk set to the transfer tray, end transfer with three sensor 620 to 622 is performed. Detail is omitted here.

In the present embodiment, a main feature is that the transfer tray 546, which is recording paper is provided under a main scan line on which the carriage 513 moves.

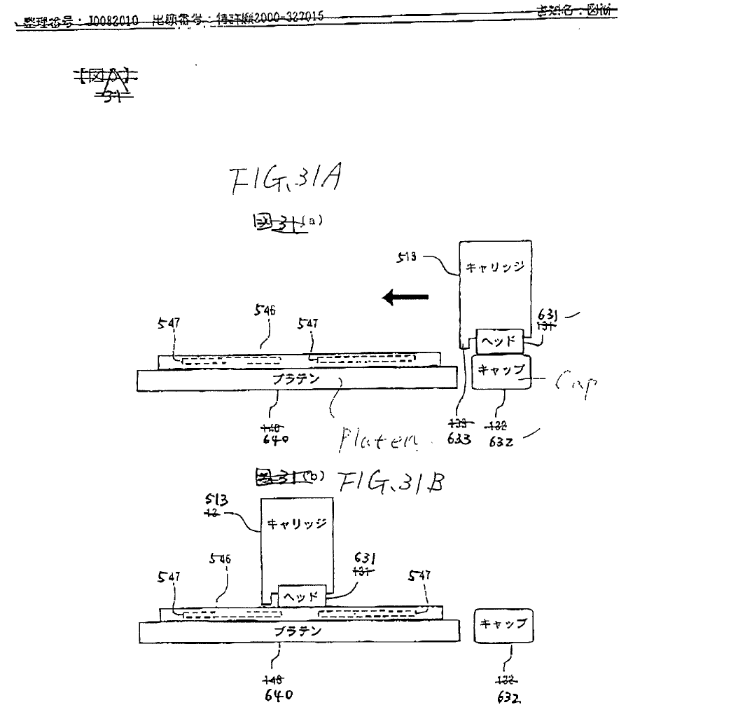

FIGS. 31A and 31B are views recording paper and a carriage on which the recording head is mounted from a printer front.

FIG. 31A shows a state where the carriage is at, namely, home position and the recording head 631 is protected by a cap 632 for dry protection. FIG. 31B shows a state when paper thickness is confirmed prior printing execution.

The confirmation operation is performed by moving the carriage 631 to a predetermined position on recording paper. The controller 510 controlling each part of a print engine 600 (Shown by surrounding with a projected line) controls the number of digits similar to the control at the time of normal printing operation, drives the carriage motor 613 (Fih.29), and mainly scans the carriage in an arrow direction in FIG. 31A. For example, when print control to control width of paper in A4 size with where figures is performed, scan is performed to 40 figures.

When the paper gap of the printer is correctly set by the user at this time, the carriage is smoothly moved as a state shown in FIG. 31B. In contract, when the paper gap is incorrectly set, a projection 633 provided on the side face of the carriage 513 is caught at recording paper.

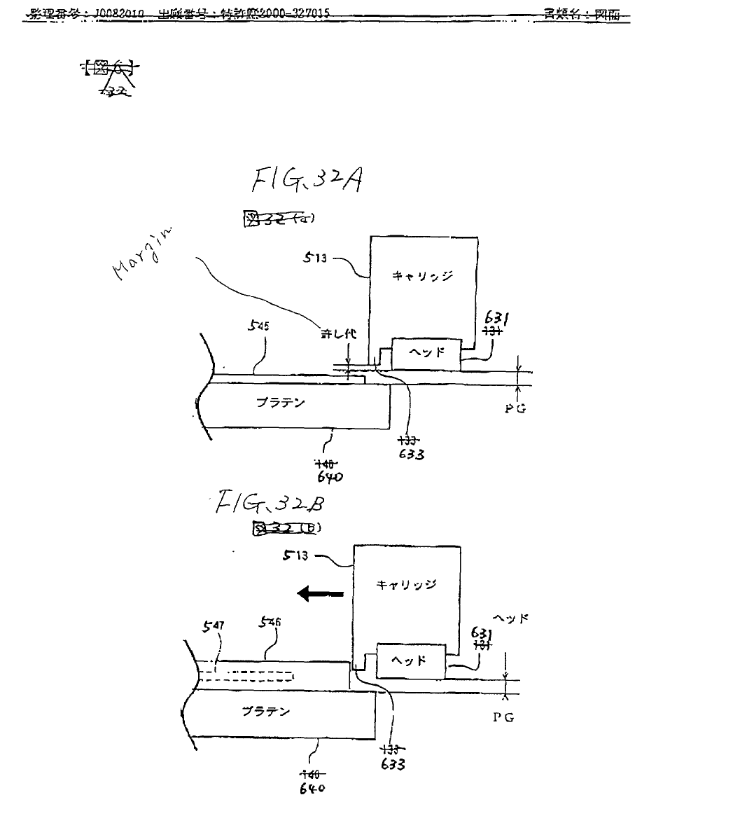

FIGS. 32A and 32B are views for explaining a relation between a size of a set paper gaps and a thickness of paper. Each part shown in FIG. 31 is enlarged. In FIG. 32A, recording paper 545 is mounted on the platen 640, and the FIG. 32A shows a state where the paper gap (the value shown PG in figure) which is adjusted to thin paper is set. In FIG. 32B, the paper gap is set to thin paper, however, a state where the transfer tray 546 is mounted on the platen 640 is actually shown.

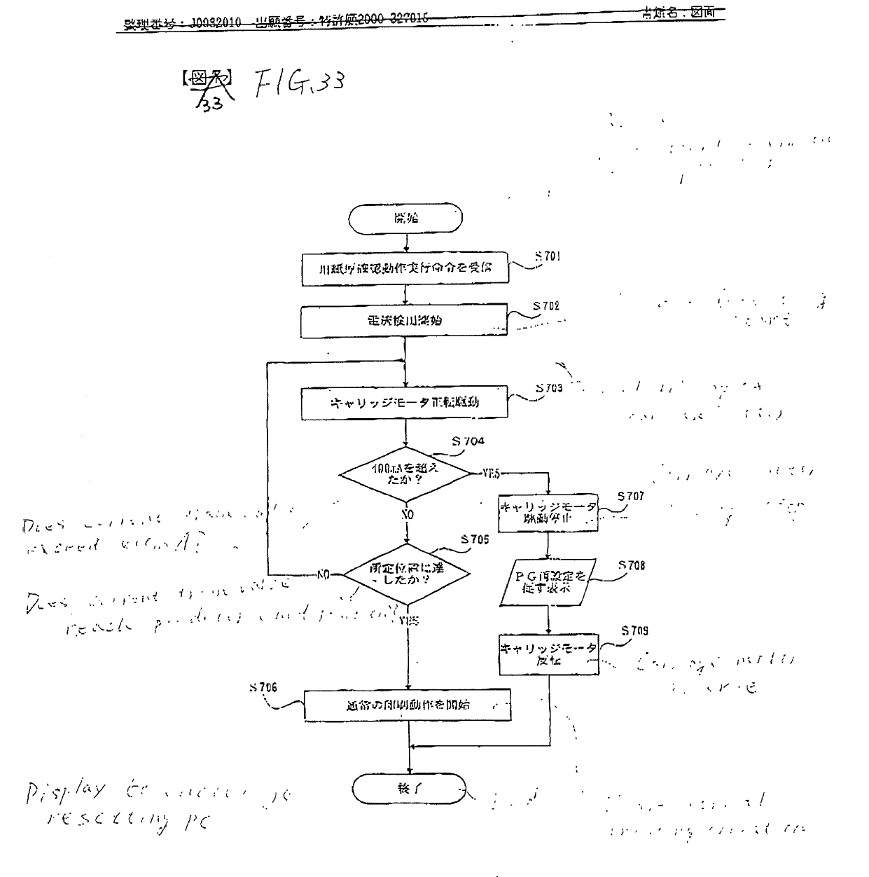

FIG. 33 is a flow chart to explain a procedure of flow in the motor controlling unit 535 when thickness of paper is confirmed in a state shown in FIG. 31A or a state shown in FIG. 32B.

For example, in a state shown in FIG. 31, paper thickness confirmation operation is instructed prior to print command (S701 in FIG. 33) and the rotation controlling part 539 drives the carriage 613 and starts to move the carriage motor 613 in the arrow direction. At that time, the current sensor 614 monitors consumption current of the carriage motor 613 (S702 and S703). In this case, the consumption current value in the carriage motor 613 also does not exceed 400 mA (NO in S704). The carriage reaches a position shown in FIG. 31B, it is judged that there is no unsuitable paper, and the judging part 538 instructs to the rotation controlling part 539 so as to perform normal print operation (YES in S705, S706).

On the other hand, at a time when a state shown in FIG. 32B, in a process where the carriage 13 is moved in the arrow direction, the carriage motor 613 receives a high load and a consumption current is abruptly increased for a short time. When the consumption current value detected by the current sensor 614 exceeds a predetermined value (400 mA), the contradistinction part 537 informs the judging part 538 of it (YES in S704). The judging part 538 judges that the paper is unsuitable and instructs to stop the carriage motor 613 (S707).

Since the judging part 538 encourages reset the paper gap of the user, the judging part 538 instructs to a display controlling unit 541 and warning is displayed on a liquid crystal display device 520 of the printer 501 (S708). The carriage motor 613 is rotated in an opposite direction by a rotation controlling part 539 and the carriage 513 is instructed to return to a home position.

At this time, if a host computer 502 is connected to the printer 501 so as to be capable of communicating in two ways, the judging part 538 may inform the host computer of unsuitable of recording paper to the paper gap. The host computer 502 displays warning by a function of a printer driver.

These procedures are repeated again when the user of the printer resets the paper gap responding to the process performed by the printer for responding to the unsuitability of paper (S701 to S706).

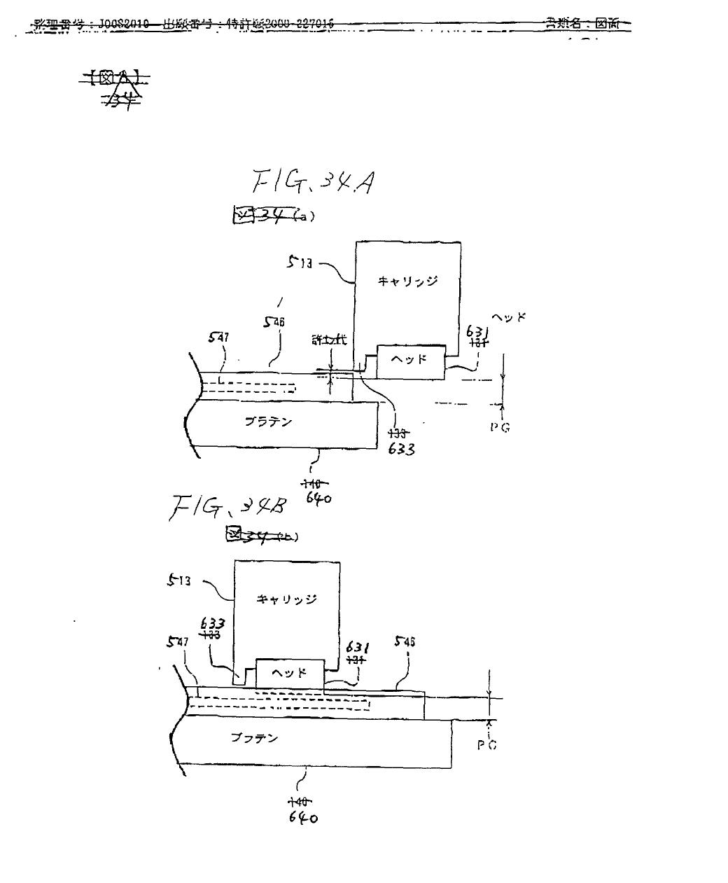

FIG. 34A is a view to explain a reason why the projection 633 has a predetermined margin for the recording head 631.

In the embodiment, a transfer tray 546 embeds with the optical disk 547 therein to house the optical disk 547. A print face of the optical disk 547 is positioned at a lower position than height of an end face of the transfer tray 546. If a bottom of the projection 633 is positioned at the same height as an opening face of each ink nozzle, the projection 633 is positioned at the same height as an opening face of each ink nozzle, the projection 633 is caught an end face of the transfer tray 546 except that the paper gap is set so that a distance from the nozzle to the print face is too far. The bottom of the projection 633 of the carriage 513 is offset at the slight upper side than a bottom face of the recording head 631.

By providing with the spacing, at a time of the actual print operation, a distance from an ink nozzle to the print face of the optical disk 547 is appropriately held. (See a bottom face of the recording head 631 shown with a hidden line in FIG. 34B). A size of spacing is set depending on a shape of the transfer tray 546, and it is not always necessary that the projection 633 is positioned at a higher position than a position of the recording head 631.

According to the present invention, it becomes possible to prevent from operating an error by set error of the paper gap and jamming paper when extremely thick recording paper such as a transfer tray setting the optical disk is printed.

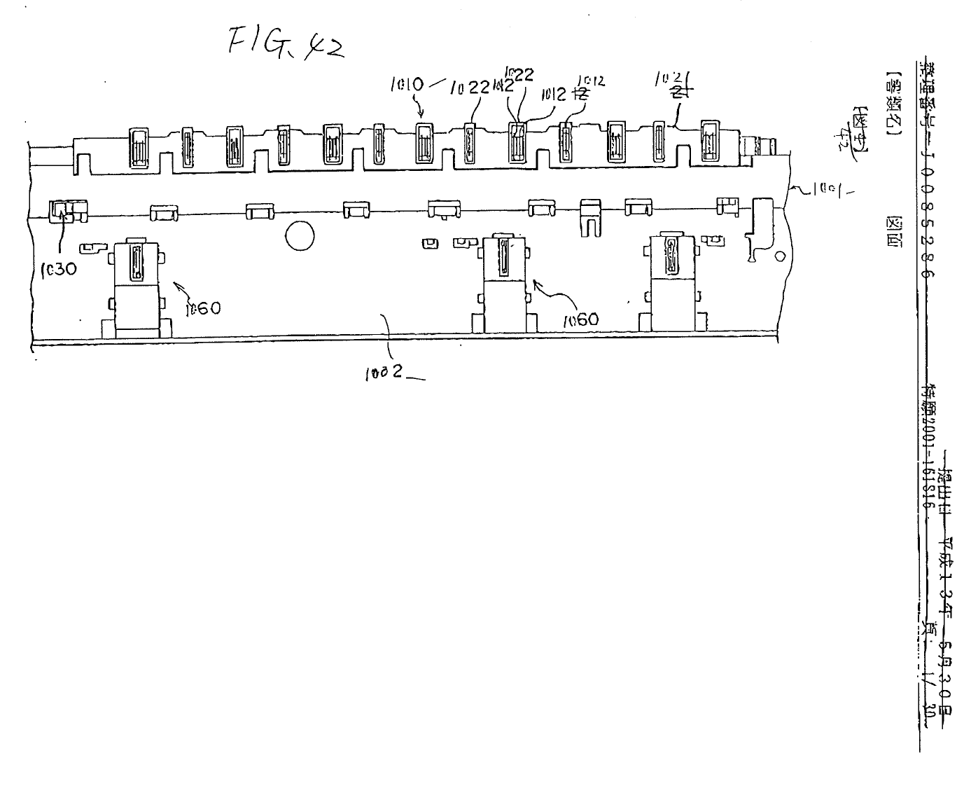

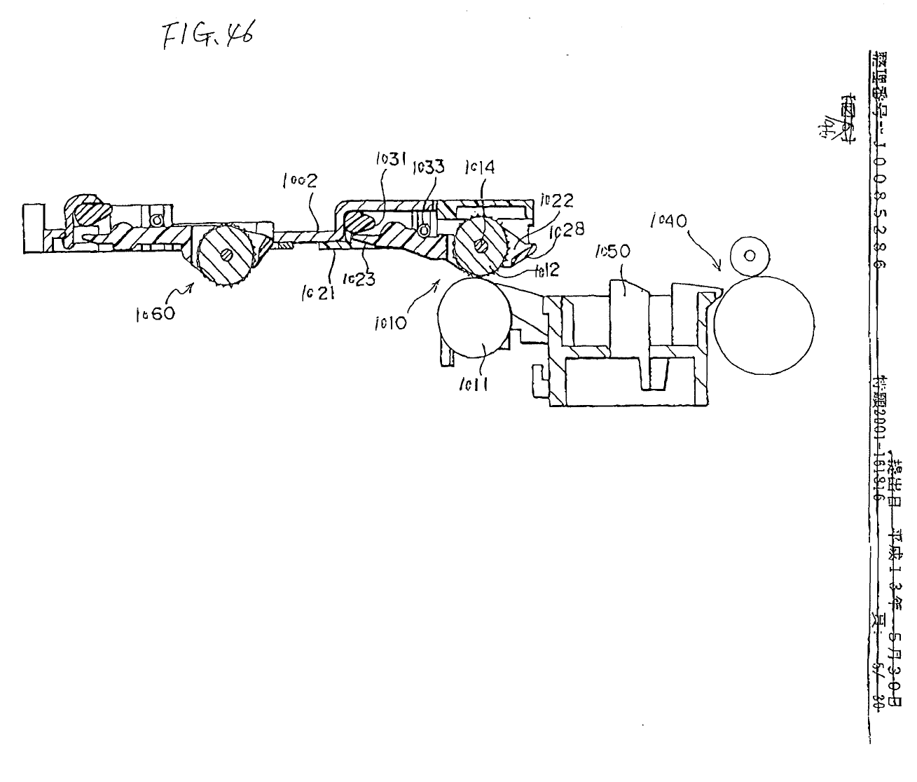

In following, an embodiment of another invention will be described referring to the figure drawings. FIG. 42 shows a plan view of the arrangement of the paper ejection roller 1010 in the inkjet type recording apparatus of an embodiment of the present invention. The roller 1010 is provided on a send-out following roller 1012 in a state where an upper part of a send-out following roller 1012 is exposed. The roller 1010 is aligned at a plurality of places in the main scanning direction according to width of a sheet to be recorded P. A send-out roller 1060 is provided at lower side of a transfer direction from the roller 1010. Normally, the number of the rollers 1060 is fewer than the number of the rollers 1012 and the roller 1060 is one part of a send-out apparatus (See FIG. 46). Description will be explained based on the roller 1012. It cannot prevent that the roller 1060 has the same mechanism.

In FIG. 42, when the sheet to be recorded is forwarded, the sheet to be recorded is transferred from an upper side of the transfer direction (upper part in FIG. 42). The sheet to be recorded is sent out to the outside the recording apparatus via the roller 1060 provided at the lower side of the transfer direction (lower part in FIG. 42) while the sheet to be recorded by a send-out driving roller (not shown) and the roller 1060. In a case of backward, the sheet to be recorded P is transferred towards upper part in FIG. 42. At this time, the roller 1012 is reversed. A forward direction is shown in a case where the upper part of the transfer direction and the lower part of the transfer direction is not specially mentioned.

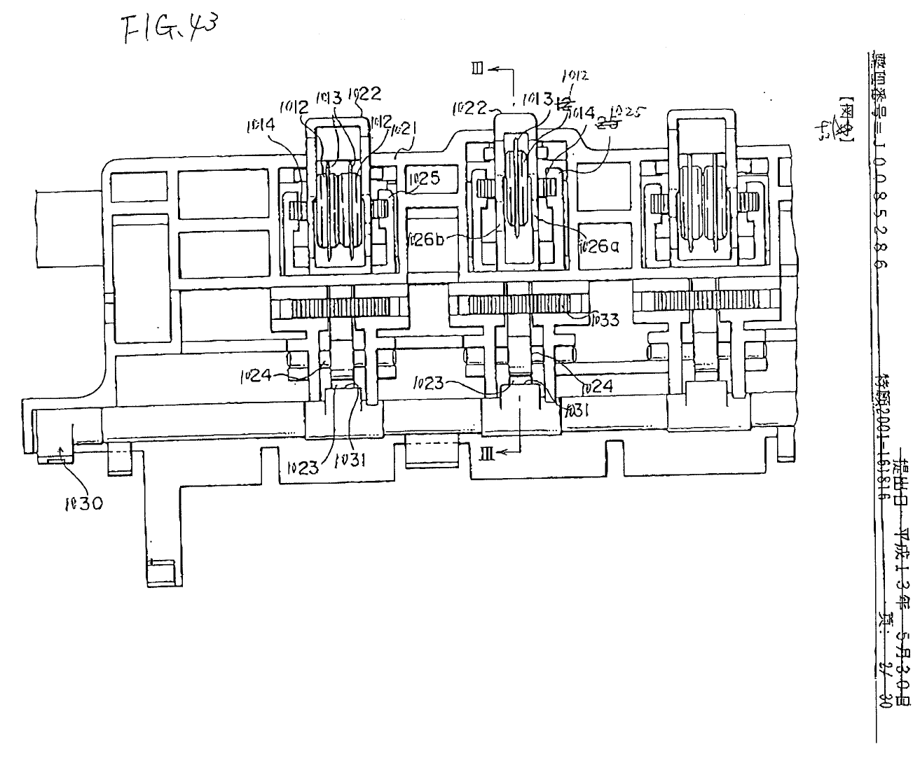

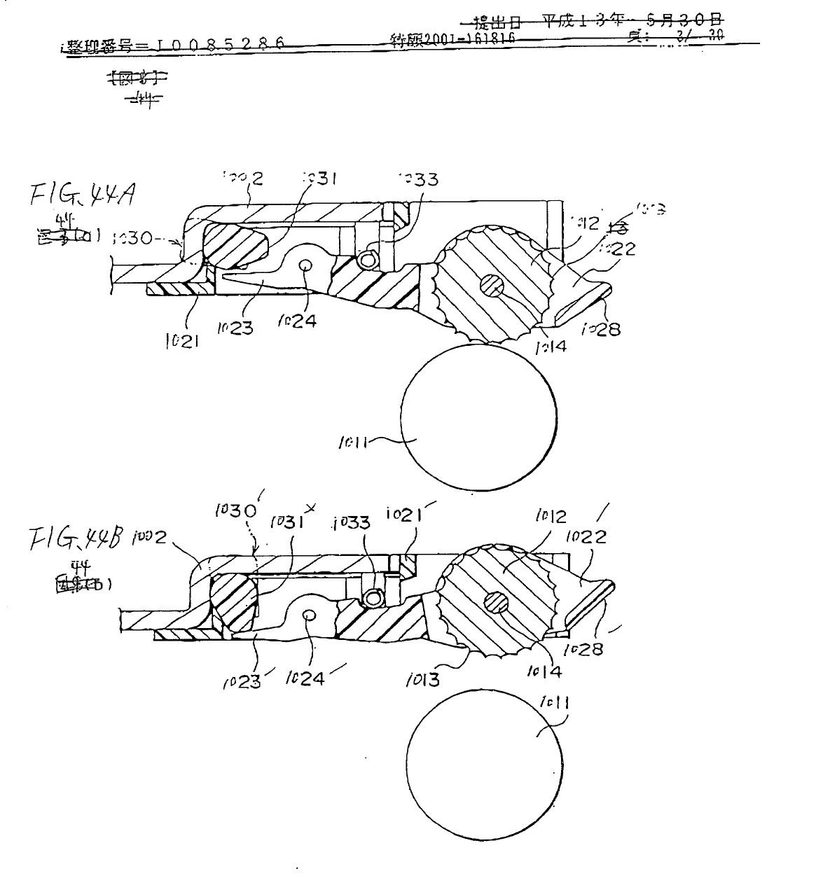

FIG. 43 is a view in which a main part of FIG. 42 is enlarged and shows a state where a send-out frame 1002 is taken off in order to be clear an internal configuration. FIGS. 44A and 44B are cross-sectional views of a main part of III-III line in FIG. 43.

In the present embodiment, a holder for send-out following roller is comprised of a main folder 1021 as a first holder. The holder is comprised of a plurality of small holders 1022. The main holder 1021 itself is integrally formed in one-body and obtains a space capable of all small holder 1022 and the roller 1012. The small holder 1022 is held by the holder 1021. The holder 1022 has a cam follower 1023 of a cam 1031 at the proximal. As shown in FIGS. 44A and 44B, an end holding the roller 1012 is provided at a bearing part of a main holder (not shown) by referring a support part 1024 so that the holder 1022 is separated from the holder 1021 and can be swinging up and down. Up and down position positions of the holder 1022 is switched by a cam mechanism comprised of the cam 1031 of a switching means 1030 and a cam follower 1023.

The cam 1031 is rotatable and constitutes a release mechanism by constituting so as to be able to switch into a state where the cam 1031 is contacted with a cam follower 1023 (FIG. 44B) and a state where the cam 1031 is not contacted with the cam follower 1023 (FIG. 44A) while the cam 1031 is rotated by operating the switching means 1030. A bar spring 1033 pushes the small holder 1022 at a center part (upper side of transfer direction from a support part 1024) from the proximal side to the end side. The bar spring 1033 forces in a lower direction. When the cam 1031 is not contacted with the cam follower 1023, the distal side of the small holder 1022 is tilted in a lower direction. As the support part being a center, a position of the distal is a normal position so as to contact with the sheet to be recorded (FIG. 44A). The distal side of the small holder 1022 is swung in the upper direction as pivoting the support part 1024 against a force applied in downward direction by the base spring 1033 by contacting the cam 1031 with the cam follower 1023 using the switching means 1030 and is shifted to evacuation position (Referring to FIG. 44B). By this release structure, one of two positions can be selected between the normal position (FIG. 44A), in which the following roller 1012 can be contact with the sheet to be recorded, and the position, in which the following roller 1012 does not contact with the sheet to be recorded (FIG. 44B).

A tilt face 1028 is provided at an end of the small holder 1022 and it is possible to lead transferred paper into a send-out passage (Roller 1012 and roller loll defined in FIG. 44) even if the small holder 1022 is either at a normal position or an evacuation position.

The roller 1012 comprises double holders and a single holder that are arranged alternatively. The double holder houses two following rollers 1012, each of which have teeth 1013 around its periphery, arranged in parallel as a pair inside one small holder 1022. The single holder houses one following roller 1012 inside the small holder 1022. The single roller is positioned in the upstream side in the transfer direction than the position of the double roller. By this arrangement, the single roller has a role as a preventing roller that prevents the sheet to jump up.

Each following rollers 1012 is supported by the small holder 1022 such that each rollers 1012 can rotates around the axis 1014, independently. Furthermore, the axis 1014 penetrates through the wall bodies 1026a and 1026b of the small holder 1022 and is supported by the axis bearing part 1025, which is provided on both sides of the wall body 1026a and 1026b. Here, the axis 1014 may be a metal rod. The axis 1014 preferably made of material that can elastically deform and has a core adjusting function. In the present embodiment, bar spring is used as the axis 1014.

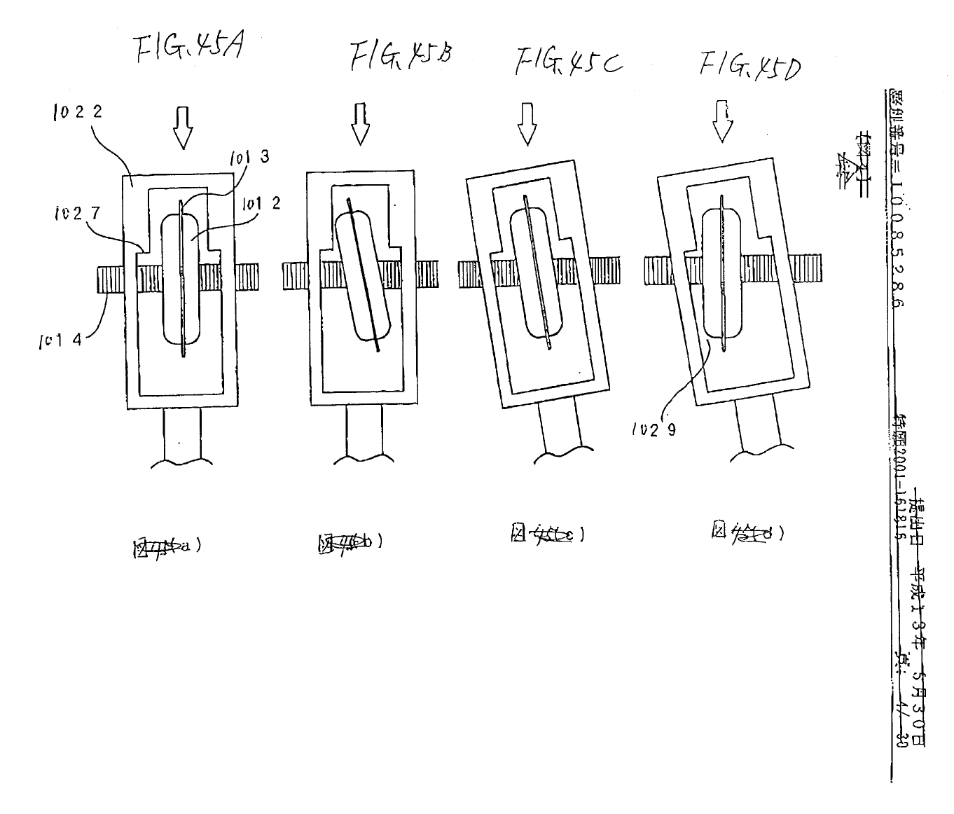

In the present embodiment, the distance between the inside face of the wall body 1026a and 1026b becomes longer than that of the upstream side in the transfer direction by providing a step part 1027 (Refer to FIG. 45) on the inside face of two wall bodies 1026a and 1026b of the small holder 1022 at more upstream side than the supporting part of the axis 1014 in the transfer direction, that is, vertical direction in FIG. 45. By this structure, the space in the downstream side in the transfer direction inside the small holder 1022 is enlarged. Also, the space for allowing the following roller 1012 to be positioned parallel to the transfer direction of the sheet is formed. Therefore, the following roller 1012 can easily returns to normal direction even when the small holder 1022 is slanted.

In the following, the principle in which the following roller 1012 returns to parallel condition is explained with referring to FIG. 45. FIG. 45 emphasizes the characteristic of each parts and a degree of slanting angle because of convenience of explanation. Furthermore, the arrow in the drawing shows the direction for transferring the sheet.

There is a case where the roller 1012 is slanted from a state where the teeth 1013 is orthogonal to the paper to a state where the teeth 1013 is slanted to the right or left direction while the sheet to be recorded is transferred. The roller 1012 changes the direction of the roller 1012 inside the small holder 1022 from the direction parallel to a transfer direction (FIG. 45A) to the direction that is slanted from the transfer direction (FIG. 45B) in order to cancel the changes of the angle of the vertical direction.

On the other hand, the small holder 1022 originally serves control of a rotation direction of the roller 1012 and is constituted so that the small holder 1022 can be swung in an upper or lower directions of the small holder 1022.

Therefore, the supporting part 1024 that supports the small holder 1022 has a slight room so that the supporting part 1024 can shake to the right or left direction on the supporting part 1024 as a bearing point. Because of the reason, with the change in direction of the roller 1012, the small holder 1022, which has a small room to receive the pivot movement in lateral direction with respect to the paper feeding direction, comes to be inclined by a distance of the pivot just like it is urged from inside against the discharge following roller 1012, and finally comes to a state where it stops at the inclination limitation point as shown in FIG. 44C. Here, the roller 1012 has a nature to return to the normal direction while rotating. However, because the small holder 1022 is still in the inclined state, the inner wall of the small holder 1022 prevents the roller 1012 from returning. If the recording medium is continued to be fed, the teeth 1013 may give a damage to a recording surface of the recording medium such as fine recess or streaks because the discharge following roller 1012 cannot rotate smoothly. This may cause an undesirable exfoliation or picking and therefore printing quality may be deteriorated.

According to the invention, a step part 1027 is disposed on an inner surface of the wall body 1026a, 1026b of the small holder 1022 so that a distance between the inner walls downstream in the paper feeding direction is made longer than a distance between the inner walls upstream in the paper feeding direction. Therefore, parts or members of the paper discharge following roller disposed at downstream in the paper feeding direction, which roller being to be returned to the normal direction, are allowed to be received within a space or relief space within the small holder 1022 widened by the steps 1027. Then the paper discharge roller 1012 can readily be returned to the normal direction as shown in FIG. 44D. Thus, to make the condition where the paper discharge following roller 1012 can be readily returned to the normal direction causes a time in which the teeth 1013 contacts the paper surface while kept in the inclined posture to be the shortest. Therefore, particularly in a case where streaks on the surface of the recording medium, or exfoliation or picking on the coating paper can be avoided. In addition, the returning to the normal direction can be emphasized if the elastically deformable bar spring is used as a shaft body 1014 serving as an axis of rotation of the paper discharge following roller 1012 as in the present embodiment discussed above because of the core adjustment phenomenon.

As described above, the invention is described with reference to the ink jet type recording apparatus. However, the invention is not limited thereto or thereby. That is, the holder structure for the paper discharge following roller may also be applicable to the other types of printer, copying machine, facsimile machine or the like having the same or similar recording medium discharging mechanism.

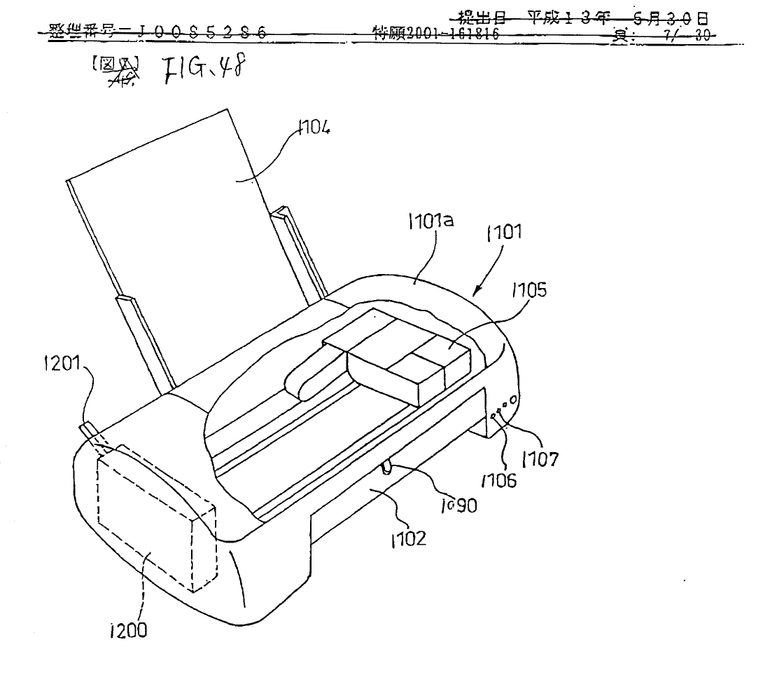

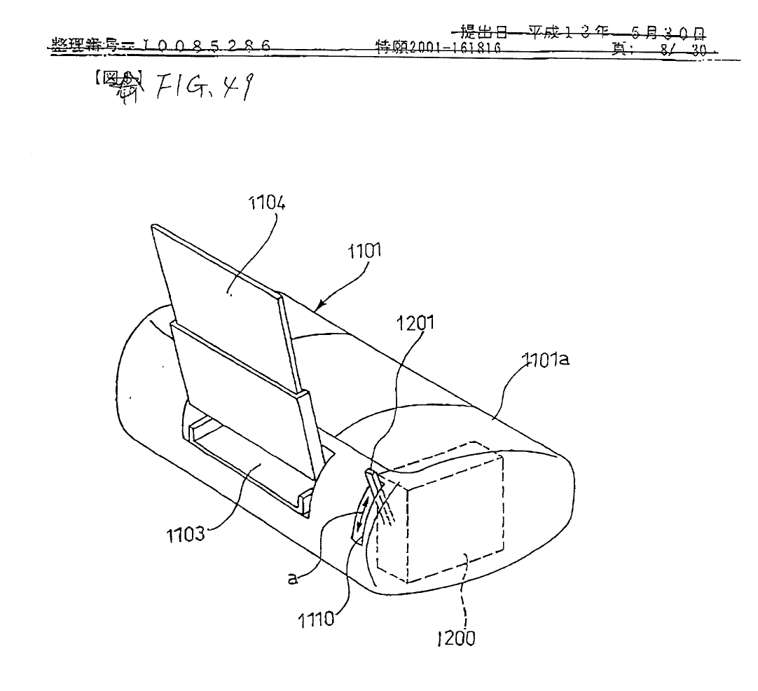

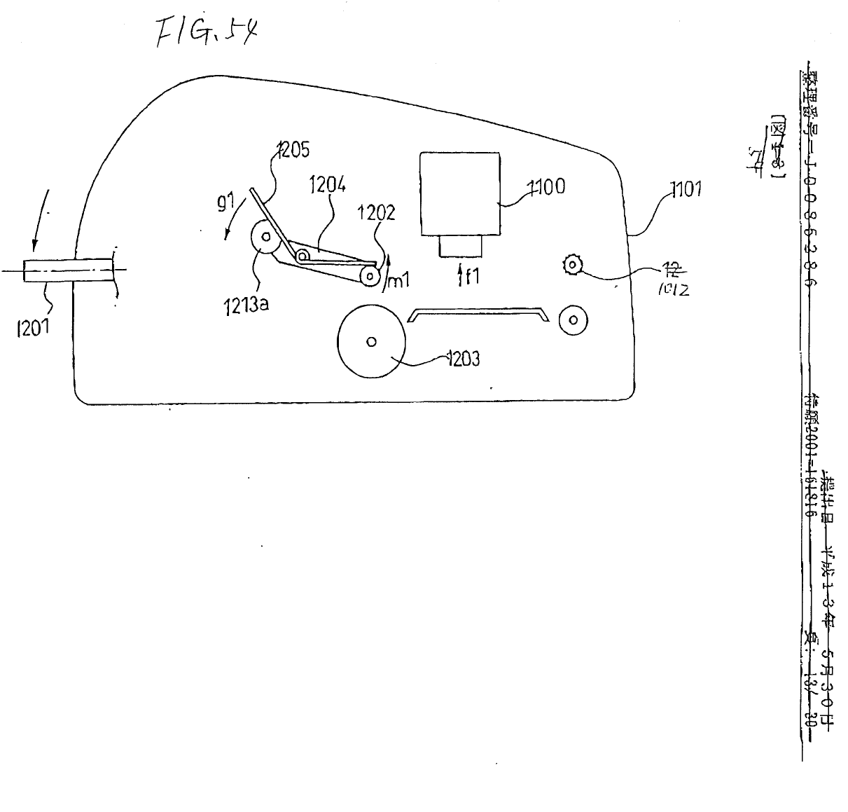

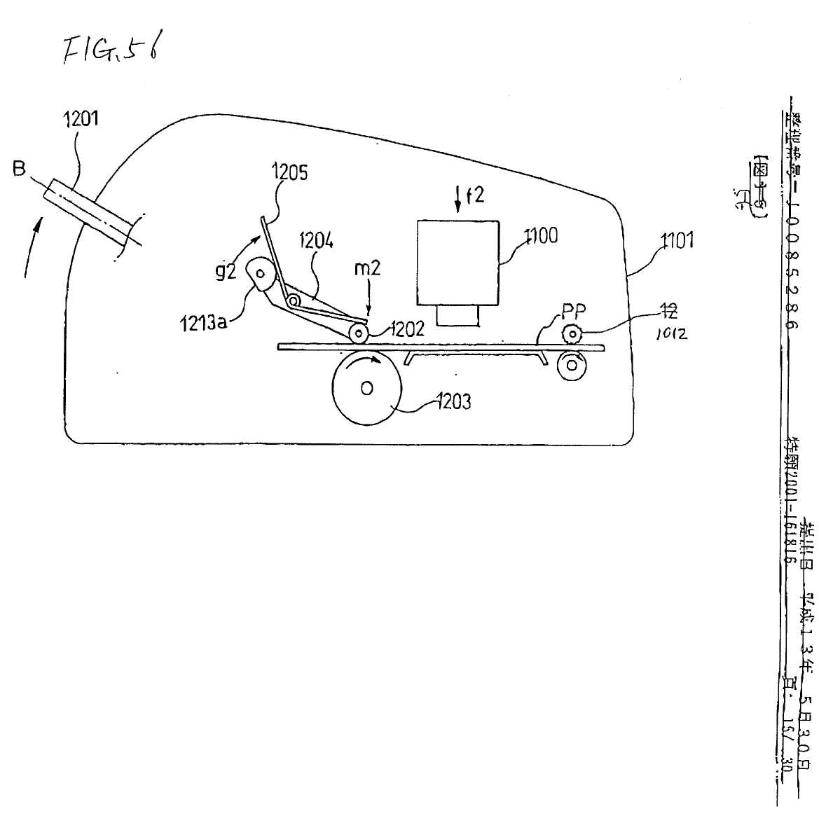

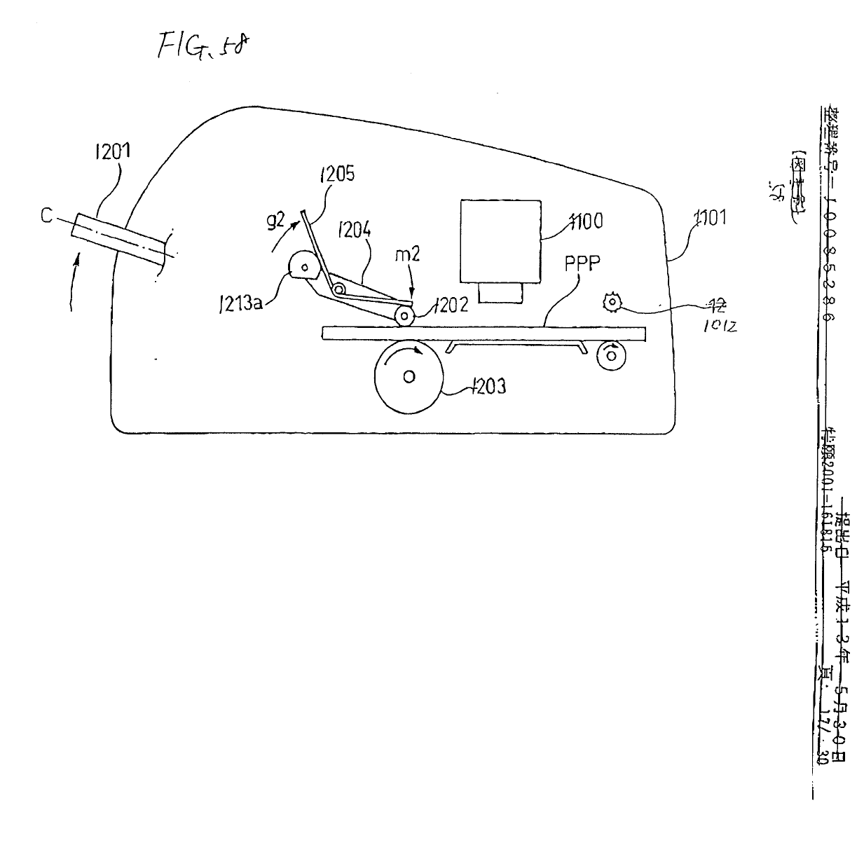

Next, a second embodiment of the present invention will be described with reference to accompanying Fig. drawings FIGS. 48 through 71. FIG. 48 is a perspective view showing an ink jet printer according to a second embodiment of the invention. and FIG. 49. is a perspective rear side angle view of the ink jet printer in FIG. 48. The ink jet printer is provided with a carriage 1105 in which a recording head 1100 is provided, a carriage driving mechanism (not shown), an auto sheet feeder (not shown), a paper gap switching means/discharge following roller release means/following roller separating means 1200 in a body 1101 covered with a cover 1101a. Also, a discharge outlet 1102 is on the front face of the body 1102, and a hand feeder inlet 1103 is at the back face of the body 1101.

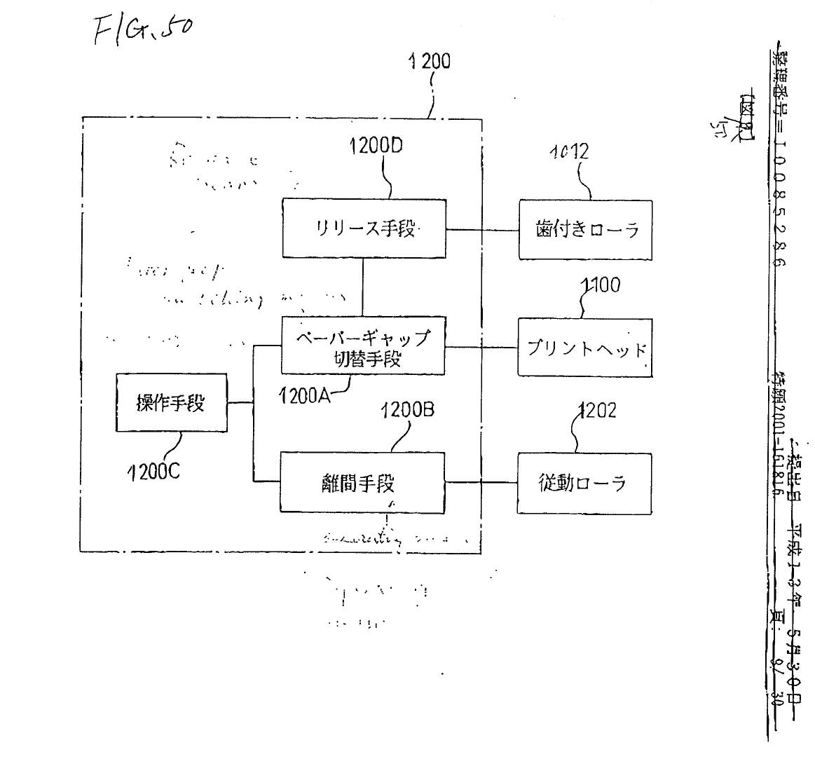

An auto sheet feeder tray 1104 is provided on the upper part of the outlet 1103 on the rear face of the body 1101. A control lever 1201 constituting a controlling means 1120C (see FIG. 50) of a paper gap switching means/discharge following roller release means/following roller separating means 1200 is projected from the body 1101 at the side of the outlet 1103.

The recording head 1100 has the ink cartridge (not shown) with a total of four colors, for example, yellow, magenta, cyan, black, and it is constituted so as to be capable of being a full color printer. Ink jet timing of the recording head 1100 and scanning of a head driving mechanism are controlled by a dedicated controller bold in the body 1101. Ink dot control with high precision and half tone processing are performed.

The sheet to be recorded is fed into the tray 1104 is automatically transmitted by the auto sheet feeder and is sandwiched by a feeder main driver roller (not shown) and a following roller (not shown) further to be transmitted and then is sent out from the outlet 1102. The sheet to be recorded is fed by hand into the outlet 1103 is sandwiched by the feeder roller and the following roller similar to the above and is transmitted. It is then sent out from the outlet 1102.

Normal paper, special purpose paper, recommended OHP sheet, glossy print paper, coated paper, coated film, label sheet, and post cards can be used as the sheet to be recorded fed from the tray 1104. The thickness may vary, such as cardboard or very thick cardboard (a tray for information recording disk is included) beside each piece of paper, that is, the printed material that is used may vary in thickness so that it is difficult to fold over.

The control lever 1201 constituting the control means 1220C slides in step in a shown arrow direction along slit 1110 provided linearly on the body 1101 and can set the paper gap switching means/discharge following roller release means/following roller separating means 1200. The paper gap switching means can be adjusted by moving, the recording head 1100 so that a distance between the paper face and a nozzle opening face of the recording head 1100, that is, a paper gap is almost always constant. Discharge following roller release means can release up to a waiting avoid position where the discharge following roller is not contacted with the sheet to be recorded according to a kind of sheet to be recorded if required. The following roller separating means applies a pressure to the following roller to push the following roller to the main driving roller or releases the pressure to separate the following roller from the main driving roller to sandwich the sheet to be recorded between the discharge main driving roller and the following roller or pull-out the sheet to be recorded from between the main driving roller and the following roller.

FIG. 50 is a block diagram showing the relation of the control means 1200C, a paper gap switching means 1200A, discharge following roller release means 1200D, and a following roller separating means 1200B in paper gap switching means/discharge following roller release means/following roller separating means 1200. Control means 1200C is provided in association with the paper gap switching means 1200A and the following roller separating means 1200B mechanically shown in FIG. 50 and further the paper gap switching means 1200A is associated with the discharge following roller release means 1200D. That is slide operation in step of only one control lever 1201 constituting the control means 1200C makes the paper gap switching means 1200A, discharge following roller release means 1200D, and the following roller separating means 1200B operate and can set the recording head 1100, the discharge following roller 1012 and the following roller 1202 to a desired state.

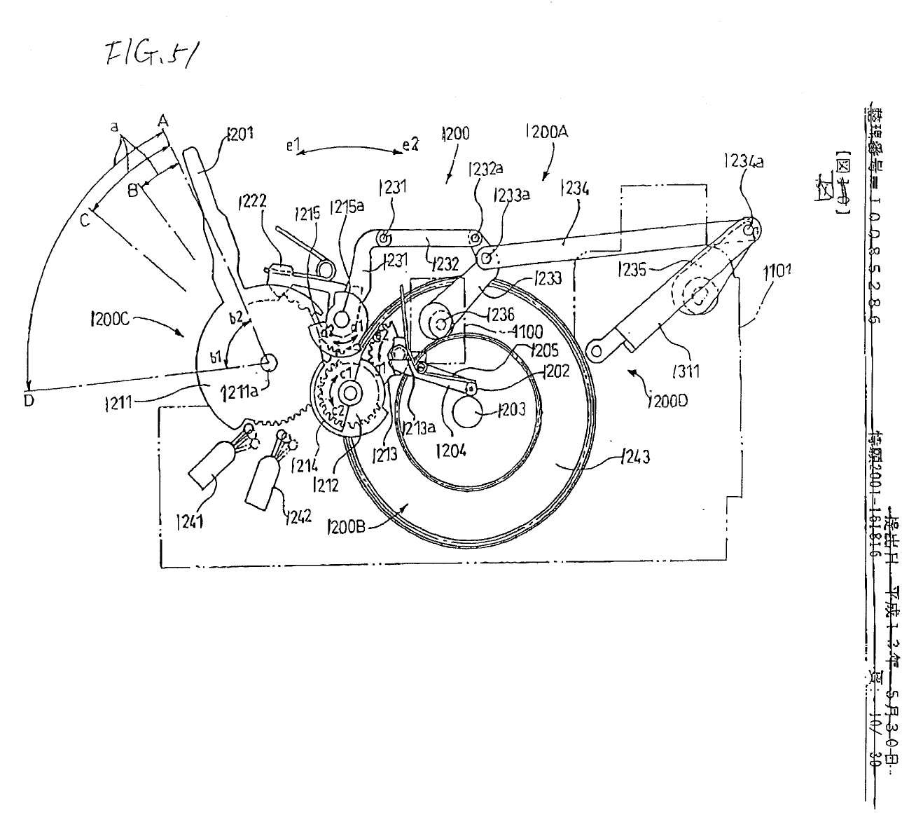

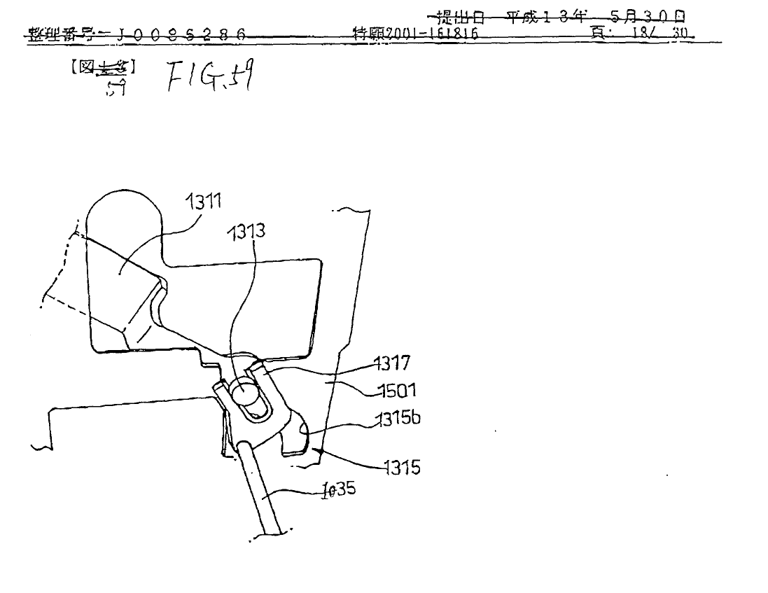

FIG. 51 is a side view showing a detailed example of the control means 1200C, the paper gap switching means 1200A, the discharge following roller release means 1200D, and the following roller release means 1200B. The control means 1200C provides with a first intermittent gear 1211 having the control lever 1201, a second intermittent gear 1212 and a third intermittent gear 1214. That paper gap switching means 1200A provides with an eccentric cam 1236 in which a carriage is set having a first link 1231, a second link 1232, a third link 1233, a four link 1234, a fifth link 1234, and the recording head 1100. The discharge following roller release means 1200D provides with a cam shaft 1035 having a U-shaped receiving part 1317 and the cam 1031, a holder for the discharge following roller having the cam follower 1023, an arm part connected to the paper gap switching means 1200A (6th link 1311) and a guide groove 1315 as a guide structure (See FIGS. 59-62). The following roller separating means 1200B provides with a 4th intermittent gear 1213 having an axis 1213a of which a part of circumference face is a flat face, a 5th intermittent gear 1215, a following roller arm at en end at which the following roller 1202 is rotatably set and is provided with a coil spring 1205.

The control lever 1201 is integrally formed so as to protect from a circumference part of the first intermittent gear 1211 and a ratchet 1222 is engaged with the first intermittent gear 1211. The control lever 1201 can be reciprocally rotated as shown in an a arrow direction around the axis 1211a of the first intermittent gear 1211 and can determine a position of a position A, position B, position C, and a position D in the steps.

When the control lever 1201 is positioned at position A, position A is a position to use the record sheet with normal thickness, for example, normal paper. When the control lever 1201 is positioned at position B, position B is a position to use the record sheet of a slight thick, the cardboard. When a control lever 1201 is positioned at position C, position C is a position to record a sheet that is very thick, for example, very thick paper including a tray for information recording disk. Further, when the control lever 1201 is then positioned at position D, position D is a position where the following roller 1202 is separated main driving roller 1203.

The first intermittent gear 1211 is provided so as to engage with the second intermittent gear 1212. The intermittent second gear 1212 is provided so as to be engaged with the fourth intermittent gear 1213. The third intermittent gear 1214, provided on the same axis with the second intermittent gear 1212, is provided so as to be engaged with the fifth intermittent gear 1215.

A center part of the coil spring 1205, an end is stopped at the following roller 1202 and the other end is contacted with the D axis 1213a of the fourth intermittent gear 1213, is stopped at an almost center part of the following roller arm 1204. The other end of a following roller 1204 of an end at which the following roller 1202 is rotatably attached is attached to an axis 1213a.

A free end of the first link 1231 of the first and second links 1231 and 1232, being substantially L-shaped, connected by a hinge 1231a at axis 1215a of the intermittent fifth gear 1215. A free end of the second link 1232 is connected with the end part at a hinge 1233a side of the third link 1233 of the third, fourth, and fifth links 1233, 1234, and 1235, being substantially U-shaped, by hinges 1233a and 1234a, by the hinge 1232a. The free end of the third link 1233 is connected with the carriage 1105 via the eccentric cam 1236 and a free end of the fifth link 1235 is actually supported so as to be rotatably in the body 1101.

The sixth link 1311 is a crank shaped connection arm and one end is connected with the hinge 1234a connecting with which the fourth and fifth links 1233 and 1234. The sixth link 1311 is stopped to a U-shaped receiving part (not shown) by a pin 1313 as a projecting part at the other end (see FIGS. 59 to 61).

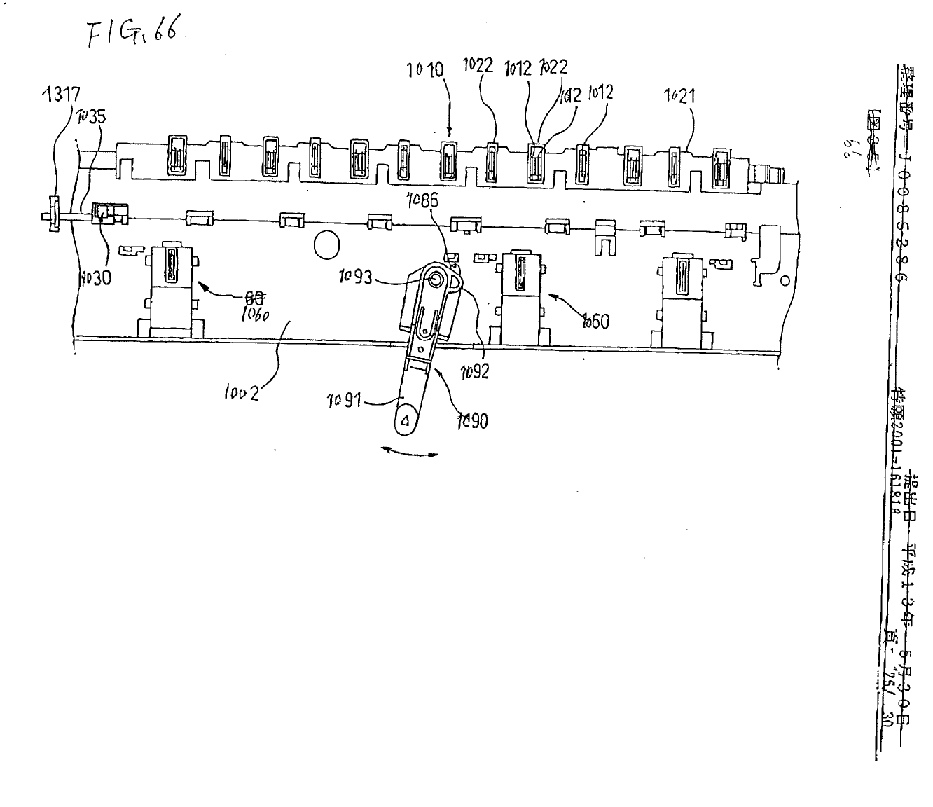

A folder for discharge following roller is constituted by a main folder 1021 as the first folder and a plurality of small folders 1022 as a second folder. The main folder 1021 itself is integrally formed and obtains a space capable of folding all of the small folders 1022 and the discharge following roller 1022 inside. The discharge following roller 1012 is arranged so that a pair of rollers having teeth 1013 on an outer circumference is stored in one of the small folders 1022. One roller is positioned at the slight upper side of the transfer direction from the pair of rollers as shown in FIG. 66.

Each discharge following roller 1012 is borne to the small folder 1022 so that the discharge following roller 1012 is rotatably by the axis 1014. The axis 1014 may be a metal bar, however, the flexible changeable axis having an elastic function 1014 is preferred.

An inclined surface 1028 is provided at the end part of the small holder 1022 and the sheet to be recorded can smoothly be read into a discharge passage (this is defined by the discharge following roller 1012 and the discharge driving roller 1011) at a position where the small holder 1022 is either at a normal position or a waiting avoid position.

Although the small holder 1022 is held in the main holder 1021, the small holder has the cam follower 1023 of the cam 1031 at the proximal side. The proximal side holding the discharge following roller 1012, is moveable up and down, provided bearing a part of the main holder (not shown) by pivoting the supporting part 1024 so that the proximal side is separated from the main holder 1021. The bar spring 1033 pushes the holder 1022 at the center part (the upper side of the transferred direction from the supporting part 1024) from the proximal side to the end side of the small holder 1022 and forces in a lower direction. Switching into an upper position and a downward position of the small holder 1022 is carried out by a mechanism comprised of the cam 1031 and the cam follower 1023.

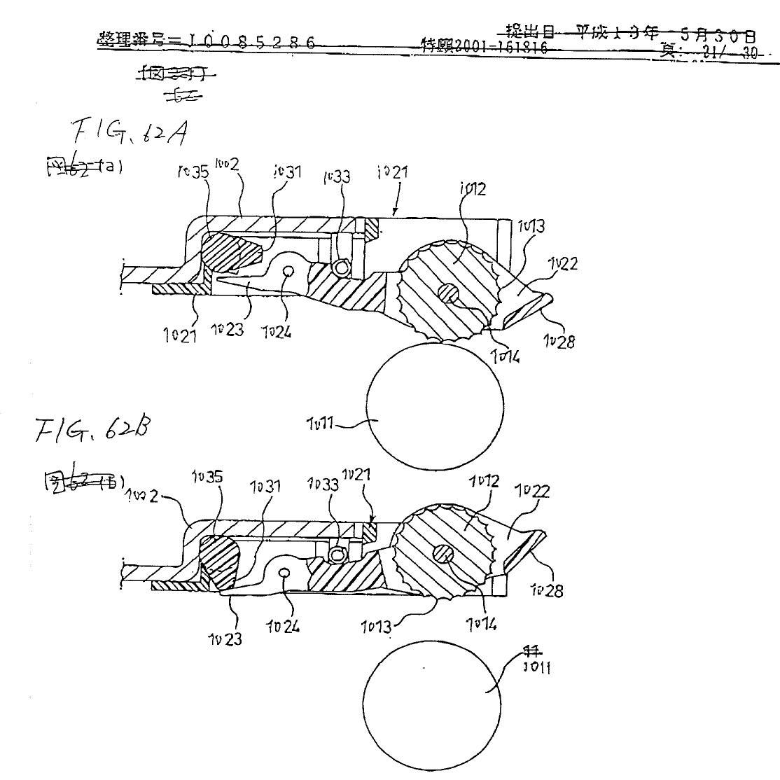

In this example, the cam 1031 is rotatably provided and is constituted so as to be capable of switching into a state contacted with the cam follower 1023 shown in FIG. 62B and a state is not contacted with the cam follower 1023 shown in FIG. 62A. Thereby release of the discharge following roller 1012 becomes possible. When the cam 1031 is not contacted with the cam follower 1023, the end side of the small holder 1022 moves down by pivoting the supporting part 1024 with a force of the bar spring 1033 and a position is a normal position capable of contacting with the sheet to be recorded (FIG. 62A). On the other hand, the end side of the small holder 1022 moves up by pivoting the supporting part 1024 against the force in a lower part with the bar spring 1033 and a position is transferred to the waiting avoid position by contacting the cam 1031 with the cam follower 1023 as best shown in FIG. 62B. The cam mechanism can select two positions, either a normal position where the discharge following roller 1012 can be contacted with the sheet to be recorded or the waiting avoid position where the discharge following roller 1012 is not contacted with the sheet to be recorded.

A limit switch 1241 turning on/off the auto sheet feeder and the limit switch 1242 turning on/off the printer by rotating the first intermittent gear 1211 is provided at the lower part of the first intermittent gear 1211.

An encoder 1243 used as a control when printing on the sheet to be recorded is provided to the main driving roller 1203.

Since the control means 1200C operating three system driving of the paper gap switching means 1200A, the discharge following release means 1200D and the following roller separating means 1200B in series is provided, switching the paper gap, switching a release state of the discharge following roller, and switching a separating state of the following roller can be performed by operation of only the control means 1200C. It becomes smoothly possible to switch the paper gap and operate the discharge following release and break the following roller separation without error. User friendliness can be improved.

Since each function of the paper gap switching, discharge following roller release, and following roller separation is integrated, structures of the control means 1200C, the paper gap switching means 1200A, the discharge following roller release 1200D, and the following roller separating means 1200B are simplified. Design becomes simple and design error can be reduced. Manufacture or assemble costs and labor costs can be reduced.

In constitution like this, outline of the operation will be described relating to FIGS. 51-61. In a state of FIG. 51 when the control lever 1201 is positioned at position A, power from the coil spring 1205 pushed to the D axis 1213a is applied the following roller 1202 so that the following roller 1202 pushes a paper P transmitted between the following roller 1202 and the main driving roller 1203. The recording head 1100 is set so as to be a paper gap ha matched with the paper P. The recording head 1100 thickness is about 0.6 mm or below including paper variety, the recording head 1100 is adjusted by moving so that the paper gap ha is about 1.2 mm.

The sixth link 1311 is the most tilted and is shown in FIG. 51. The pin 1313 provided at the free end of the 6^{th} link is shown in FIG. 59 is positioned around the end of the U-shaped receiving part and still does not push the U-shaped receiving part 1317. The cam shaft 1035 is not rotated and the cam 1031 is not contacted with the cam floor 1023 of the small holder 1022 as shown in FIG. 62A. The same following roller stays at the normal position contactable with the sheet to be recorded such as the paper. The limit switches 1241 and 1242 at this time are turned on and the lamps 1106 and 1107 shown in FIG. 48 provided on a front face of the body 1101 are lighted.

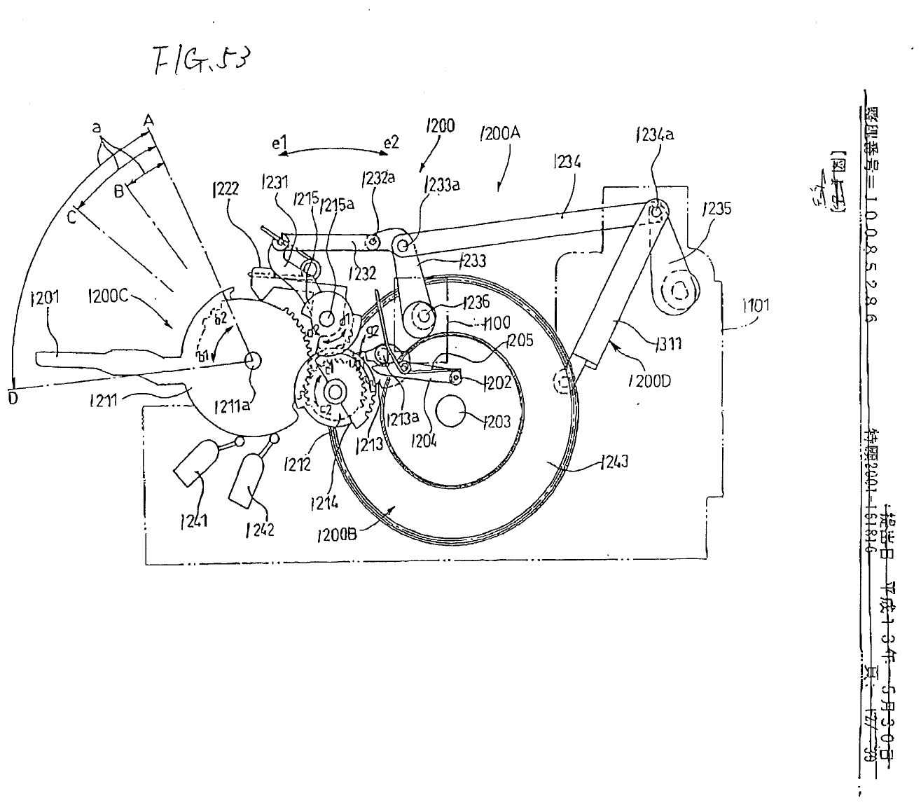

Next in the state in FIG. 53, when the control lever 1201 is positioned from position A to position D, the second intermittent gear 1212 and the fourth intermittent gear 1214 are firstly rotated in a shown arrow c1 direction and the fifth intermittent gear 1215 is further rotated in a shown arrow d1 direction. Thereby, since each of the links 1231-1235 is rotated in a shown arrow e1 direction, the recording head 1100 is moved in a shown arrow a1 direction, that is, moved up. Since the recording head 1100 has a thickness around 1.6 mm-2.5 mm including a variety of very thick paper, the recording head 1100 is positioned from a position of the paper to a position where it is moved up to about 2.8 mm.

In the way of operation, since the third intermittent gear 1213 is started to rotate in a shown arrow g1 direction as shown in FIG. 53, the coil spring 1205 is caught at a flat part of the D axis 1213a and the following roller 1202 is released from the force of the coil spring 1265 to be separated from the main driving roller 1203 into a shown arrow m1 direction.

A sixth link 1311 transfers to the most stand state by switching the control lever 1201 from position A into position B. The straight part 1315a of the guide groove 1315 from the end position of the U-shaped receiving part 1317 (see FIG. 59) to a position most deeply stopping to the U-shaped receiving part 1317.

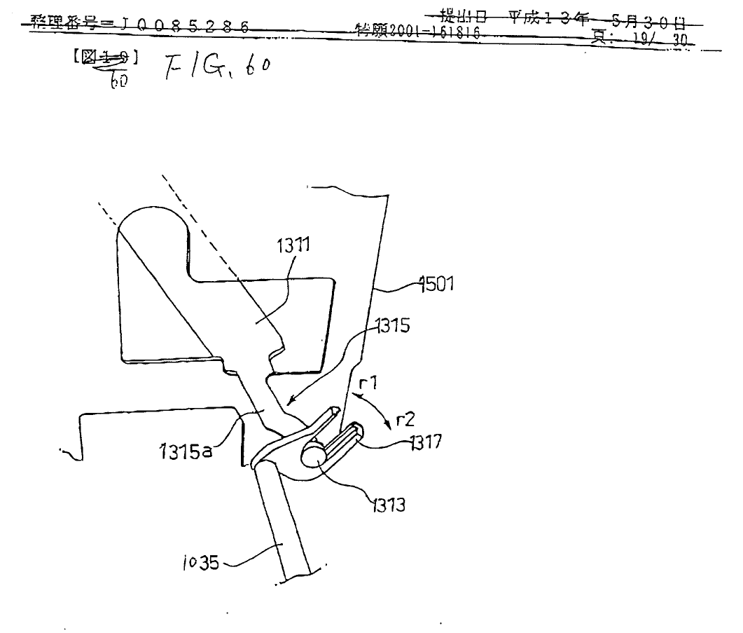

The pin 1313 pushes the U-shaped receiving part 1317 to rotate the U-shaped receiving part 1317 in an r2 direction in FIG. 60 along an arc part 1315b of the guide groove 1315. As a result, the cam shaft 1035 is rotated and become 1031 is contacted with the cam follower 1023 of the small holder 1022, then the proximal side of the small holder 1022 moves down. The end side of the small holder 1022 is swung against the force of the bar spring 1033 by pivoting the supporting part 1024 and the discharge following roller 1012 is moved to a position where it is not contacted even if the very thick paper such as CD-R tray is inserted. The discharge following roller 1012 in this state (waiting position) is changed from the normal position up to approximately 3 mm. It is possible that all of the discharge following rollers 1012 are to be released to the waiting position. The released discharge following roller 1012 in a plurality of discharge following roller 1012 arranged with direction of the sheet to be recorded inclined with a predetermined width. Only the discharge following roller 1012 of a part corresponding to a width of the CD-R is released viewed from the U-shaped receiving part 1317.

Since extra load to the cam shaft 1035 is not needed, a stable release can accurately be carried out.

In this state, both the limit switches 1241 and 1242 are turned off, and lamps 1106 and 1107 arranged in front of the body 1101 shown in FIG. 48 is operated to turn on and off.

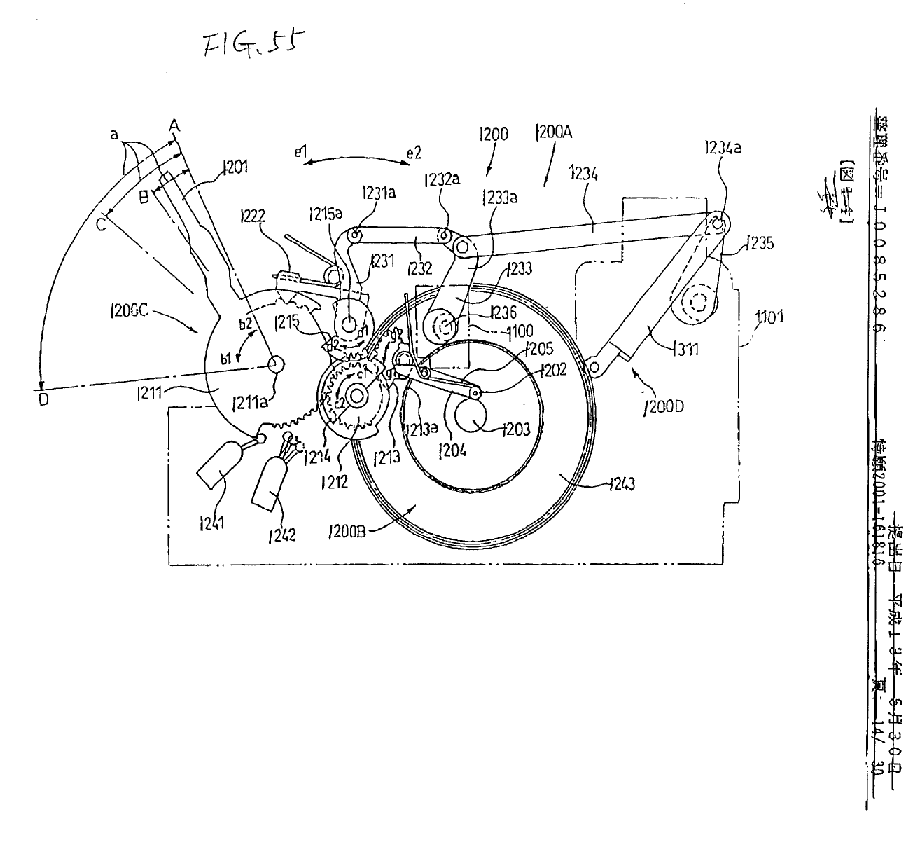

Next, in a state shown in FIG. 55, that is, when the control lever 1201 is set to position B from position D, the first intermittent gear 1211 rotates along an arrow b2 in the drawings while fourth intermittent gear 1214 rotates around an arrow c2 as well as the second intermittent gear 1212 rotates and, in addition, a fifth intermittent gear 1215 rotates along an arrow d2. Because of these operation, each of the links 1231 through 1235 rotates along an arrow e2 and, therefore, the recording head 1100 moves toward an arrow f2, i.e., moving down.

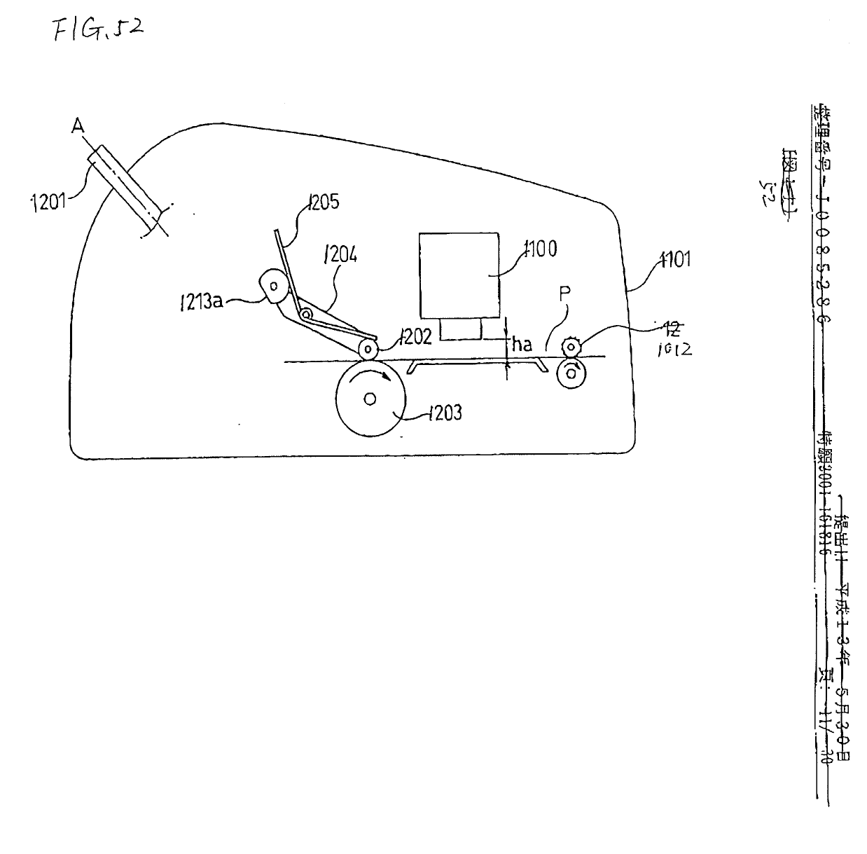

The recording head 1100 is adjusted by moving to a position spaced around 1.5 mm from a position of the normal paper in FIG. 52. At the same time, since the third intermittent gear 1213 is rotated in a shown arrow g2 direction as shown in FIG. 55 and the coil spring 1205 is pushed to the D axis 1213a, a resilient force of the coil spring 1205 pushing to the D axis 1213a is applied so that the following roller 1202 is rotated in a shown arrow m2 direction and the following roller 1202 pushes the cardboard P transmitted between the following roller 1202 and the main driving roller 1203.

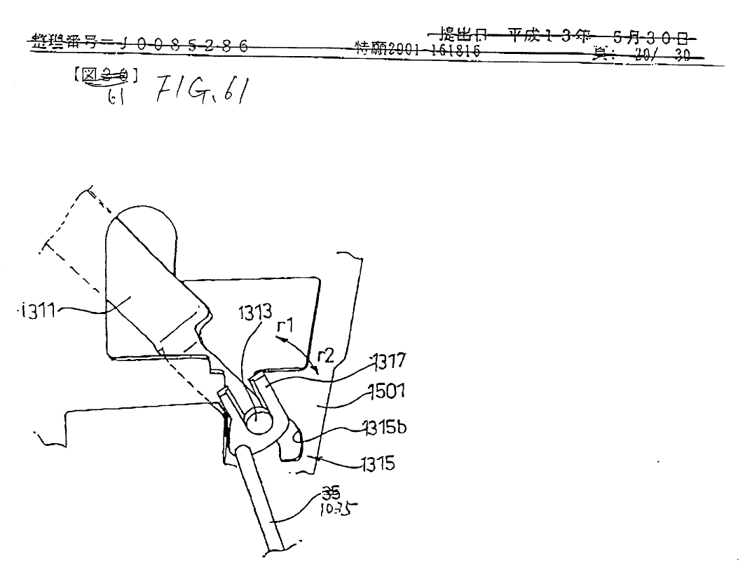

When the control lever 1201 is transferred to position B, the control lever 1201 is moved around the border of the arc part 1315b of the guide groove 1315 and the straight 1315a around the perimeter along the guide groove 1315 shown in FIG. 61 while the pin 1311 of the sixth link 1311 is connected with the U-shaped receiving part 1317 at the U-shaped bottom part. The U-shaped receiving part 1317 connected with the pin 1313 with the movement is also rotated in an r1 direction. The cam shaft 1035 is rotated in a synchronized rotation of the U-shaped receiving part 1317, as a result of this, the problem of the cam 1031 contacting with the cam follower 1023 is solved. The end side of the small holder 1022 is pushed up by pressure of the bar spring 1033 and a position of the small holder 1022 moves to the normal position contactable with the sheet to be recorded such as normal paper or cardboard (see FIG. 62A).

The limit switches 1241 and 1242 are turned on at this time, the lamp 1106 shown in FIG. 48 provided on the front face of the body 1101 flashes, and the lamp 1107 is turned on.

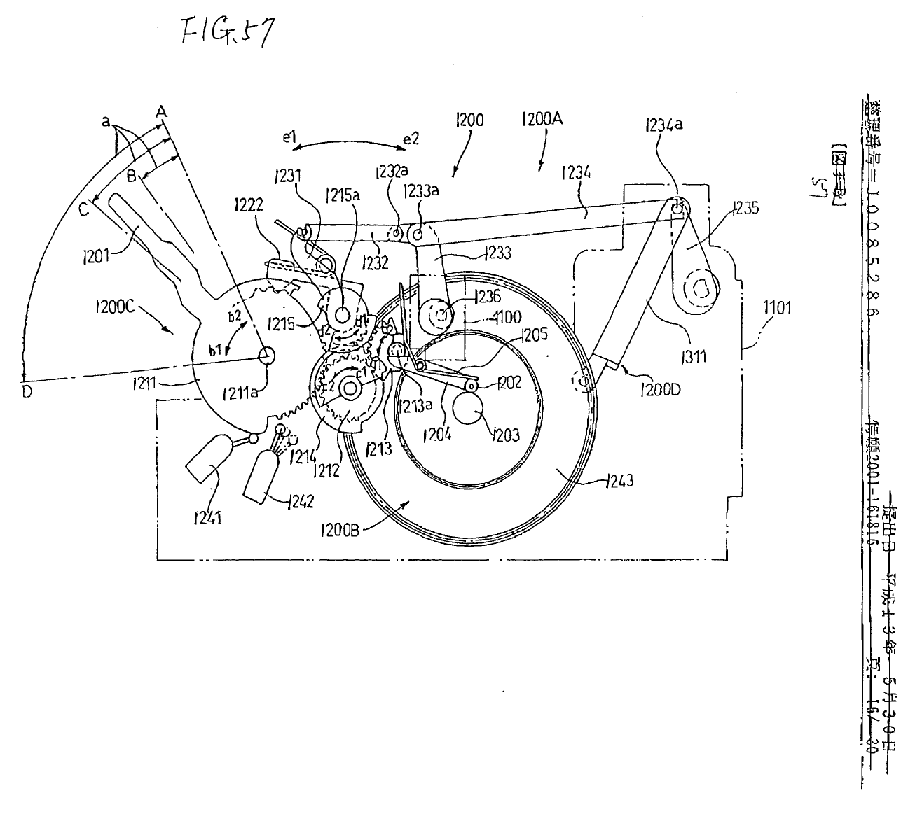

Next, in a state shown in FIG. 57, that is, when the control lever 1201 is set to position C from position D, the first intermittent gear 1211 rotates along an arrow b2, the second intermittent gear 1212 and the fourth intermittent gear 1214 rotate along an arrow c2, whereas the third intermittent gear 1213 rotates along an arrow g2. As a result, the coil spring 1205 is urged against an axis D 1213a, and the following roller 1202 rotates along an arrow m2 so that the elastic force of the coil spring 1205 urged toward the D axis 1213a is applied to urge the very thick paper PPP fed between the main driving roller 1203.

On the other hand, since the fifth intermittent gear 1215 is not associated with the fourth intermittent gear 1214 in switching of position D and position C of the control lever 1201, the links 1231-1235 are not moved and the recording head 1100 is not moved. Therefore, the recording head 1100 stays at a position changed about 2.8 mm from a position normal paper in FIG. 52. Since the sixth link 1311 is not changed, a stopping state of the pin 1313 and the U-shaped receiving part 1317 is the same as 19 and the discharge following roller 1012 stays at the waiting avoid position.

At this time, the limit switch 1241 is turned off while the limit switch 1242 is turned on, and a lamp 1106 arranged in front of the body 1101 shown in FIG. 48 flashes whereas a lamp 1107 is turned on.

As described above, in the ink jet printer of the present embodiment, the paper gap is switched at position A for normal paper, position B for cardboard, and position C for CD-R tray in three steps by switching the control level 1201, the discharge following roller 1012 is not released at position A and B, and the discharge following roller 1012 is released at position C, and position D (following roller separation). Since the discharge following roller 1012 is released in only necessary timing while it is associated with the paper gap switching means 1200A, the guide groove 1315 comprised of the straight part 1315a and the arc part 1315b and the U-shaped receiving part 1317 are used. In switching the control lever 1201 from position A to position B, movement of the paper gap switching means 1200A is changed to moving of the straight part 1315a of the pin 1313 and movement is not converted into rotation of the U-shaped receiving part 1317. In switching the control lever 1201 from position B into position C, the pin 1313 moves the arc part 1315b, movement is not converted into rotation of the U-shaped receiving part 1317 and the cam mechanism is operated.

When the paper gap is set to the normal paper erroneously in printing the CD-R (control level 1201 is at position A) in the paper gap switching means 1200A or the paper gap is set to cardboard (control level 1201 is at position B), a paper thickness detection means in which the CD-R tray is separately provided considers as error of thickness and the printing task cannot be executed.

The ink jet printer in the second embodiment moves the recording head 1100, and a switching driving operation of three system is realized by one control lever 1201 constituting the control means 1200C, accurate switching operation reads with high precision can be performed. The three system driving operation includes the paper gap switching means 1200A switching the paper gap reads different intervals, the release means 1200D changing the discharge following roller 1012 to switch the normal position and the waiting avoid position, and the following controller separating means 1200B applying/releasing pressure to/from the following roller 1220 and adjusting pressure to push in order for the sheet to be recorded with a different thickness.

Setting, releasing and recovery, applying and switching can smoothly be performed. The paper gap with different intervals of the recording head 1100 is set by the paper switching means 1200A through the second intermittent gear 1212 and the third intermittent gear 1214. The following roller makes the discharge following roller 1012 change according to the paper gap set to switching the lever from the normal position to the waiting avoid position is released and recovered. Pressure of the following roller 1202 by the following roller separate means 1200B is applied. Further, the control means 1200C, the paper gap switching means 1200A, the discharge following roller release means 1200D and the following roller separating means 1200B of the discharge following roller can be realized by a gear mechanism, a link mechanism, and a cam mechanism that has a simple construction

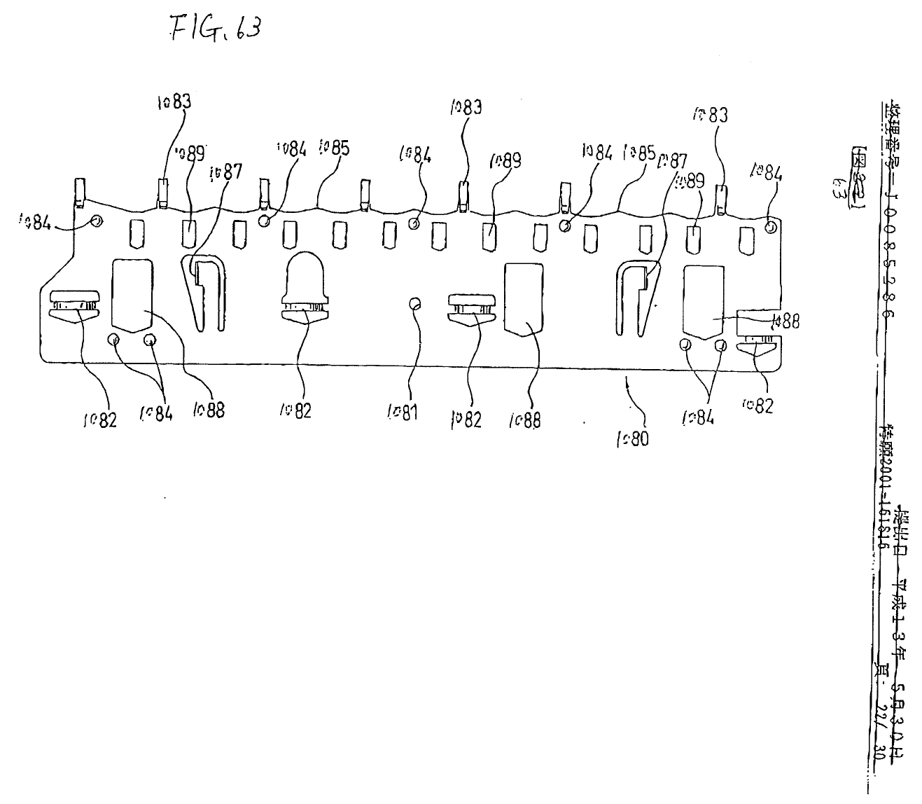

The ink jet printer of the second embodiment, the printer provides with a release means capable of releasing the discharge following roller 1012 in printing normal paper or cardboard depending on the users use purpose, in addition, a release means 1200D of the discharge following roller in association with the paper gap switching means (often referred to as a first release means hereinafter). The second release means will be described referring to FIGS. 63-67 below.

The second release means can release the discharge following roller 1012 so as to separate from the first release means 1200D and a plate 1080 is used and is shown as an example in FIG. 63 in the present embodiment.

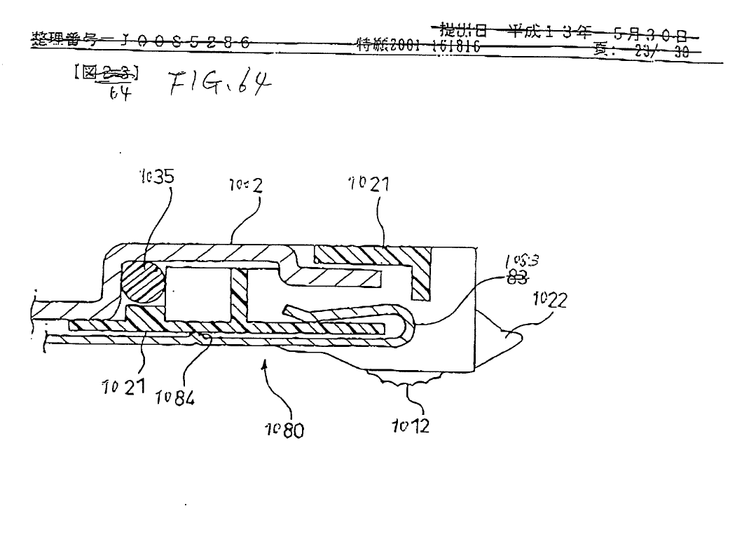

The plate 1080 is a flat board of a material of an SUS and it is provided to the discharge frame 1002 from the lower part of the small holder 1022 as shown in FIG. 64. Seven hooks 1083 are formed on the front part of the plate (shown on the upper side of FIG. 63) and can slide forwards and backwards and are stopped by the main holder 1021. Similarly, four hangers 1082 are stopped by catches (not shown) formed on the discharge frame 1002 so as to slide forwards and backwards. Position determine parts 1087 are inserted into a slit of the discharge frame 1002, and right/left positions are determined and the plate 1080 is provided. Width of the plate 1080 corresponds with the arranged discharge following roller 1012 in the second release means different from the first release means so that all of the discharge following rollers 1012 are swung. A large opening part 1088 is provided at a position corresponding to the discharge roller 1060 (see FIG. 66) in a case the plate 1080 is set and a small opening part 1089 is formed so that the end of the proximal side of the small holder 1022 is put in the case the discharge following roller 1012 is swung to the waiting position. A sliding face at a time of position determination of a height direction of the plate and slide is formed.

Since the plate 1080 is attached to the discharge passage of lower face of the discharge frame 1002, the printing task is performed at the end of the plate 1080 that is a recording pad and an edge on the opposite side to the transmitted sheet recorded is formed into a wave shape, occurrence of paper jam, etc. can be avoided since catching is avoided by passing the leading edge of paper with a wave shaped edge 1087, even if the sheet to be recorded jumps up to the plate 1080 by call and is transferred.

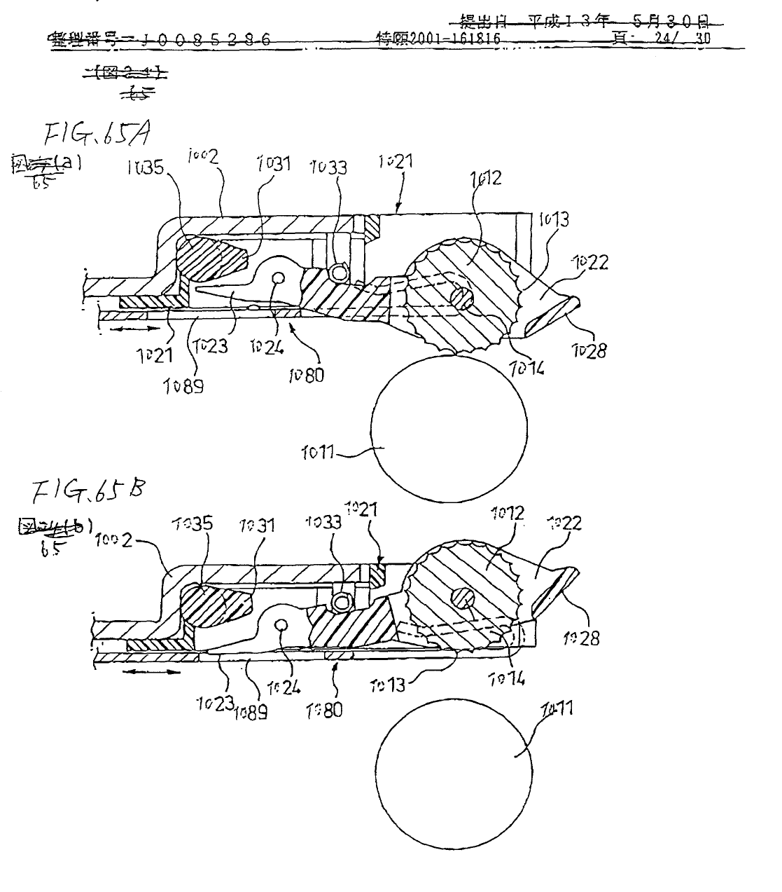

FIGS. 65A and 65B are side views explaining operation to release the discharge following roller 1012 with the second release means. FIG. 65A shows a state where the discharge following roller 1012 is at the normal position. The end of the small holder 1022 is swung up by pivoting the supporting part 1024 by sliding-contact upper face of the plate 1080 on a bottom part of the small holder 1022 as shown in FIG. 65B when the plate 1080 slides from the position into the front direction. The discharge following roller 1012 is released up to the waiting avoiding position by the swinging. Swinging width in the second release means (change amount of discharge following roller) is set to a swinging width, which is narrower, for example about 1 mm, than a swinging width by the cam mechanism in the first release means 1200D described in FIG. 62. Release operation of the discharge following roller 1012 of the is associated with the paper gap switching means 1200A and change width in releasing is also set at the same width as paper gap adjustment in the first release means 1200A. The paper gap is always wide at the other time of releasing the discharge following roller 1012 and the carriage is changed to an upper position having the same width. In contrast, since the discharge following roller 1012 can independently be released with a state where the paper gap is minimal not relating to paper gap adjustment, the discharge following roller 1012 at the waiting avoid position is knocked with a carriage reciprocal moving a lower position in a state of the minimum paper gap and there is a probability to prevent normal printing if change amount of the discharge following roller 1012 is too large. Therefore change amount of the second release means is set to, for example, approximately 1 mm and contact with the carriage at the lower position is avoided in the present embodiment.

FIG. 66 is a main part front view of the ink jet printer explaining the control part 1090 in the second release means. The control pad 1090 is constituted so that the second control lever 1091 can easily be visually recognized from the front side of the ink jet printer around the front center part of the ink jet printer, and it is projected up to a position where it can control and the second release means can be switched, more particularly, the control pad 1090 is attached to the discharge frame 1002 by rotatably pivoting the supporting part 1093 and a stopping projection (not shown) is provided in a downwards direction at a stopping part 1092 apart from the supporting part 1093 and is inserted in a stopping hole 1081 of the plate 1080 through a guide hole 1080 of the discharge frame 1002. When the second control lever 1091 is swung from a state in FIG. 66 where it is at the standard position on the right side, the stopping projection makes the plate 1080 slide forward by pivoting the supporting part 1093 and the discharge following roller 1012 becomes the waiting avoid state (FIG. 65B). The plate 1080 is fixed on the lower side through the guide hole 1086 of the discharge frame 1002. In contrast the second control lever 1091 is swung up to the standard position from this state (separating position of the second control lever 1091) to the left side, the stopping projection makes the plate 1080 slide backward by pivoting the supporting part 1093 and the discharge following roller 1012 returns to the normal position (FIG. 65A).

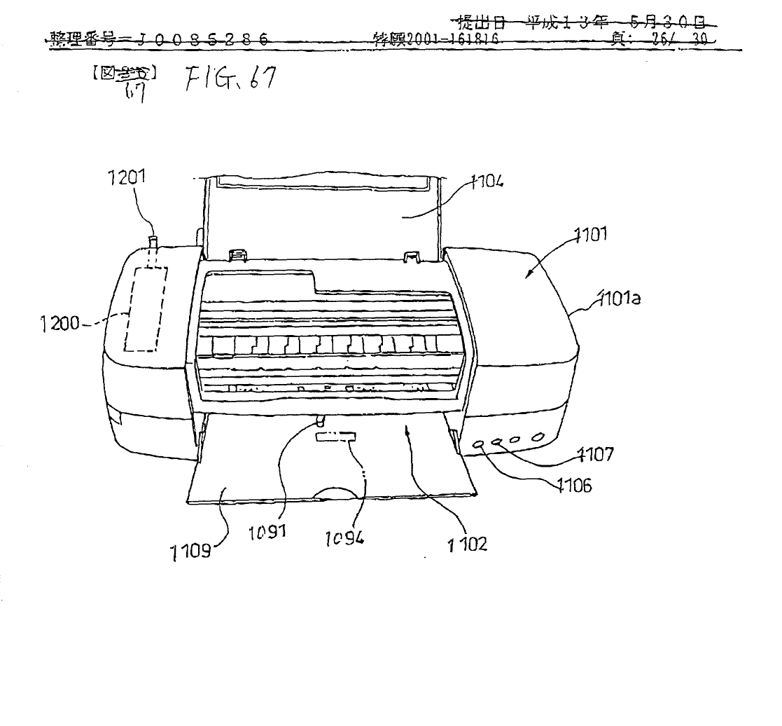

FIG. 67 is a perspective view of the ink jet printer according to the present embodiment viewed from the front upper side and shows a state where the outside tray 1109 is opened. Recovery means 1094 for recovering the second control lever 1091 to the reference position (the left side position in FIG. 67) is provided at a position corresponding to the second control lever 1091 when the tray 1109 is closed in the discharge tray 1109. One part of the upper face of the discharge tray 1109 is contacted with the second control lever 1091 at the separating position in a state where the discharge 1109 is closed. The part is formed at the tilted face of low friction coefficient with an angle that is not contacted when the lever returns to the reference position 1091. The tilted face may be the full upper face of the discharge tray 1109 and may be a face, for example, curve tilted in an arc shape. When the user leaves the control lever 1091 at the separating position of the discharge following roller 1012 and intends to close the discharge tray 1109, and the end of the second control lever 1091 is contacted on the tilted face as the recovering means 1094. Thereby the end part of the second control lever 1091 slides along the tilted face by using pressure at the time of close operation and the end part is swung to the reference position of the discharge following roller 1012 and can automatically recovery. Rotation structure may be provided at a end of the second control lever 1091 if required so that pressure of operation closing discharge tray 1109 can efficiently be converted into recovery operation.

As another example of the recovery means 1094, the recovery means 1094 can be stopped with the second control lever at the time of initially operating the carriage 1105 driven in a stage power supply of the ink jet printer is on. A mechanism can be employed. The mechanism returns the second control lever 1091 to the reference position according to the reciprocal movement of the carriage in the initial operation.

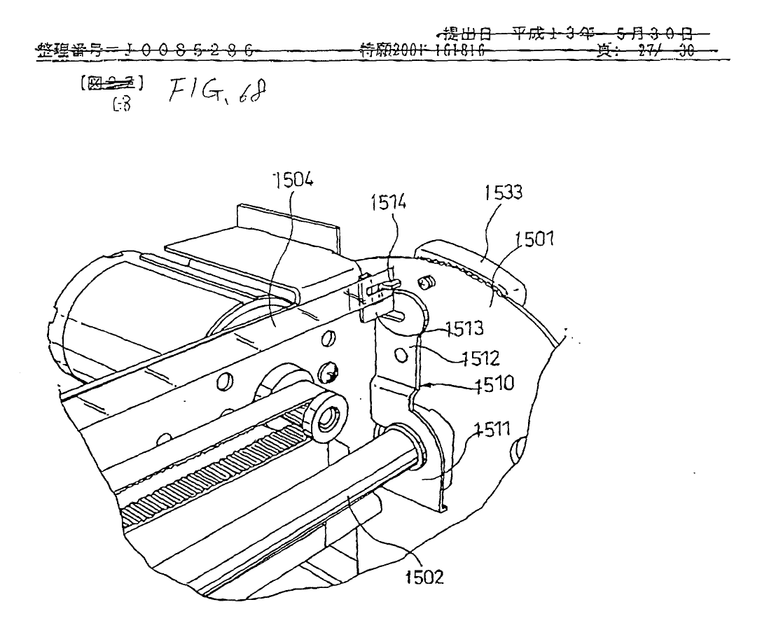

In an ink jet printer of the second embodiment, a linear scale, a detection means 1105 moving position of the carriage in the main scanning direction can be changed according to paper gap adjustment with the paper gap switching means. Association mechanism of the linear scale will be described referring to FIGS. 68-71 below.

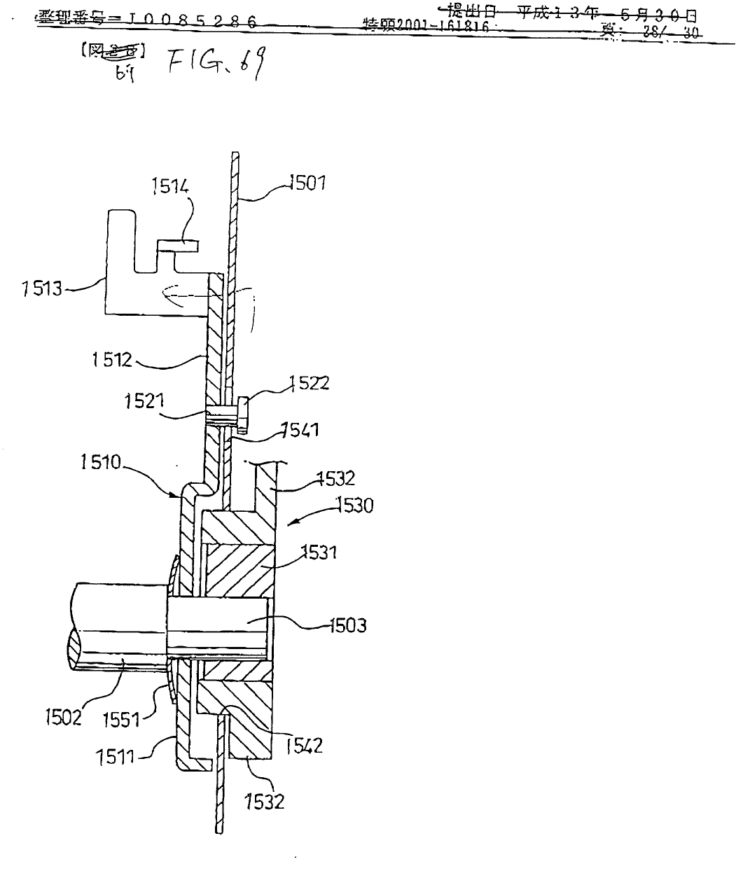

FIG. 68 is a main perspective view showing a state where a holder 1510 is set to the ink jet printer of the embodiment. FIG. 69 is a main part cross-sectional view of a circumference in FIG. 68. The carriage guide axis 1502 is supported by side frames 1501 via an eccentric mechanism 1530 so that the carriage guide axis 1502 can be moved up and down. Since the eccentric axis may be employed, an eccentric bush is used as the eccentric mechanism 1530. Since a cross-sectional concentration axis can be used as the carriage guide axis 1502 by using an eccentric bush and a move distance can be long without a diameter of the carriage guide axis 1502 itself, it becomes possible to wide width changing the carriage and a free level of paper gap adjusting becomes high.

Although shapes of the holder 1510 are any shapes if the carriage guide axis 1502 is associated with the linear scale 1504; the carriage guide axis is set to the holder 1510 at a slightly wide lower part, an attachment 1513 of the linear scale is provided at an upper part, middle of both parts are, in a substantially vertical direction, extended from a lower part to an upper part, and an extending part 1512 contacted on a wall face of the side frame 1501 is provided. The holder 1510 has a bearing shaped part of a substantially semi half circle corresponding to an outer circumference of a small diameter axis 1503 for the carriage guide axis 1502 at a part set to the carriage guide axis 1502. The holder 1510 is set to the carriage guide axis 1502 so that the small axis 1503 of the carriage guide axis 1502 is engaged with the bearing shaped part. Further, a dish-like spring 1551 is held at an engagement portion of the carriage guide axis 1502 so that the holder 1510 is urged against the side frame 1501.

The holder 1510 engaging with the carriage guide shaft 1502 is substantially U-shaped, and an upper part and a lower part of the U-shaped shaft contact the side frame 1501. The plate like plain surrounding the engagement portion defines a spaced member 1511 which is distanced from the wall surface of the side frame 1501. Owing to the spaced member 1511, a load applied to the carriage guide shaft 1502 is relieved to the side frame 1501 in such a manner that it bridges the eccentric mechanism 1530 engaging with the side frame 1501, so that the load on the eccentric mechanism 1530 is reduced.

That is, the carriage guide shaft 1502 receives both the load in a horizontal direction generated by the reciprocating movement of the carriage in the main scanning direction and also the load in a vertical direction generated by the up-down displacement of the carriage itself and the eccentric mechanism 1530. Those loads tends to be concentrated to the eccentric mechanism 1530 which is supported at both ends thereof by the carriage guide shaft 1502. However, the load is relieved by the spaced member 1511 of the holder 1510 to the side frame 1501 serving as a construction member, so that the load applied to the eccentric mechanism 1530 can be reduced.

A mounting part 1513 of a linear scale 1504 is a part formed by bending to be substantially orthogonal with the flat plain of the holder 1510 at the upper part of the holder 1510 disposed to rise up from the lower part, so that it extends in parallel with a tape-like linear scale 1504. Further, by further bending a part of the mounting part which is bent a hook member 1514 for engagement is formed. The hook member 1514 hooks on an engagement hole formed at an end of the linear scale 1504 so that the linear scale is mounted.

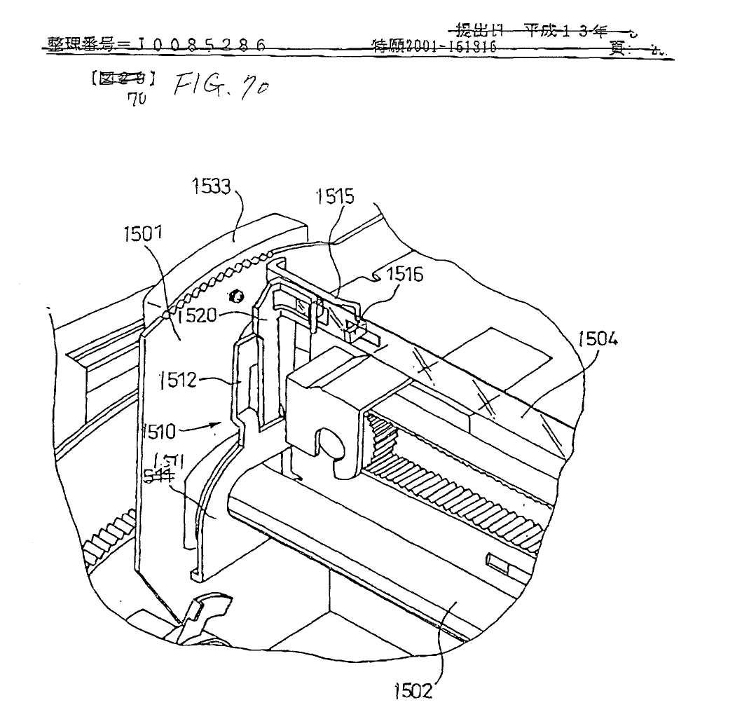

FIG. 70 is a perspective view showing an essential part of the status of the holder 1510 mounted on the side frame 1501 opposite side of the status shown in FIG. 68. The fundamental structure of the holder 1510 is the same as shown in FIGS. 68 and 69, and formed by using the flat plate member. A spaced member 1511 is formed to be spaced from the side frame 1501 at a lower part thereof and engages with the carriage guide shaft 1502 at the part. In FIG. 70, unlike FIG. 68, the linear scale 1504 is not mounted directly onto the holder 1510 but to a leaf spring 1520 mounted on the holder 1510. That is, the holder 1510 is formed with an opening approximately at the center thereof, and the leaf spring 1520 is fit in the opening. The leaf spring 1520 is secured to the holder 1510 at a lower part thereof by a means not shown in the Fig. drawings, and the mounted movably in up-down direction along the same locus as the carriage guide shaft 1502 and the holder 1510. At an upper portion of the leaf spring, there is provided a mounting portion of the linear scale 1504 formed by bending same to be approximately orthogonal with respect to the flat plate surface of the leaf spring 1520, that is, to be in parallel with the tape like linear scale 1504. Like the mounting part 1513 of the linear scale 1504 shown in FIG. 68, a hook member for mounting the linear scale 1504 is formed. The hook member hooks on an engagement opening formed in an end of the linear scale 1504, so that the linear scale is mounted. Thus, the mounting part of the linear scale 1504 is formed on the leaf spring 1520 mounted on the holder 1510 and the linear scale 1504 is mounted to the mounting part. Due to the structure, the linear scale 1504 can be held while applying a tension by means of the elastic force of the leaf spring 1520. In the present embodiment, the leaf spring 1520 is prepared separately from the holder 1510, it may be possible that a part of the holder 1510 is designed to be elastically deformable, so that the same elastic force is obtained as the leaf spring 1520.

An upper part of the holder 1510 shown in FIG. 70 is bent to be substantially orthogonal with the flat plate surface of the holder 1510, that is, to be in parallel with the take-like linear scale 1504, so that a positioning member 1515 is formed in the height direction of the linear scale 1504. A projecting piece 1516 is formed by further bending in orthogonal a part of the positioning member 1515 formed by bending, and the projecting piece 1516 is inserted into an opening formed for positioning the linear scale 1504 in the height direction, so that the height of the linear scale 1204 can be defined without deviating in vertical direction.

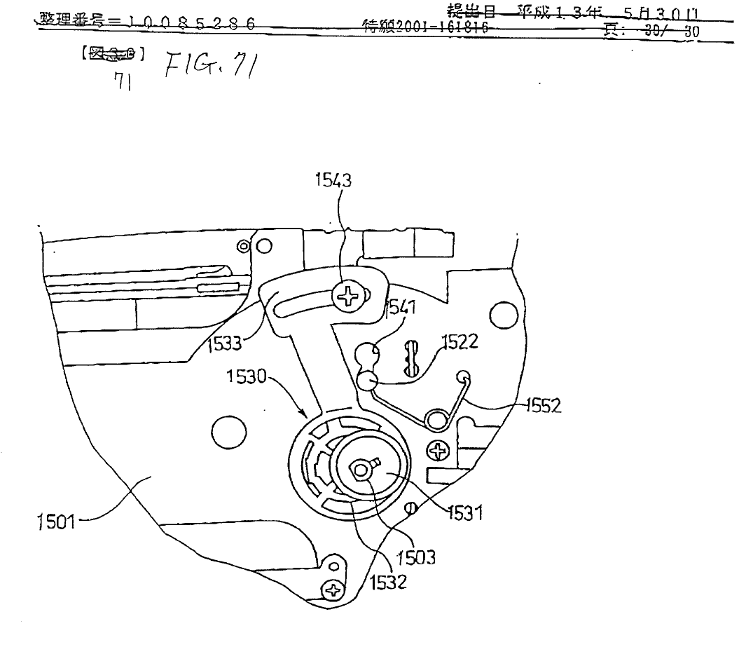

As shown in FIGS. 69 and 71, a projection 1521 is formed at a flat plate like rising-up part of the holder 1510 rising in vertical from the lower part thereof. The projection 1521, cooperating with a guide hole 1541 formed in the side frame 1501, forms a guide structure which defines a locus of the holder 1510 when it moves up and down. A lower half shape of the guide hole 1541 is designed to be the same locus as the displacement locus of the carriage guide shaft 1502. Therefore, the projection 1521 fitted in the guide hole 1541 is guided in the guide hole 1541 when it is moved to make the same locus as the carriage guide shaft 1502. Therefore, as the linear scale 1504 mounted on the holder 1510 moves along the same locus as the carriage guide shaft 1502, i.e., the carriage, the displacement of the linear scale 1504 while maintaining the relative position with the carriage can be accomplished. Further, a tip end of the projection 1521 is T-shaped in cross section which performs as a remove-preventing member 1522 from the guide hole 1541. An upper part of the guide hole 1541 is made wide compared with a lower locus shape, and by inserting the projection 1521 into the guide hole 1541 from the top when the holder 1510 is mounted, the fitting operation of the projection 1521 into the guide hole 1541 can be readily achieved. Further, the projection 1521 is linked to the side frame 1501 by a chattering-preventing spring 1522 for preventing any chattering within the guide hole, so that the projection 1521 can be guided in stable in the guide hole 1041.

Based upon the above explanation, the operation of the linear scale interlocking mechanism of the present embodiment.

The linear scale 1504 is installed to the holding unit 1510 or the bar spring 1520, which is mounted to the holding unit 1510. This holding unit 1510 changes the position up and down with synchronizing with the displacement of the carriage guide axis 1502, which has an eccentric mechanism 1530 for adjusting a paper gap. As a result, the displacement of linear scale 1504 displaces up and down with corresponding with the displacement of the carriage guide 1502.

As explained above, as a result of mounting the holding unit 1510 of the linear scale 1504 to the carriage guide axis 1502, which adopts eccentric mechanism 1530, synchronously, the carriage guide 1502 and the linear scale 1504 displaces corporately. Therefore, it is possible to adjust the paper gap and change the position of the linear scale by only one switching operation. A eccentric mechanism 1530 is not limited to the eccentric mechanism as mentioned-above, but a known mechanism such as eccentric axis may also be adopted.

The various types of the embodiments of the present invention are explained above. However, the present invention is not limited to the embodiments mentioned above, but other embodiments can also be applied to the present invention within the scope of the present invention defined by the appended claims.

For example, the paper gap switching unit 1200A (and the release unit 1200D of the following roller) and the second lacking teeth gear 1212 and the third lacking teeth gear 1214 may be separately manufactured and connected to be coaxial. Furthermore, the paper gap switching unit 1200A (and the release unit 1200D of the following roller) and the second lacking teeth gear 1212 and the third lacking teeth gear 1214 may be manufactured previously as one-body.

Furthermore, in the above-mentioned embodiments, the switching position of the operation lever 1201 is explained for the case in which the positions A, B, C, and D of four steps are set sequentially. The position A is a position for using a sheet having a normal thickness, that is, a normal paper. The position B is a position for using a sheet having a slightly large thickness, that is, a cardboard. The position C is a position for using a sheet having a large thickness, that is, a cardboard having a large thickness including an information recording disk tray. The position D is a position where the following roller 1202 is separated from the main roller 1203.

However, the present invention is not limited to the above embodiment, but other embodiment may be applied if the three positions of the position P, the position Q, and position R are set sequentially. The position P is a position for setting a first paper gap. The position Q is a position for setting a second paper gap that is larger than the first paper gap. The position R is a position where the following roller 1202 is separated from the main roller 1203.

Furthermore, the switching position that is sequentially set is not limited to the order of A, B, C, and D, but other desired order may be applied to the present invention. For example, in case of the above switching positions P, Q, and R, any one of the order of an order P, Q, R, an order R, P, Q, and an order P, R, Q may be applied.

Furthermore, in the above embodiment, the cam mechanism, which comprises cam 1031 and cam follower 1023, is used in the first release unit 1200D, and the slide mechanism of the plate 1080 is used in the second release unit. However, other mechanism that can achieve the same object can be applied for the present invention.

Moreover, the pushing means of the following roller 1202 in the following roller separating means 1200B is not limited to the coil spring 1205 and 1305, and other mechanism of an elastic member such rubber can be applied. Furthermore, if the D axis 1213a is formed in a fan-shape having an acute angle, the operation angle of the operation lever 1201 can be taken desirably.

According to the holder and the paper ejection apparatus having a holder, and a printing apparatus having the paper ejection apparatus of the present invention, a release mechanism that can changes the position of the following roller holder to the normal position or the evacuation position is provided. The normal position is a position where the holder can contact with the sheet. The evacuation position is a position where the following roller does not contact with the sheet.

For example, the printing using coating paper may be performed at the evacuation position so that the peeling off or damage of the paper can be prevented. Therefore, the printing condition can be selected according to the purpose of the printing to print without causing damage on the surface of the sheet to be recorded.

Although the present invention has been described by way of exemplary embodiments, it should be understood that those skilled in the art might make many changes and substitutions without departing from the spirit and the scope of the present invention, which is defined only by the appended claims.

What is claimed is:

1. A transferring tray for a printing apparatus for printing on one major surface of a recording media having disc shape, wherein the printing apparatus includes, a carriage having a printing head, reciprocating in a main scanning direction, a transferring unit transferring the recording media in a sub scanning direction, a detecting unit detecting the recording media being transferred by the transferring unit, and a recording unit printing on the one major surface of the recording media, the transferring tray comprising:
a tray body having a rectangular plate shape made of a material which is not detected by said detecting unit;
a detected portion formed on either one of two major surfaces of the tray body, being detectable by the detecting unit; and
a mounting portion having a mounting recess such that the one major surface of the recording media comes up to substantially same level as one of the major surfaces of the tray body when the recording media is mounted on the transferring tray.

2. The transferring tray according to claim 1, wherein the tray body of the transferring tray includes plural long grooves having plural convex portions and plural concave portions being parallel to the sub scanning direction, wherein the plural convex portions on the one of the major surfaces forms the respective plural concave portions on the other of the major surfaces, and each of the plural convex portions on the other of the major surfaces forms the respective plural concave portions on the one of the major surfaces.

3. The transferring tray according to claim 1, wherein the transferring unit includes a driving roller and a following roller, and wherein a thickness of a starting portion and an end portion of the tray body gradually decreases toward a tip end of the tray body.

4. The transferring tray according to claim 1, wherein the tray body has a hole in the mounting recess, being smaller than the mounting recess, for removing the recording media from the transferring tray.

5. The transferring tray according to claim 1, wherein the material of the tray body has a black color.

6. The transferring tray according to claim 1, wherein the tray body made from an integral molded plastic.

7. A printing apparatus for printing on one major surface of a recording media having disc shape, the printing apparatus comprising:
a carriage having a printing head, reciprocating in a main scanning direction;
a transferring unit transferring the recording media in a sub scanning direction;
a detecting unit detecting the recording media being transferred by the transferring unit;
a recording unit printing on the one major surface of the recording media; and
a transferring tray mounting the recording media thereon, the transferring tray including,
a tray body having a rectangular plate shape made of a material which is not detected by said detecting unit,
a detected portion formed on either one of two major surfaces of the tray body, being detectable by the detecting unit, and
a mounting portion having a mounting recess such that the one major surface of the recording media comes up to a substantially same level as one of the major surfaces of the tray body when the recording media is mounted on the transferring tray.

8. The printing apparatus according to claim 7, further comprising an ejecting unit including an ejection driving roller and an ejection follower roller,
wherein the tray body of the transferring tray includes plural long grooves having plural convex portions and plural concave portions being parallel to the sub scanning direction, and
wherein the plural convex portions on the one of the major surfaces forms the respective plural concave portions on the other of the major surfaces, each of the plural convex portions on the other of the major surfaces forms the respective plural concave portions on the one of the major surfaces, the convex portion is formed on a portion of the one of major surfaces of the tray body being contact with the ejection follower roller, and the convex portion formed on the portion comes up to a substantially same level as the one major surface of the recording media.

9. A transferring tray for a printing apparatus for printing on one major surface of a recording media, wherein the printing apparatus includes, a carriage having a printing head, reciprocating in a main scanning direction, a transferring unit transferring the recording media in a sub scanning direction, and a recording unit printing on the one major surface of the recording media,
wherein the recording media being a thin plate shape is mounted on the transferring tray, the transferring tray to which the recording media is mounted is transferred, serving as the recording media, and the printing head prints on one major surface of the recording media, and
wherein, when the transferring tray is manually set to a predetermined position of a transferring path of the transferring unit, the transferring tray is positioned, based on an outline picture of an element of the printing apparatus drawn on the transferring tray.

10. The transferring tray according to claim 9, wherein the predetermined position is located where the outline picture being a similar size of the element overlaps with the element to hide the outline picture by the element.

11. The transferring tray according to claim 9, wherein the outline picture indicates the ejection follower roller of the transferring unit.

12. The transferring tray according to claim 9, wherein the outline picture is drawn with a substantially same color as the element.

13. The transferring tray according to claim 9, wherein, along with the outline picture, an arrow showing a direction for inserting the transferring tray to the printing apparatus is drawn on the transferring tray.

14. The transferring tray according to claim 9, wherein the recording apparatus further includes a detecting unit detecting the recording media being transferred by the transferring unit, and wherein the transferring tray made of a material which is not detected by said detecting unit while the transferring tray further comprises a detected portion formed on either one of two major surfaces of the tray body, being detectable by the detecting unit.

15. The transferring tray according to claim 9, further comprising a mounting portion having a mounting recess such that the one major surface of the recording media comes up to a substantially same level as one of the major surfaces of the tray body when the recording media is mounted on the transferring tray, and a detaching hole in the mounting recess, being smaller than the mounting recess.

16. The transferring tray according to claim 9, further comprising a first stopper making contact with the carriage when the printing head is closer to the one of the major surfaces of the transferring tray than a predetermined distance, for preventing the printing head from scanning on the transferring tray.

17. The transferring tray according to claim 9, further comprising a second stopper making contact with the carriage when the transferring tray is inserted to the printing apparatus in a direction other than a predetermined direction, irrespective a distance between the printing head and the transferring tray, for preventing the printing head from scanning on the transferring tray, wherein the second stopper is positioned not to make contact with the carriage when the transferring tray is inserted to the printing apparatus in the predetermined direction and the printing head prints on the one major surface of the recording media.

18. The transferring tray according to claim 9, wherein the recording apparatus further includes a starting end detecting unit having a lever with self-regression to a standing orientation, being pivoted with protruding into the transferring path to be rotatable in the sub scanning direction, for detecting a starting end of the recording media, and
wherein the transferring tray further comprises a protective portion having a shape such that the transferring tray is drawn out from the transferring path without reversely rotating the lever after the transferring tray is inserted to the transferring path of the transferring unit while the one major surface faces to the printing head.

19. A printing apparatus comprising the transferring tray according to claim 9, wherein the transferring tray is transferred as the recording media, and the printing head prints on the one major surface of the recording media having the plate shape.

20. The transferring tray according to claim 9, wherein the printing apparatus further includes a detecting unit detecting the recording media being transferred by the transferring unit, and
wherein the transferring tray further comprises:
a tray body having a rectangular plate shape made of a material which is not detected by said detecting unit;
a detected portion formed on either one of two major surfaces of the tray body, being detectable by the detecting unit; and
a mounting portion having a mounting recess such that the one major surface of the recording media comes up to a substantially same level as one of the major surfaces of the tray body when the recording media is mounted on the transferring tray.

21. A printing apparatus as claimed in claim 20, wherein the tray body of the transferring tray includes plural long grooves having plural convex portions and plural concave portions being parallel to the sub scanning direction, and
wherein the plural convex portions on the one of the major surfaces forms the respective plural concave portions on the other of the major surfaces, each of the plural convex portions on the other of the major surfaces forms the respective plural concave portions on the one of the major surfaces.

22. A printing apparatus as claimed in claim 20, wherein the transferring unit includes a driving roller and a following roller, and wherein a thickness of a starting portion and an end portion of the tray body gradually decreases toward a tip end of the tray body.

23. A printing apparatus as claimed in claim 20, wherein the tray body has a hole in the mounting recess, being smaller than the mounting recess, for removing the recording media from the transferring tray.

24. A printing apparatus as claimed in claim 20, wherein said tray body is made of material having a black color.

25. A printing apparatus as claimed in claim 20, wherein said tray body is made of plastic material formed in one-body.

26. A printing apparatus as claimed in claim 19, further comprising a detecting unit that detects recording media which is transferred by said transferring unit, wherein
said transferring tray further includes:
a tray body having a rectangular plate shape made of a material which is not detected by said detecting unit;
a detected portion that is detectable by said detecting unit; and
said tray body has a mounting groove, on which said recording media can be mounted so that a printing face of said recording media is arranged at substantially same plane with the plane of said recording media mounting side when said recording media is mounted.

27. A printing apparatus as claimed in claim 26, further comprising:
an ejection unit having an ejection driving roller and an ejection follower roller having a teeth; wherein:
said tray body having a plurality of grooves on both sides of said tray body in the direction parallel to the sub scanning direction along which said transferring tray is transferred so that said tray body has a plurality of convex face regions and a plurality of concave face regions; and
said plurality of grooves are formed such that one side of back face of said convex face region becomes said concave face region, and one side of back face of said concave region becomes said convex face region; and a region that contacts with said ejection following roller becomes said convex face region, and said convex face and a printing face of said recording media mounted on said convex face becomes substantially same plane.

28. A printing apparatus as claimed in claim 19, wherein:
the printing apparatus records an image for one scanning on a recording medium by main scanning a printing head at a predetermined printing position in sub scanning direction and records an image on one piece of recording medium by performing a sub scanning with transferring said recording medium in said sub scanning direction after the end of said main scanning and repeating said main scanning and said sub scanning one after another; and
said transferring unit is provided in each of upstream side of said printing position and down stream side of said printing position along said sub scanning direction, and said transferring unit has a first and second paper sending roller that holds and transfers said recording media, and said transferring unit can transfers said recording media in any one of said upstream side and said downstream side of said sub scanning direction; and
said printing apparatus further comprising:
a paper feeding unit provided on most upstream side of said sub scanning direction in the printing apparatus;
a detecting part provided at a position where the optical axis to be detected is positioned at more downstream side than the holding position of said second paper sending roller and second follower roller provided at downstream side of said printing position; said detecting part outputting a voltage according to a reflected light amount of the object at said position and detecting said object by judging whether said detected voltage surpass a predetermined threshold value (T0) at default condition;
a recording unit for recording a value of said detected voltage detected by said detecting part; and
a transferring control unit for transferring said recording media for a predetermined amount downstream side in the sub scanning direction by said transferring unit so that said detection part can detects a tip portion of said recording media; recording a detected voltage (T1) detected by said detecting part at said transferring position and at the same time transferring said recording media to the upstream side in the sub scanning direction by said transferring unit; recording a detected voltage (T2) detected by said detecting part when there is no recording media on said recording unit;
calculating a average value (T0Vp) of said detected voltage (T1) and said detected voltage (T2); transferring said recording media to the downstream side in the sub scanning direction by said transferring unit after modifying a predetermined threshold value for detecting the existence of said object to said average value (T0Vp) calculated from said default threshold value (T0); and setting said recording media to an initial position referring to a point where said detected voltage detected by said detecting part reaches to said average value (T0Vp).

29. A printing apparatus as claimed in claim 28, further comprising:
a second detection part provided at a position more upstream side than holding position of said first paper sending roller and first follower roller provided at upstream side of said printing position for detecting an existence of said recording media at said position; and
a third detection part provided at a position between said second detecting part and said paper feeding unit in said sub scanning direction for detecting an existence of said recording media at said position.

30. A printing apparatus as claimed in claim 19, further comprising:
an initial setting unit for said recording media, said initial setting unit including said transferring unit, which can transfer said recording media in any one of direction of upstream side and downstream side of transferring passage, an optical sensor, a recording unit, and a calculating unit; wherein:
said optical sensor changes an output voltage according to the object;
said recording unit stores predetermined voltage value, which is previously determined;
said transferring unit transfers said recording media for a predetermined distance from the time when the output voltage value of said optical sensor exceeds said predetermined voltage value during transferring said recording media so that the object of said optical sensor becomes said recording media only;
said recording unit records an output voltage value of said optical sensor in said condition as a first measurement value;
said transferring unit further transfers said recording media in the reverse direction toward downstream side of said transferring passage to remove said recording media from a detection range of said optical sensor;
said recording unit records an output voltage value of said optical sensor in said condition as a second measurement value;
said calculation unit calculates an average value of said first measurement value and said second measurement value; and
said transferring unit transferring said recording media upstream side of said transferring passage and transferring said recording media for a predetermined amount referring to a position which is to be an average value calculated by said calculation to perform initial setting of said recording media.

31. A printing apparatus as claimed in claim 30, wherein said optical sensor has a light-emitting element and a light-receiving element, and said optical sensor detects an existence of the object by catching a reflected light that is emitted from said light-emitting element and is reflected from an object with said light-receiving element.

32. A printing apparatus as claimed in claim 31, wherein said transferring tray, on which said optical disc is mounted, can be moved inside the paper passage of the printing apparatus by said transferring unit.

33. A printing apparatus as claimed in claim 19, wherein said transferring unit comprises a structure for sending said recording media by driving a motor with motor driving control unit; and
said printing apparatus further comprising an optical sensor; and
said printing apparatus performing a forward sending and a backward sending of said recording media, which is entered to the detection range of said optical sensor, using a structure for sending said recording media; and detecting a light amount at said forward sending position and said backward sending position of said recording media; and controlling a sending of said recording media with said motor driving control unit based on said detection results; and
a structure for sending said recording media including a roller driven by said motor; and
said optical sensor is arranged at more recording media ejection side than a position of a structure that performs said sending of said recording media in said recording media passage of the printer apparatus.

34. A printing apparatus as claimed in claim 19, wherein said transferring unit comprises a structure for sending said recording media by driving a motor with motor driving control unit; and
said printing apparatus further comprising an optical sensor; and
said printing apparatus performing a forward sending and a backward sending of said recording media, which is entered to the detection range of said optical sensor, using a structure for sending said recording media and detecting a light amount at said forward sending position and said backward sending position of said recording media and controlling a sending of said recording media with said motor driving control unit based on said detection results; and
a structure for sending said recording media including a roller driven by said motor and a notched roller which is pushed against said roller, said notched roller holding said recording media together with said roller and sending said recording media; and
an optical axis of said optical sensor is arranged at more recording media ejection side than a center position of said notched roller in the said recording media passage.

35. A printing apparatus as claimed in claim 19, wherein said transferring unit comprises a structure for sending said recording media by driving a motor with motor driving control unit; and
said printing apparatus further comprising an optical sensor; and
said printing apparatus performing a forward sending and a backward sending of said recording media, which is entered to the detection range of said optical sensor, using a structure for sending said recording media; and detecting a light amount at said forward sending position and said backward sending position of said recording media; and controlling a sending of said recording media with said motor driving control unit based on said detection results; and
a structure for sending said recording media including a roller driven by said motor and a plurality of notched rollers which are pushed against said roller, said notched roller holding said recording media together with said roller and sending said recording media; and
said optical sensor is arranged between said plurality of notched rollers in the paper width direction of said recording media.

36. A printing apparatus as claimed in claim 33, wherein said printing apparatus is a printer for performing a printing by scanning a printing head; and
a structure for sending said recording media includes two rollers, which are driven synchronously by same motor through a power transmission mechanism; and
said scanning operation of said printing head is performed at the position between said two rollers in said recording media passage.

37. A printing apparatus as claimed in claim 19, wherein said printing apparatus performs a printing operation by driving a sending motor of said recording media with a motor driving control unit to send said recording media in a sub scanning direction and driving a carriage motor to move a carriage, on which said printing head is mounted, in a main scanning direction; and
said motor driving control unit has:
an current detecting unit for detecting a consumption current value of said carriage motor;
a judging unit for judging a type of said recording media installed in the printing apparatus by obtaining information of a detected current value; and
said judging unit judges said recording media has a failure when said consumption current value detected by said current detecting unit exceeds a predetermined value during the process when said consumption current value of said carriage motor is detected while said recording media is sent under a main scanning lines, along which said carriage moves, by a sending motor of said recording media and moves said carriage to a predetermined position on said recording media.

38. A printing apparatus as claimed in claim 37, wherein the printing apparatus moves said transferring tray, on which said recording media having a shape of a thin-plate is mounted, in a recording media passage of said printing apparatus with a sending motor of said recording media; and
the printing apparatus has a gap adjusting unit for setting a size of the gap between said printing head and a platen by moving said carriage up and down according to a type of said recording media; and
a convex part, which has a predetermined height against a height of said printing head, is provided on said carriage; and
said convex part contacts with a side face of edge of said recording media when said carriage scans in the condition where said recording media, which has a thickness larger than the thickness of the type of said recording media set by said gap adjusting unit, is positioned under said main scanning line.

39. A printing apparatus as claimed in claim 37, wherein said motor driving control unit stops the operation of driving said motor when said judging unit judges said recording media has a failure.

40. A printing apparatus as claimed in claim 37, further comprising:
a screen display unit that can rewrite information, which is to be displayed in a screen, desirably by display control unit; and
said display control unit controls said screen display unit such that said screen display unit displays information for urging resetting said gap adjusting unit to the size of said gap that is adjusted to said recording media mounted in the printer when said judging unit judges said recording media has a failure.
